(19) United States
(12) Patent Application Publication
(10) Pub. No.: US 2011/0204142 A1
(43) Pub. Date: Aug. 25, 2011

(54) SYSTEM AND METHOD OF INTEGRATED NATIONAL CITIZEN IDENTITY MANAGEMENT AND E-GOVERNANCE

(76) Inventor: Css Rao, Mumbai (IN)

(21) Appl. No.: 13/126,694

(22) PCT Filed: Oct. 27, 2009
(86) PCT No.: PCT/IN09/00606

§ 371 Date: Apr. 28, 2011

(30) Foreign Application Priority Data
Oct. 28, 2008 (IN) 2609/CHE/2008

(51) Int. Cl. G06Q 10/00; G06K 19/077; G06K 19/02

(52) U.S. Cl. 235/380; 235/492; 235/488

(57) ABSTRACT

The instant invention relates to an integrated system and method of secure national citizen identity management and e-Governance—known as the CimeGo System®—using as the foundational platform a centralized national-level electronic database of all citizens known as the National Registry (NR) or Central Data Repository (CDR) (containing all relevant data including biometrics in uniquely designed formats, periodically updated) (and also separately for non-citizens) for national level identity management deploying secure smart cards bearing a single, unique scientifically derived identity reference allocated to each citizen valid for the lifetime of the citizen for all applications countrywide, replacing all multiple IDs presently in use. Dedicated India Card Centres (ICCs) across the country serve to rapidly complete citizens' enrolment procedures leading to card issuance and activation. Data stored on the card chip is ported from NR (CDR) and accessed by authorised personnel via card reader units located countrywide. Using the method offered under the instant invention, the NR also serves as the basis for operationalising a modern e-Governance programme with numerous advanced functionalities for efficient, facile bi-directional interaction between citizens versus government and other agencies, spanning a wide range of statutory and non-statutory applications. The Cimego® System facilitates efficient national administration, ensuring compliance by citizens with laid-down laws and national directives. The invention also helps to plan and monitor welfare measures to the populace and to maintain stringent levels of internal security and border regulation by means of the wide ranging actionable inputs and functional capabilities offered by the instant invention.

### FIELD OF INVENTION

The instant invention relates to a system and method for creating a secure and comprehensive centralized national-level electronic database of all citizens, serving as the foundational platform for implementing a unique, secure smartcard-based national level identity management system via a single, harmonized identity reference for each citizen for life (replacing all multiple IDs presently in use) encompassing multiple functions and a comprehensive range of applications and for operationalising a modern e-Governance programme with numerous advanced, futuristic functionalities, for efficient, facile interaction between citizens versus government and other agencies, spanning a wide range of statutory and non-statutory applications fulfilling the needs of efficient national administration, and providing Governments a modern system to oversee compliance with laid-down laws and national policies by citizens, to reach welfare measures to the entire populace, and to establish stringent levels of administrative control, internal security and border regulation; said invention comprising custom-designed hardware, middleware, software, supplies and services which provide the procedure, know-how, do-how, design, methodology, actionable inputs and wherewithal to deliver the above results seamlessly.

### BACKGROUND OF THE INVENTION

Historically, governments have endeavoured to administer their populace efficiently by introducing one or more forms of identity card systems, seeking to safeguard the authenticity of the ID Card while simultaneously trying to provide utility—both to the government itself as well as to the citizens—by the deployment of such Cards. However, till date, governments have not developed a comprehensive solution that guarantees the security of the Card while, at the same time, providing multiple functionalities. Consequently, there have been a multitude of ID Cards and identity systems, usually fraught with high risk of fraud and tampering/manipulation of identities, owing to the incorporation of only minimal—or no sustainable—security features. These are generally paper or plastic cards, targeting a specific, sole or restricted set of applications. Owing to such limited functionality, different government bodies—both at the state as well as the national level—have been issuing their own identity cards. The citizen is therefore compelled to cope with a multiplicity of ID cards, each of which is susceptible to identity fraud. At the same time, the multiplicity of cards also results in repetitive costs of enrolment, issuance and administration, and poor card security resulting from deploying low-end technology, or even the absence thereof. Example: Voter ID, PAN Card, Driving Licence, PDS Card, BPL Card, etc.

U.S. Pat. No. 7,337,973 provides a card with a paper core and at least one chip incorporated into the paper core, characterised in that an image is arranged on at least one main surface of the paper core, at least 5% of at least one main surface are covered by a seal and the chip is covered on both main surfaces with a seal or a plastics layer, is distinguished by elevated anti-counterfeiting security, very good durability and elevated flexibility.

U.S. Pat. No. 7,395,435 provides a secure memory device which can be used for multi-application smart cards for secure identification in data transfer, or for component verification in a computer system, without the requirement of an internal microprocessor. The secure memory device features a dual authentication protocol in which the memory and host authenticate each other. The secure memory device also includes an encrypted password feature, as well as using stream encryption to encrypt the data.

U.S. Pat. No. 7,362,884 provides a biometric system that uses readings from a plurality of biometrics of a user is disclosed. The biometric system includes a first and second biometric readers, a first and second biometric matching engines and a processor. The first biometric reader producing a first measured biometric that is processed by the first biometric matching engine to deliver a first value, which is indicative of a likelihood that the first measured biometric matches a first stored biometric reading. A plurality of first values are gathered prior to the first value. The second biometric reader delivers a second measured biometric for processing by the second biometric matching engine to produce a second value, which is indicative of a likelihood that the second measured biometric matches a second stored biometric reading. A plurality of second values are gathered prior to the second value. The first and second biometric readers measure a different biometric, or the first and second biometric matching engines use a different algorithm. The processor normalizes the first value according to the plurality of first values, normalizes the second value according to the plurality of second values, and determines if the user matches a person using the normalized first and second values.

U.S. Pat. No. 7,370,807 provides an identity card that can be used, for example, in a travel document or as a separate card, includes at least two core layers, preferably of polycarbonate material, that are fused to one another. In each of the core layers there is a recess, each of a different size. On assembly these recesses become situated on top of one another and a semiconductor chip is accommodated in the larger recess formed as a result. A covering layer can be fused to at least one of the core layers, and a layer that can be written on by laser can also be applied. There can be (semi-transparent) windows on top of one another in the core layer and if the covering layer is transparent, light can be transmitted, it being possible to define a specific pattern in the windows.

U.S. Pat. No. 7,357,331 provides a selectable, multi-purpose card comprising a plurality of features stored in memory means operatively mounted on the card and selection means for allowing a user to select a feature in a few simple steps, preferably in a single step. In one embodiment the card includes a plurality of magnetic strips positioned on the card in a manner to allow swiping each magnetic strip separately using conventional reading devices. Each magnetic strip activates a different feature of the card. In another embodiment the card includes a programmable magnetic strip, a plurality of features stored in memory means mounted on the card, a plurality of buttons or contacts, and means for programming the magnetic strip with a different card feature. The card may also include a thin, flexible display.

Clearly, the requirements of good governance of large populations in modern times point to the need for deploying sophisticated, tamper-proof identity management systems which also incorporate modern information technology solutions, and draw value from technological advancements in the fields of electronics and telecommunications. These features are not provided by the above-stated prior art, hence there is a requirement of more advanced fool proof solutions.

The instant invention represents an ideal solution to the above stated problems presently faced by governments, and represents a high-utility end-to-end packaged solution comprising hardware, middleware and software as well as a full suite of actionable inputs, designed to precisely fulfil the varied needs of modern identity management as well as of emerging imperatives of modern nations to implement e-Governance practices. The instant invention is bolstered by a well-synthesized conglomeration of many individually unique and pioneering sub-inventions which collectively constitute a novel, unprecedented, extremely reliable and robust identity management system for federal governments, and can cope with the multifarious e-Governance requirements of progressive countries endowed with large, diverse, geographically dispersed and expansive populations. As a result, the instant invention is capable of delivering reliable, very long term and efficient support to federal governments worldwide seeking to implement fool-proof, technologically advanced identity management practices and deploying comprehensive and futuristic e-Governance programmes.

### SUMMARY OF THE INVENTION

The instant invention provides federal governments the complete method of National Citizen Identity Management and e-Governance, by inter alia offering the proprietary concepts, technical know-how, do-how, methodology, actionable inputs, integrated hardware, middleware and tailored software solutions, systems, supplies and services, and the wherewithal to create the legal basis, infallible means and product to irrefutably prove one's citizenship—something which cannot be currently achieved as there is no known practice—on a pan-population basis, including non-resident citizens and persons of country's origin;

The instant invention provides an integrated method of creating and maintaining a centralised national registry containing all relevant particulars of citizens ensuring secure data transmission and storage and a national e-governance system utilising a citizen identity card comprising a card, front portion of said card is embedded with a memory chip, citizen name, photograph, signature and unique citizen ID number, back portion of said card is embedded with issuing authority name, batch code, control code, date of birth, blood group, sex, issuing and renewal dates and emergency contact details wherein the memory chip is stored with core personal data, biometric data, digital signature, card holder status, education, vocation, banking, credit card, driving license, passport, census, electoral, social security, medical and insurance, fixed assets ownership, moveable assets ownership, business ownership, government interface, key services utilisation, public distribution system, key membership, taxation, major travel, special achievements, principal events, linkage to related IndiaCards, IndiaCard® history, litigation data, crime data, other data, additional segments for future use, system files, said card on operation through specially calibrated card reader units will display the required information on PC terminals and on mobile/wireless communication devices.

The instant invention is also a method for preparing the national citizen identity card comprising filing application form with personal data, capturing biometric data, uploading the personal data and biometric data to local database at India card centre (ICC), sending said data to different government departments for critical verification, if the result on verification is negative, the citizen is given an opportunity to correct, if the result is positive, the ICC data is uploaded via Zonal Control Office (ZCO) and State Control Office (SCO) of NCID to Central Control Office (CCO) of NCID where it gets stored in the National Registry (NR). The National Office completes its prescribed final verification processes, leading to generation of unique citizen ID number and authorizing issuance of ID Card, in respect of all citizens whose applications are approved. This leads to production and personalisation of the card, fixing a memory chip on the personalized ID card, storing citizen specific data in specially designed modules in the National Registry (CDR), loading of data from NR on to the memory chip, despatching of personalized card by secure post, receipt of said card by the citizen with a proof of delivery by ICC and confirmation to the CCO, activating the card by the CCO, and despatching computer generated 6-digit PIN to the citizen in a secure manner.

The present invention further provides features to create, establish and operate a smooth, citizen-friendly procedure for enrolment of citizens across the country to the National Citizen ID Card Programme;

to create, establish and operate a centralized national-level database of all citizens known as the National Registry (NR) (also referred to as Centralised Data Repository or CDR), and thereby provide governments a ready resource of all citizens—something that is non-existent at the present time; yet preserves the confidentiality of stored data and safeguards privacy of citizens;

to personalise and deliver high security, tamper-proof National Citizen smart identity cards to citizens, which can be remotely activated/deactivated by authorities, thus altogether eliminating identity thefts and frauds, impersonation, forgery and misuse of identity cards;

to create a seamless interface between various government and other agencies to provide a robust and efficient platform for C2G and G2C interaction;

to ensure an efficient and secure method of border control and internal security procedures;

to facilitate a reliable, electronic entry regulation for important events or specifically designated areas;

to usher modern e-Governance practices with futuristic features and wide ranging capabilities for efficient administration of populace;

to create a novel and unprecedented method for citizens to exercise franchise remotely, online, by electronic means, with utmost reliability and security, resulting in accurate, real-time poll results sans risks of errors, malpractices and mala fide influences;

to offer an 18-digit scientifically composed unique citizen identity number valid for the lifetime of the citizen, with specially designed identifier fields which impart extra-ordinary value-in-use, which serves as the primary identifier and single reference point for all matters relating to the interface of each citizen with government and other agencies;

to provide for secure storage of data on smart card chip of the identity card covering all facets of citizen in novel, convenient and unique configurations;

to provide for secure flow of stored data from NR (CDR) to chip of smart card via reader-writer devices by means of secure channels of electronic data transmission and stringent, multiple-level data access control;

to hold a host of biometric data pertaining to each citizen both in the NR and on the smart card chip, which serve as infallible proof of the real identity of each citizen;

to provide for instant verification of citizen's data by authorized personnel of respective government or other agency at conventional, office locations via standard PC terminals or at remote locations via hand-held reader units and mobile/wireless communication devices with inbuilt display units, offered as part of the deliverable supplies;

to serve as a reliable means of visual identity, whereby, at the basic level, the instant ID Card is adequate to complete many routine applications of identity verification;

to serve as a single identity card for all applications, hence truly multi-functional, and includes the needs of present and future e-Governance practices;

to provide the means for authorities to undertake a wide range of statistical analyses which help in planning administrative and security strategies, as well as in macro-economic planning and policy framing by federal and state/provincial governments;

to provide a ready method to electronically replace the conduct of physical, national-level census operations, by creating and maintaining an electronic population database spontaneously by means of compulsive compliance by citizens;

to provide easy-to-access citizen-friendly services close to citizens' homes covering all the needs of citizens for interaction with governments and other agencies, by means of India Card Centres (ICCs) in every neighbourhood, manned by specially trained staff under the public private partnership format;

to create a method to ensure and oversee compulsive compliance by citizens with all laid-down laws of the country—especially tax and fiscal laws—thus ensuring a high degree of suasive socio-economic discipline, which is an essential ingredient for national progress;

to serve as an inland/regional passport with utmost reliability and facility by the provision of Machine Readable Zone (MRZ) on the reverse of ID Card;

to cover identification requirements of all categories of non-citizens as well;

to hold digital signature of citizens and facilitate affixation thereof in a secure environment controlled by 6-digit user-PIN, for all e-Governance related requirements;

to provide a powerful electronic infrastructure with system of alerts and controls for remote surveillance of unlawful activities, and to effectively combat crime and terrorism;

Method for providing a smart card based national level identity management system via a single, harmonized identity reference for each citizen encompassing multiple functions and a comprehensive range of applications for operationalising a modern e-Governance programme are described. The instant invention provides a unique citizen identity number incorporating key biometrics data pertaining to each citizen stored in main server also known as National Registry (NR) and on the smart card. The National Registry or Central Data Repository (CDR) comprises a national-level database of all the citizens held at the National Control Office of NCID, and thereby provides governments a ready resource of all citizens by creating an interface between various governments and other agencies vs citizens.

### BRIEF DESCRIPTION OF THE DRAWINGS

FIG. 1: illustrates the obverse and reverse views of the design and make-up of the Premium Category of National Citizen ID Card, according to the instant invention.

FIG. 1A: illustrates the obverse and reverse views of the design and make-up of the Standard Category of National Citizen ID Card, according to the instant invention.

FIG. 1B: illustrates the obverse and reverse views of the design and make-up of the Minor's Category of National Citizen ID Card, according to the instant invention.

FIG. 1C: illustrates the reverse view of the design and make-up of (any of the above categories of) National Citizen ID Card, MRZ: Machine Readable Zone, widely used in international travel documents such as passports, visa, trans-regional Citizen ID Cards is provided optionally at the bottom panel on the reverse of the ID Card, at the instance of authorities, according to the instant invention.

FIG. 2: illustrate the flow diagram depicting the issuance process of national citizen ID Card to citizens, according to the present invention.

FIG. 3: illustrates the macro structure of India Card Centres (ICCs) from the apex level of Central Control Office to the field level of ICCs, according to the present invention.

FIG. 3A: illustrates the layout of the National Citizen ID Enrolment and Services Facility—herein referred to as “India Card Centre” or ICC for short—for Type M: Metro Facility including Category A Cities.

FIG. 3B: illustrates the layout of the National Citizen ID Enrolment and Services Facility—herein referred to as “India Card Centre” or ICC for short—for Type A: Advanced Biometric Capture Facility.

FIG. 3C: illustrates the layout of the National Citizen ID Enrolment and Services Facility—herein referred to as “India Card Centre” or ICC for short—for Type S: Standard Facility for Urban Areas including Category B, C and D Cities/Towns.

FIG. 3D: illustrates the layout of the National Citizen ID Enrolment and Services Facility—herein referred to as “India Card Centre” or ICC for short—for Type R: Rural Facility.

FIGS. 4 & 4A illustrates the method of processing and verifying citizen's application for grant of National Citizen ID Card.

FIG. 5 illustrates the sequence and means for capturing the biometric data of the applicant, according to the present invention.

FIG. 6 illustrates the flow when the data of each applicant is sent from the Zonal Control Office of NCID to various departments for verification, according to the present invention.

FIGS. 7 & 8: illustrate the Doughnut Chart and the composition of segments of data stored on the smart card chip of National Citizen ID Card appurtenant to the Premium Version of Card together with Identification Codes of Data Segments (ICDS) thereof, according to the instant invention.

FIGS. 7A & 8: illustrate the Doughnut Chart and the composition of segments of data stored on the smart card chip of National Citizen ID Card appurtenant to the Standard Version of Card together with Identification Codes of Data Segments (ICDS) thereof, according to the instant invention.

FIGS. 7B & 8: illustrate the Doughnut Chart and the composition of segments of data stored on the smart card chip of National Citizen ID Card appurtenant to the Minor's Version of Card together with Identification Codes of Data Segments (ICDS) 5 thereof, according to the instant invention.

FIG. 9 illustrates an exemplary system depicting the Multiple Uses of National Citizen ID Card, according to the present invention.

FIG. 10 illustrates an exemplary system depicting the Card Deployment Schematic of National Citizen ID Card, according to the present invention.

FIG. 10A: illustrates the various transactions of citizens record of which are directly interfaced from originating department's e-governmental server to NCID server.

FIG. 10B: illustrates the various activities requiring mandatory deployment of the citizen ID card for the respective transactions shown therein.

FIG. 10C: illustrates the various citizens' activities requiring compulsory furnishing of their national ID number for the respective transactions shown therein, for which the actual deployment of the ID card is not essential.

FIG. 10D: illustrates the activities which require compulsory voluntary event-based disclosure by citizens in respect of each of the events shown therein.

FIG. 11 illustrates an exemplary method of performing transaction under Public Distribution System using the National Citizen ID Card, according to the present invention.

FIG. 12 is a flow diagram illustrating an exemplary method of securing of Driving License by citizen from RTO using National Citizen ID Card, according to the present invention.

FIG. 13 illustrates the Schematic showing flow of citizen's data from Implementing and Operating Agencies of the NCID Programme to the National Registry and between such Agencies inter se, according to the present invention.

FIG. 14 illustrates the sequential Conglomeration of Data Fields of all Tabs and Sub Tabs in National Registry and on memory chip of citizen ID Card as seen in English, which will be correspondingly facilitated in Hindi and in all official Indian languages in due course.

FIGS. 15 to 24 are embodiments of one of the chosen methods of illustrating the content, composition, inter-linkage, sequence and configuration of specially assembled data pertaining to each citizen, now seen in the form of uniquely designed and developed Tabs (Tabulated Authenticated BiographicS), according to the present invention, with the functionalities and utilities of said Tabs being expandable/upgradeable without restriction, and the memory storage space for each Segment originally allocated both in the NR and on the card chip being seamlessly variable to accommodate varying needs of data storage of each citizen.

FIG. 25 illustrates the Population Coverage Priority Classification for National Citizen ID Card Project implementation on a countrywide basis, showing the focus and thrust for optimum coverage of population based on three criteria viz., geographic location-wise, age group-wise and income group-wise.

FIG. 26 illustrates the national-e-Governance Programme using the IDMax® wherein the NCID Card is a tool to achieve the programme objectives on a countrywide basis, showing the distinct areas of citizen-to-government and government-to-citizen interfaces operating under e-Governance with optimum coverage of population.

FIG. 27 illustrates the Context Diagram showing Schematic of Dataflow from RTO's to Citizens' e-File in National Registry, which is representative of the flow of key citizen-centric data from various government departments and other NCID Project-related agencies to the concerned segment of the Citizens e-File in the National Registry, through official channels as defined by government authorities.

FIG. 28: illustrates the Macro View of Compulsory Population Coverage under National Identity Management Project for implementation on a countrywide basis, showing the master plan for coverage of the total population under a comprehensive Identity Management System, with distinct identity solutions for the two principal and distinct Groups viz., (a) Citizens and (b) Non-Citizens, showing classification of persons under each Group as well as the three types of visually distinguishable Identity Cards for each Group.

FIG. 29: illustrates the three distinct types of Identity Cards for Non-Citizens offered under the instant invention for issuance under the National Identity Management Project on a countrywide basis, containing respectively the (1) Resident National ID Card; (2) Temporary National ID Card; and (3) Alien National ID Card.

FIG. 30: illustrate the layout and schematic of the proprietary ENCID File, which is generated and assigned a unique ICC-centric number individually for each citizen at the time of enrolment to the national ID Project at the IndiaCard Centre, and to which is uploaded basic particulars of the citizen, various biometric data of the citizen, scanned images of the citizen's application form and checklist, foundational documents furnished by the citizen in supporting his (her) application, as well as all presently held ID and other cards/registration certificates, which are respectively stored on each of the relative Tabs shown therein.

### DETAILED DESCRIPTION OF THE INVENTION

The instant invention is a system and method for creation of a centralised national level database of all citizens (separately for non-Citizens) which is structured as the foundation for (i) implementing a national identity management system covering all citizens via smart card and (ii) for introducing secure e-Governance procedures covering a comprehensive range of citizen-to-government and government-to-citizen applications. The present invention is not intended to be restricted to any particular form or arrangement, or any specific embodiment, or any specific use disclosed herein, since the same may be modified in various particulars or relations without deviating from the spirit or scope of the claimed invention herein shown and described of which the system or method shown is intended only for illustration and disclosure of an operative embodiment and not to show all of the various forms or modifications in which this invention might be embodied, implemented or operated.

The invention is also referred to as the CimeGo System®—which is an acronym for Citizens' Identity Management and e-Governance System. The invention provides a unique citizen ID to each and every incorporated on a smart card which serves as a permanent and reliable means to establish the true identity of each citizen. It further facilitates a wide range of e-governance programmes. The smart card provides for multiple applications serving as a single interface for all transactions required by an individual. When the smart card is inserted in the card reader and writer unit installed at convenient locations at all NCID Project implementing agencies, the citizen's identity is spontaneously verified and he/she can perform desired transaction having designated application. After the transaction is performed, the updated data pertaining to said transaction is sent to the main server of that Department/Organization in each zone, which links all units thereunder, performing similar functions. The data from the main server is then sent to the Zonal Control Office where it is examined and transmitted onward to the National Registry (NR) or Central Data Repository (CDR) for permanent storage. The same updated data is then transmitted to and stored on the respective citizen's smart card when the card is submitted at any card center for periodic updations, by means of the card writer unit, via a highly secure and well-defined data communication channel which embodies stringent control and monitoring procedures. Various e-governance practices are also carried out using the same NR as the foundation, where the citizen's NCID Card serves as a reliable tool and operating link between citizens and government.

This invention can be described better by way of example of a Country. The specification herewith takes the Country India as an example to explain the invention, It may be noted that throughout the specification including claims where-ever reference is made to India or India specific terms, it is by way of exemplification only, as these terms can be easily replaced with the particular country specific term where the invention would be applied or deployed.

It may be clear to the person skilled in the art that such terms/terminology can be replaced with local terms/terminology relevant to the country where the invention for the patent applicant will be applied.

In India, there is no secure, credible national citizens' identification card or identity system per se to serve the primary role of irrefutably establishing the citizenship and identification of Indians. In other words, there is no definitive and completely reliable documentary means existing for a person to prove his citizenship as an Indian, nor to establish his identity (except the passport which only a very small percentage of Indians possess; and voter ID Card, which lacks credibility owing to significant numbers of fake versions in circulation).

Over the last quarter century, the Central Government and various Departments of State/UT Governments have variously issued different types of cards to citizens to serve specific functions. Examples of these include PAN card, voter ID card, BPL card, PDS card, driving licence, etc.

However, none of these was intended to serve principally as a true means of identity. Circumstantially, for want of a better alternative, each of these has been used additionally as a means of proving one's identity, after fulfilling its respective basic function.

Accordingly, none of these cards can be termed as a truly irrefutable means of establishing a citizens' identity. Moreover, all these cards have been produced using poor quality material, low technology, incorporating minimal (sometimes no) security features, devoid of biometrics. Furthermore, the enrolment and issuance procedures for these cards have serious lacuna in authentication processes. These deficiencies are confirmed by the presence of spurious/multiple PAN cards, voter ID card, diving license, ration cards, BPL cards, etc, running to millions in the aggregate.

The offering of the instant invention is a high security identity card issued to each citizen which serves the primary function of irrefutably establishing his (her) true identity, and confirming and validating that each person is genuinely the person he/she claims to be, without any doubt. This provides the operational basis for a modern, reliable and uniform identity management system on a nationwide basis.

The novel solution now offered provides both a visual form of identity as well as a more elaborate electronic means of establishing the citizen's identify with all relevant citizen's information and biometrics, available both on-line and off-line.

By virtue of the sophisticated technology of the solution provided and of the smart chip offered on the identity card, adequate provision is made to include the essential information relating to all existing ID and other relevant function-specific Cards issued to citizens by both Central and State Governments, achieved by storing the scanned visual images of each of these Cards (both obverse and reverse) (obtained at the time of citizens enrolment and scanned and uploaded to the respective citizen's Encid File) in specific slots allocated citizen-wise in the database of the National Registry as well as on the memory chip of the smart ID Card. This ensures the automatic weeding out—and paving the way for spontaneous cancellation—of all spurious cards and fake registrations.

By this method, an extremely reliable basis is created for issuance of all other certifications/registrations to citizens by respective Government Departments and other Agencies, resting on the single, new high-security ID Card with its unique, 18-digit number. In the case of citizens who do not already possess other cards/registrations, various Government Departments or Agencies issuing fresh certifications/registrations would not be required to assign any other numbers to said citizen, as all such registrations and certifications would automatically attain convergence on the single ID platform, as described above. In respect of citizens holding various existing cards/registrations, these registries would forthwith receive compulsory cross-referencing of the new 18-digit number.

This procedure imparts high value not only to the process of identity management but also in providing registration/services to citizens by various Central and State Government authorities and other agencies, achieved through the extremely simple, harmonious, unified and fool proof approach of the instant invention.

As a result, the possibility of fake cards, duplicate cards, misrepresentation and data manipulations—which are all so commonly witnessed today—would cease to be of concern to the authorities, since the stringent operating environment and card issuance procedure to be followed under the new system would altogether preclude any manner of physical or electronic manipulation, tampering, malpractice or deceit at any stage—whether before or after card issuance.

The present invention is now described in detail by referring to the accompanying diagrams.

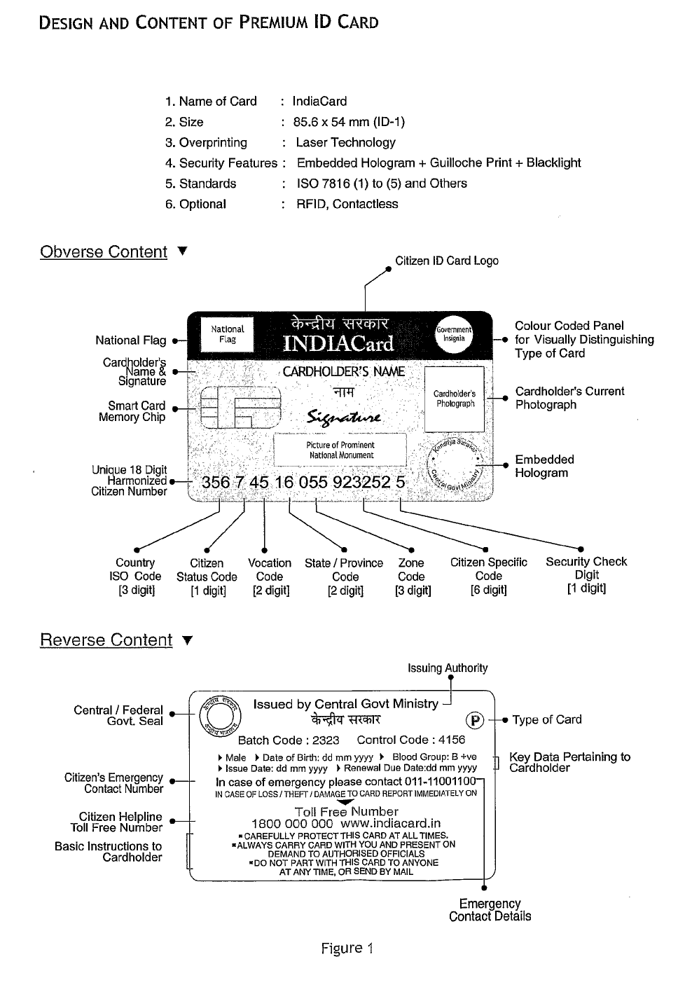

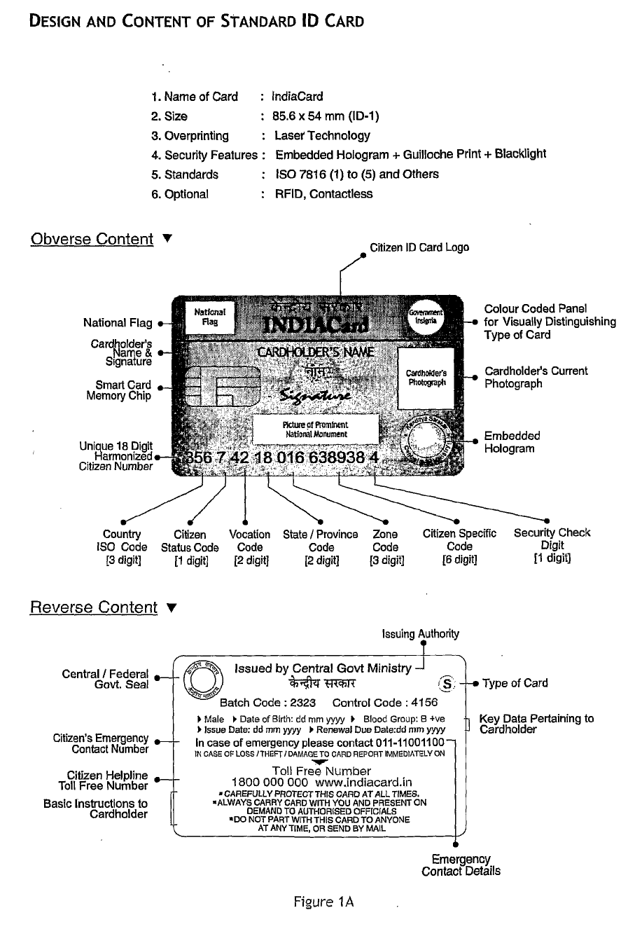

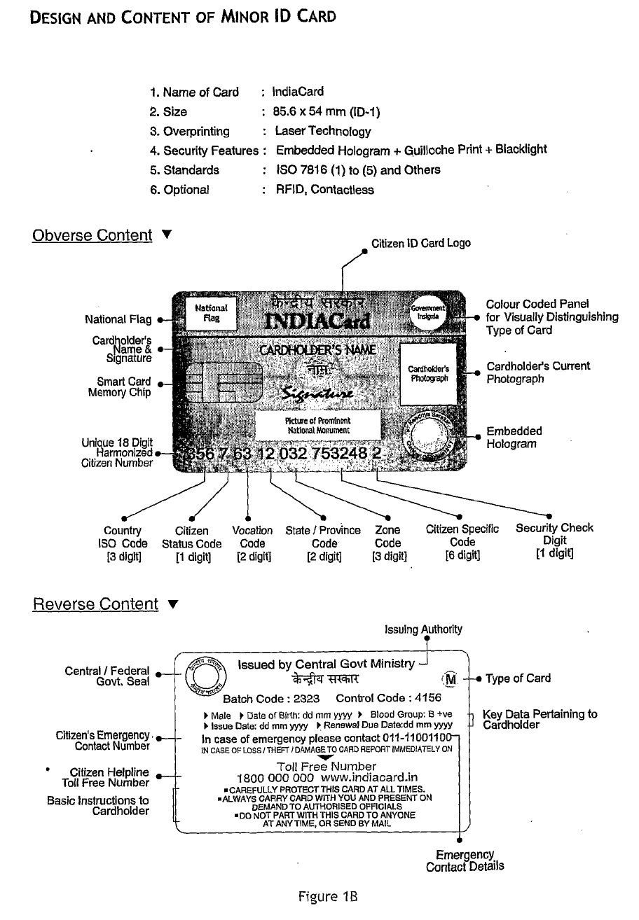

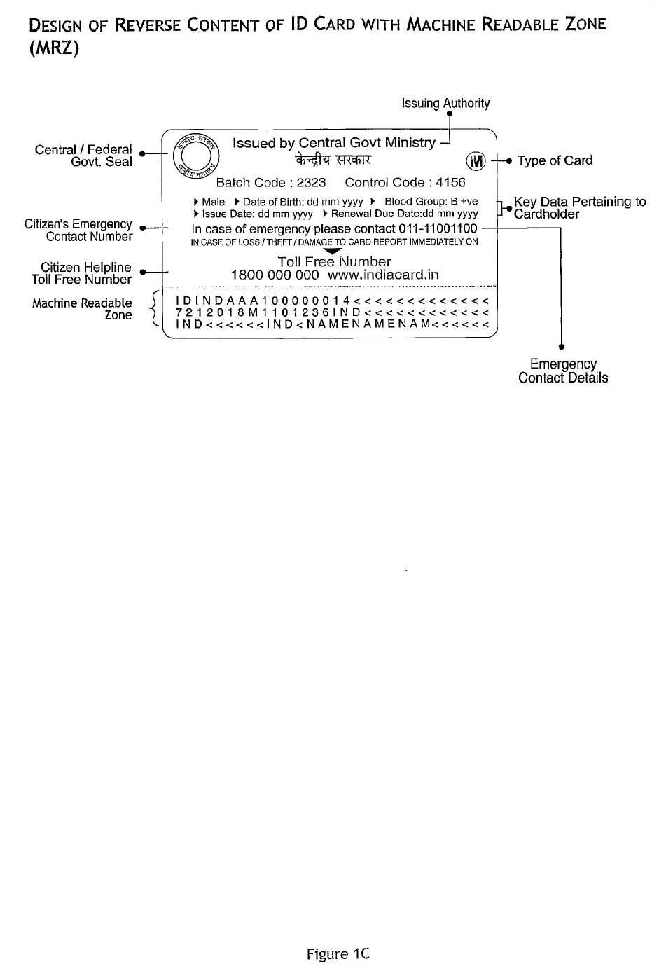

FIG. 1 illustrates the obverse and reverse views of the design and makeup of the Citizen ID Card according to the instant invention.

The present invention embodies a smart card chip. The capacity of the smart card chip can vary from 1.0 MB for the Standard ID Card and Minor's ID Card to 4 MB for Premium ID Card, or even higher capacity as desired. The Card is of standard international size of 85.6×54 mm (ID 1) fully compliant with ISO 7816 (1) to (5) and other international standards applicable to such products and services. The card is extremely secure because of the several in-built stringent protective features, which include embedded hologram, guilloche print, blacklight, variable surface level of citizen's signature image, and laser-etched unique 18-digit harmonized citizen number, which altogether preclude the possibility of forgery, identity theft, counterfeiting or misuse of the card. The card also incorporates Issuing Authority details which include computer generated batch code and control code numbers. The card is weather-resistant and extremely user-friendly. The Card can be optionally offered to include RFID and to function as a contactless smart card.

The most significant feature of the card is its self destructing nature, which is invoked when an attempt is made to tamper with it electronically. This prevents unauthorized access to the card. There will be a static password that accompanies the ‘Kill Command’. Whenever the chip senses the security threat, the kill command would get activated resulting in the destruction of the chip.

The 18-digit harmonized citizen number for each citizen has universal application and instant global recognition. This unique ID number is composed of various identifier groups which, when juxtaposed, ensure that only one unique ID valid for life is allocated to each citizen, serving as the key primary identifier at all times.

### Example

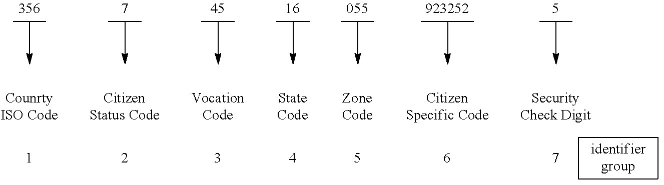

The methodology for deriving the numbers for each field are as described below.

Identifier Group 1 consists of 3-digit ISO country code, Identifier Group 2 consists of 1-digit citizen's status code, Identifier Group 3 consists of 2-digit citizen's vocation code, Identifier Group 4 consists of 2-digit issuing State code, Identifier Group 5 consists of 3-digit Issuing Zone code, Identifier Group 6 consists of 6-digit unique citizen-specific code, and Identifier Group 7 consists of 1-digit security check digit at the end. This numbering system facilitates efficient administrative control as well as rapid analysis and review of wide range of data relating to various facets of populace, apart from enabling effective e-Governance operational activity. This unique citizen ID Card incorporates key biometric data including photograph, finger/palm print, Iris scan, DNA mapping, digital signature and full body profile—which are all unique to each individual, hence irreplaceable by any means, whether official or otherwise.

In further process followed by deploying the instant invention, the new unique ID number would be incorporated on a high-security national citizen ID card to be issued to each citizen as shown in FIGS. 1, 1A and 1B respectively for each category of card, issuance of such card being an essential pre-requisite and basis to achieve the very objectives of establishing a national identity management system in the first place. Since the data captured including biometrics of each citizen is completed following extremely stringent enrolment procedures and after thorough verification and validation, no citizen can obtain such ID card through mis-representation or deceit. In other words, such ID card will irrefutably establish the true identity of each citizen, thereby affirming that the holder of such ID card is truly the person described therein. According to the instant invention, the unique ID number allotted to each citizen is concomitant with the respective ID Card issued under the relevant laws, and there is never an independent existence for either i.e., the unique ID number itself cannot exist on standalone basis, nor can an ID Card exist without the said unique ID number being imprinted thereon—they can only mutually co-exist.

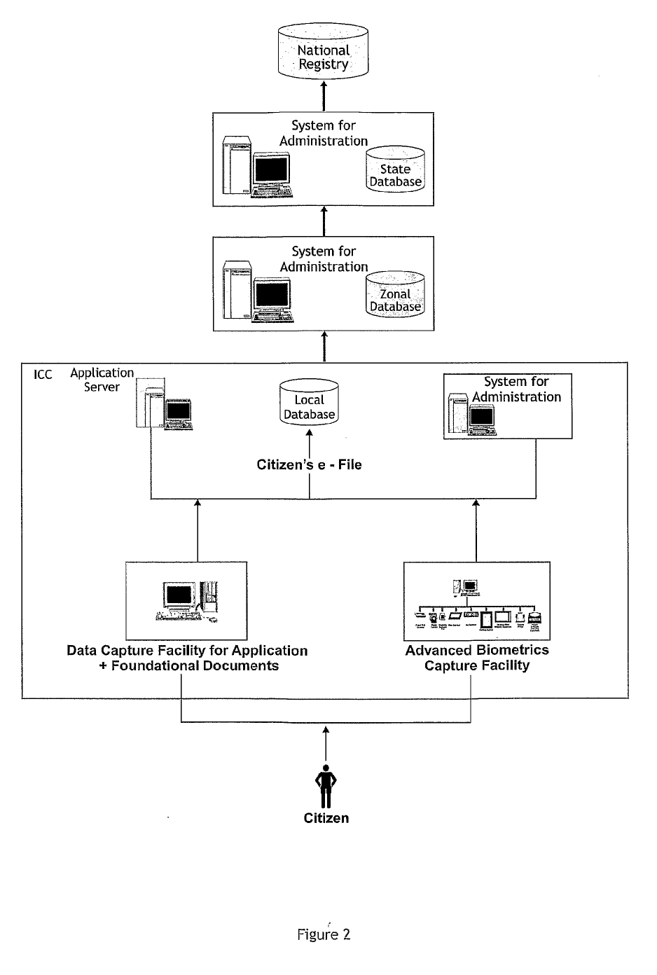

FIGS. 2 & 3 illustrate the system for issuing of the NCID card. Special Centres known as India Card Centres (ICCs) are provided at easily accessible points in every neighbourhood of each metro, city, town and tehsil of all Districts of every State and Union Territory of the country. Each State/UT is thus divided into administratively convenient, geographically well-defined Zones—each being allotted a distinct Zone Number—for the purpose of identity management as well as e-Governance of the populace. Each ICC is responsible for issuing of National Citizen ID Card to all the citizens within the designated geographic jurisdiction, and incorporates basic/advanced (as required) biometric enrolment facilities for the collection of biometric data of each applicant. The applicant (citizen) files a request for issue of a NCID card and submits the prescribed foundational documents to provide supporting evidence of the data filed by him. The ICC captures the biometric data of the applicant using the biometric enrolment equipment installed thereat. Then, together with the scanned images of the citizen's application and supporting documents, the said biometric data is uploaded to the local database at the ICC, in the format of an e-File with a distinct Temporary Control Number (TCN). The TCN incorporates the ICC Code and the Zonal Office Code, in addition to a non-interruptible serial number generated by the software installed at the Data Capture Station (DCS) of each ICC. All the ICCs in a district are linked together through a dedicated network such as local area network or through a wireless network to a server which is responsible for administering all the ICCs. The ICCs also work as dedicated Service Centres to provide citizens vital support services on an ongoing basis, including card memory updations, providing replacement of lost/damaged cards, substitution of Minor's ID Cards with Standard/Premium ID Cards, substitution of Standard ID Cards with Premium Cards, processing requests for data amendments/corrections and updations, grievance redressal, complaint processing, user assistance etc. The data from the local database of each ICC is periodically uploaded to a Zonal database at a Zonal Control Office. There are multiple number of Zonal Control Offices in every State linked together through a wide area network or wireless network. The functions of the Zonal Office are to receive completed application form, send data for verification to various concerned government departments/other relevant organisations, and receiving the results of the verification, approving the application for card issuance, and sending their recommendations to the State NCID Control Office for issuance of ID Cards to approved citizens. e-Files of approved applications are sent from the Zonal database to the State database at the State Control Office. Here, all applications are finally cross-checked and cleared in daily batches, and uploaded to the National Registry (NR) located at the National ID Card Centre, which is the apex control centre for the NCID Project. All the State (and UT) Control Offices (SCOs) are linked together to the highest level body for this Project viz., The National ID Card Central Control Office (CCO). The function of the CCO is to accord permission to grant ID Cards to approved citizens, which culminates in the act of allotting unique harmonized citizen ID number, which is conveyed online to the State Office of NCID. The State Office then issues written authorization to the Service Provider under the public private partnership (PPP) structure for card issuance, following various stringent laid down procedures. Data pertaining to all approved cases is furnished to the Service Provider. At the high security ID Card Production Facility established under the PPP and managed and operated by the Service Provider under the aegis of federal government and NCID officials, this data is utilised for the hi-tech, rapid production and personalisation of specially designed national citizen ID Cards, incorporating several advanced high-security features. After personalisation, the ID Card is embedded with electronic chip of designated memory capacity. An ID Card protective storage pouch with special lanyard, multi-language Instruction Booklet for citizens and packed in secure custom designed box, and prepared for dispatch to concerned citizen under covering letter from NCID authorities, via secure post.

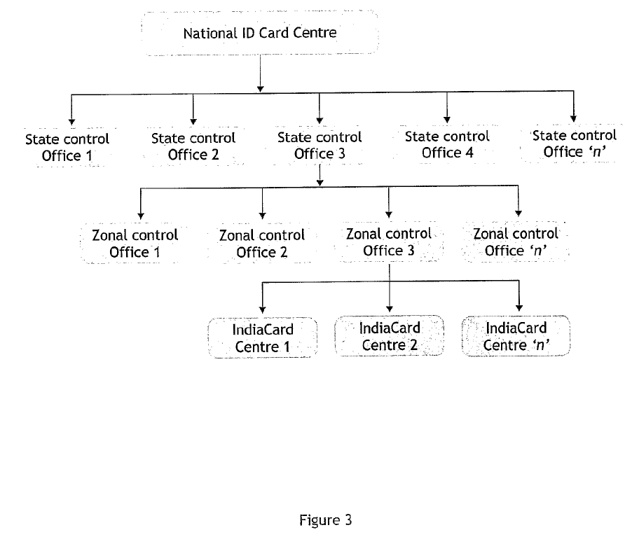

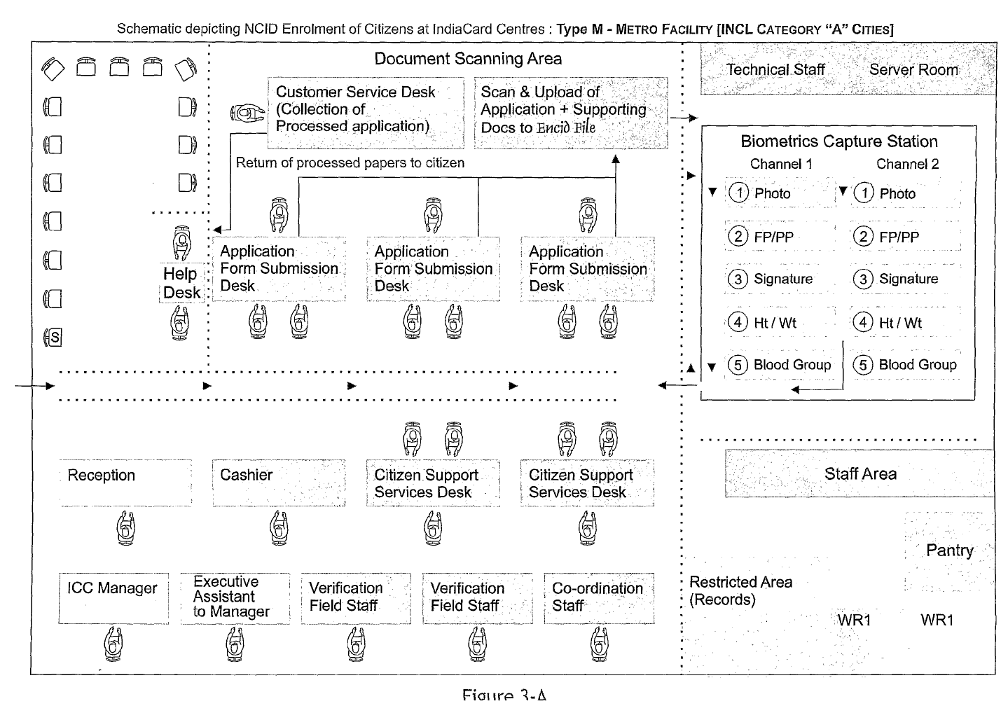

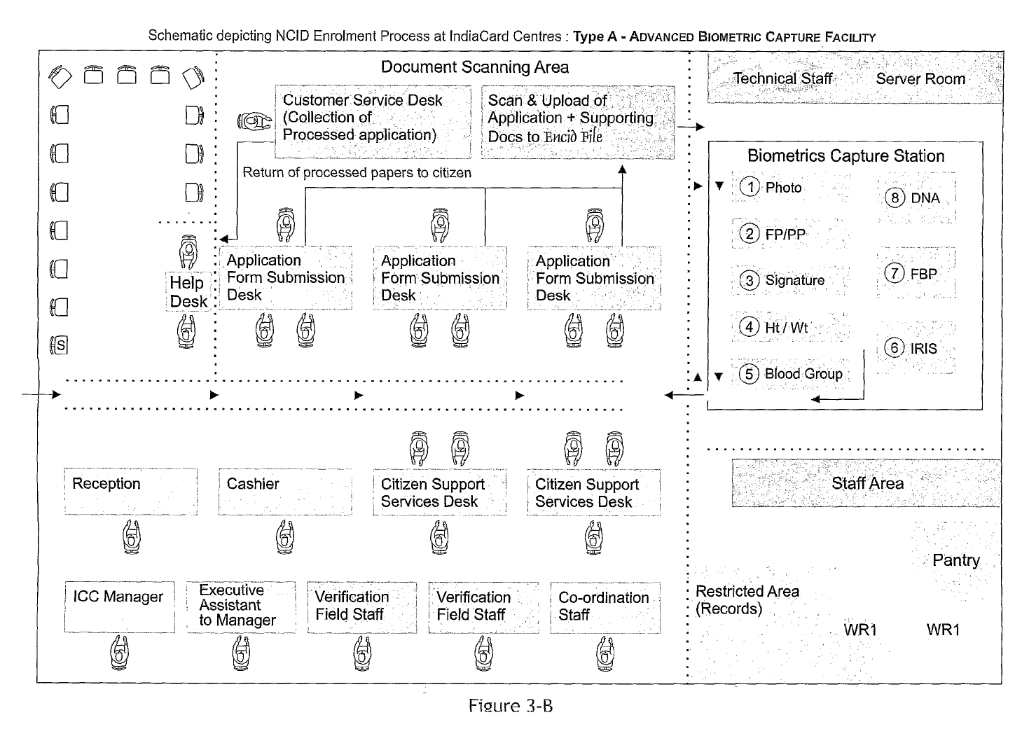

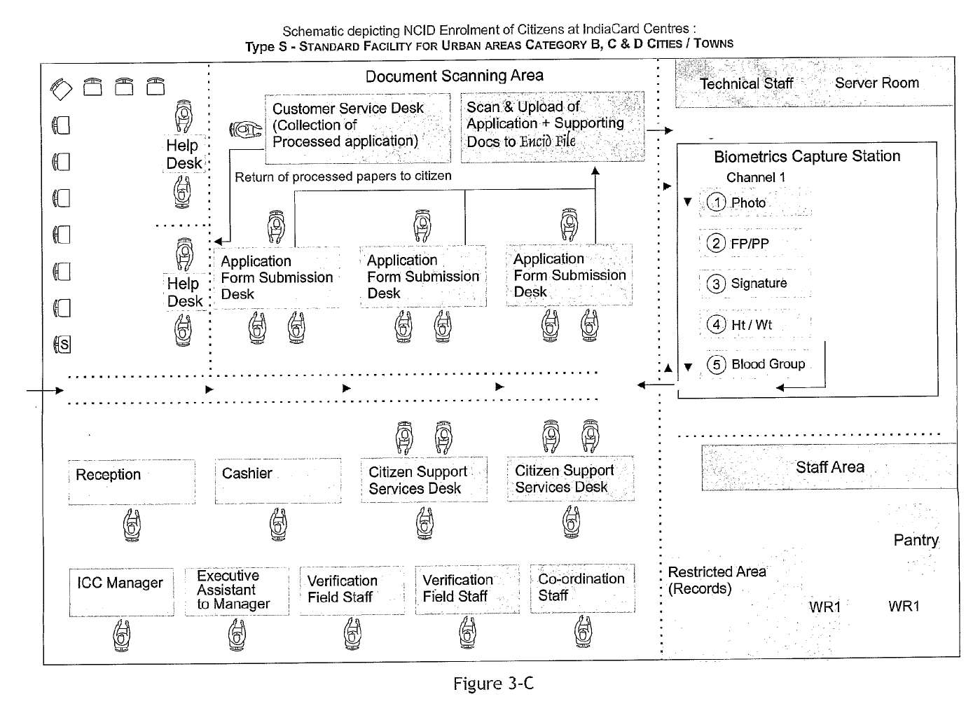

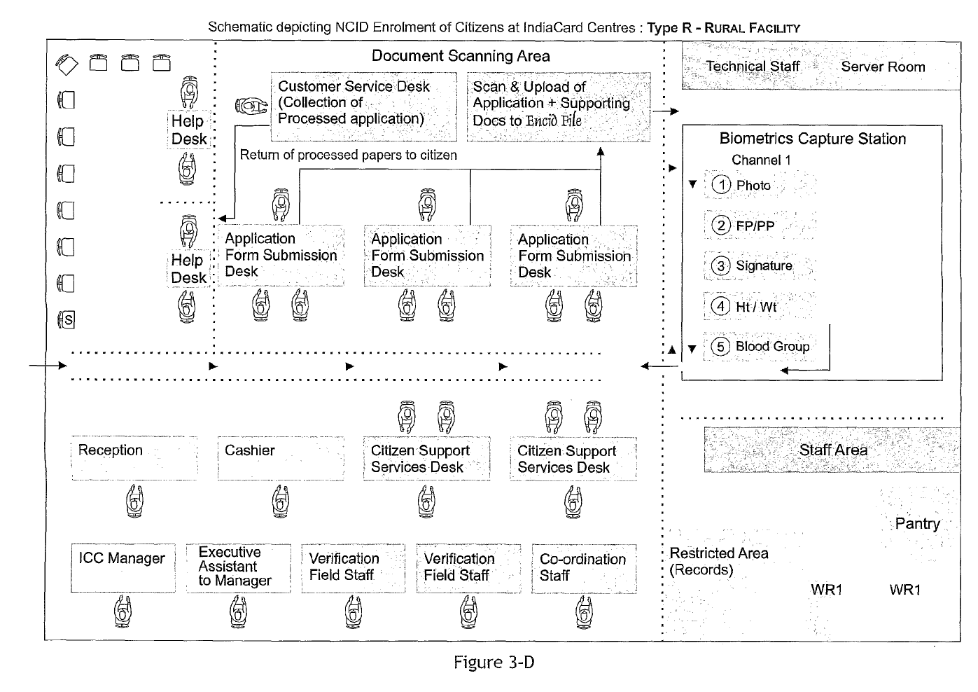

The layout of the National Citizen ID Enrolment and Services Facility—herein referred to as “India Card Centre” or ICC for short as illustrated in FIG. 3, is further elaborated by the illustrations contained in FIGS. 3A to 3D, which represent each of the four layout design options respectively for (1) Metro Facility (including Category “A” Cities); (2) Advanced Biometric Capture Facility; (3) Standard Facility for Urban Areas including Category “B”, “C” and “D” Cities/Towns; and (4) Rural Facility. Various functions carried out at such Centres are depicted in each of said drawings, and reflect optimum efficiency in servicing the needs of citizens—both during enrolment and post project implementation, while maintaining high degree of operational control and process automation.

The method for implementation of the national citizens' card project is unique and unprecedented owing to the novel approach for citizen data capture stations known as ‘India Card Centres’ are established throughout the country at locations convenient to citizens. Through Governmental orders, all citizens would be required to compulsorily enrol themselves at such Centres and provide relevant information pertaining to themselves and their family members utilizing the prescribed application form, supported by various prescribed foundational documents and the originals of all existing ID and other types of cards/registration certificates held by them.

The layout of the National Citizen ID Enrolment and Services Facility—herein referred to as “India Card Centre” or ICC for short as illustrated in FIG. 3 and as elaborated by the illustrations contained in FIGS. 3A, 3B, 3C and 3D which represent each of the four layout design options respectively viz., FIG. 3A: Metro Facility (including Category “A” Cities); FIG. 3B: Advanced Biometric Capture Facility; FIG. 3C: Standard Facility for Urban Areas including Category “B”, “C” and “D” Cities/Towns; and FIG. 3D: Rural Facility. Various functions carried out at such Centres are depicted in each of said drawings, and reflect optimum efficiency in servicing the needs of citizens—both during enrolment and post project implementation, while maintaining a high degree of operational control and process automation.

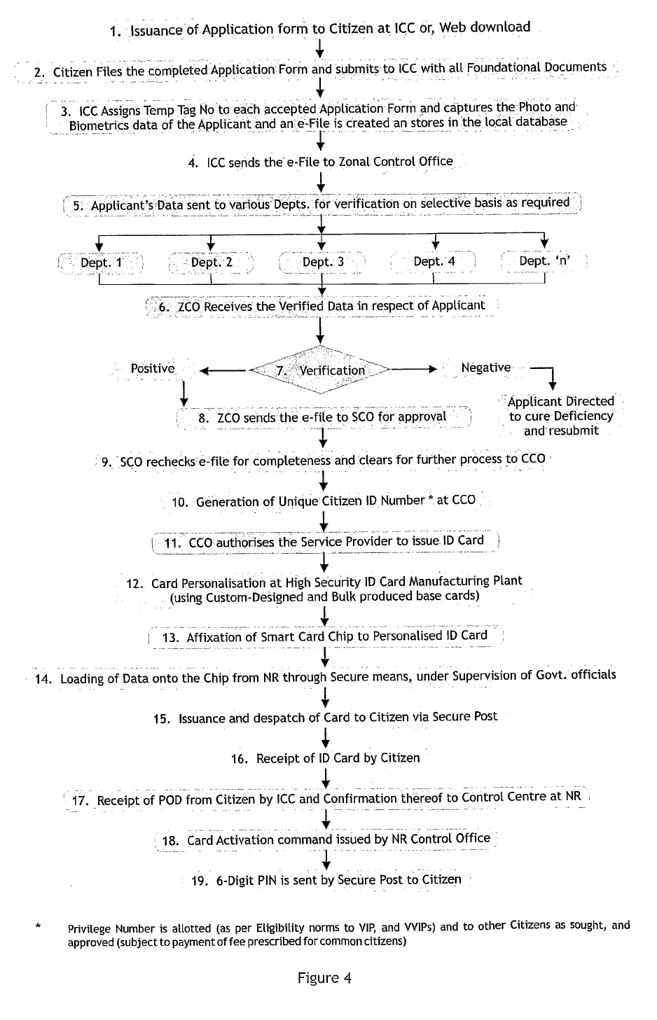

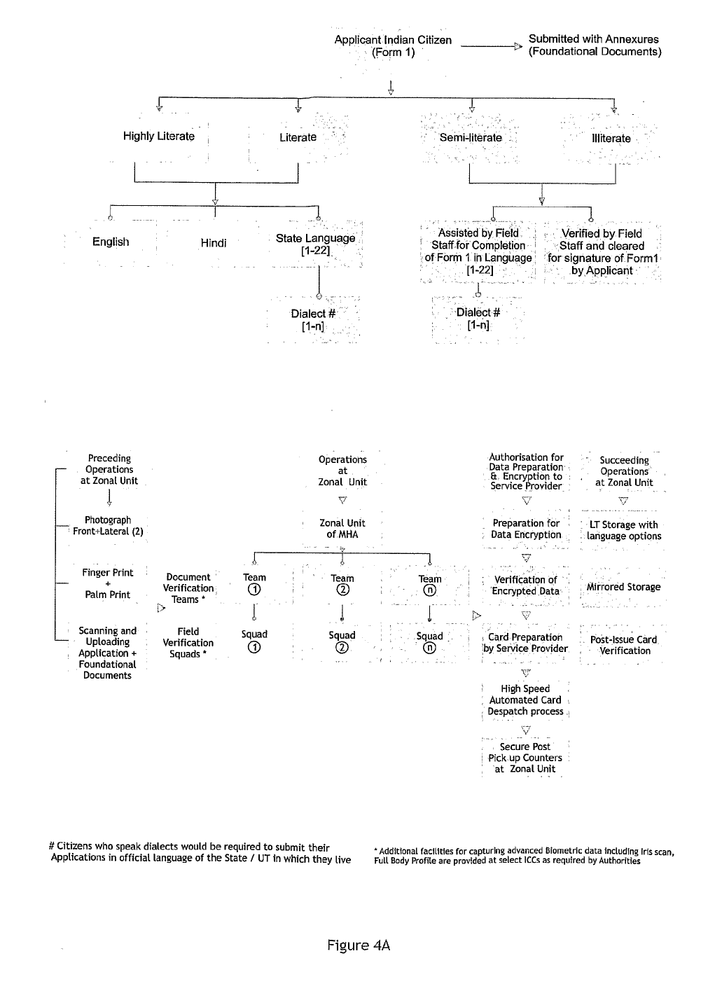

The method of processing citizen's application for grant of National Citizen ID Card is explained by referring to FIGS. 4 and 4A.

At step 1, citizen visits ICC and collects the prescribed printed Application Form accompanied by Instructions, which is provided free of charge to citizens across the counter; alternatively, citizens can download this from the NCID official web portal. Said Forms (and Instructions) are offered in Hindi, English and all official State languages.

At step 2, the Application Form is completed by the citizen providing all the required information, and supported by various prescribed foundational documents (either originals or certified true copies), which are then submitted in one set in person at the jurisdictional ICC. Help Desks at ICC provide hands-on service to citizens to assist in completion of all enrolment procedures to ensure that the Application Form has been filled in completely and accurately, and that all the supporting documents are in order.

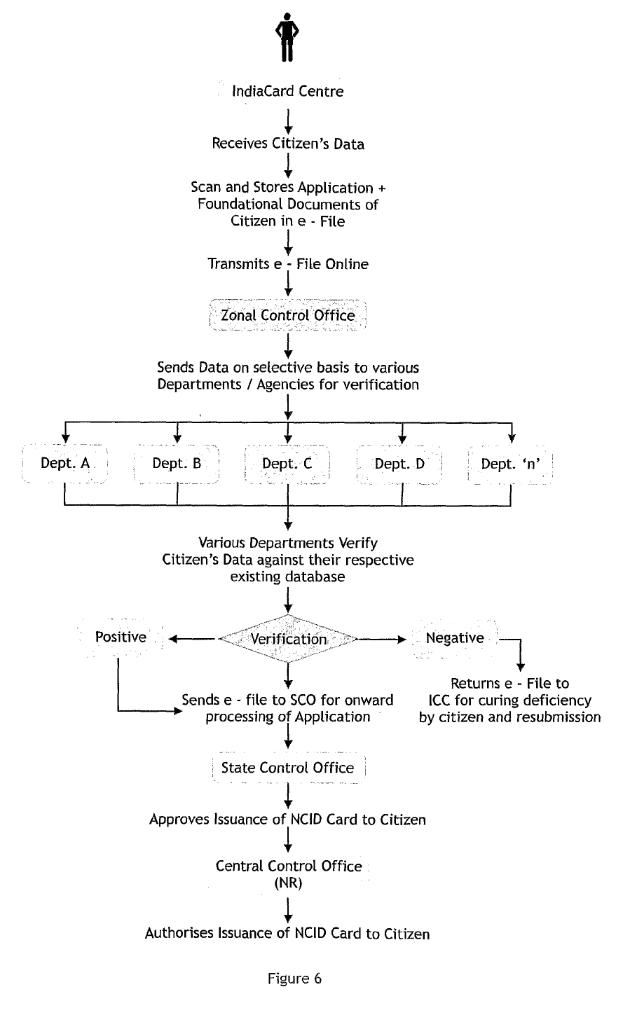

At step 3, said verified and accepted Application Form along with supporting foundational documents are forwarded to the Citizen Enrolment Station (CES) within the same ICC, where (i) the said documents are scanned and uploaded to the local database and the same are returned to the citizen thereafter, with a machine stamping confirming the acceptance of the Application Form and recording the time and date of acceptance, along with ICC Code and TCN reference, thus no paper record storage at the ICC is envisaged; and (ii) citizen's biometrics are captured by means of biometric enrolment equipment as shown in FIG. 6. The operational means used to capture some or all of the biometric data of citizens, as required by the NCID Authorities, include the deployment of specialized equipment such as finger print scanner, digital camera, electronic signature pad, palm scanner, iris scanner, full body scanner and DNA mapping equipment. Contents of (i) and (ii) are combined and stored in a distinct e-File created for each citizen, identified by means of the TCN assigned to it. The original application form and supporting foundational documents submitted by the citizen are returned to him/her forthwith after scanning and uploading at the ICC, thus enabling and introducing a paperless regime in the NCID Project, which is the most appropriate precursor to e-Governance.

At step 4 & 5, said e-File is sent online to the Zonal Control Office (ZCO) of NCID, where citizens' claims made in foundational documents submitted by them are referred to various departments such as public distribution system, Income tax office, RTO, Election Commission, etc for verification/validation, on selective basis as required.

At step 6, the verified data from various departments is received by the ZCO in respect of the applicant. Where the verification (step 7) is positive, then at step 8, the ZCO uploads the e-File to SCO database with the duly approved by it. But if the verification received is negative, the applicant is directed to rectify the errors/cure the deficiencies, to qualify for step 8 processing. If citizen fails or is unable to comply, then his (her) application is turned down, and fact thereof recorded in the NCID system.

At step 9, the e-File is checked and verified by SCO from higher perspectives following prescribed examining guidelines, and then cleared and forwarded online to the CCO for final processing. If a citizen clandestinely attempts to obtain a second NCID Card from another geolocation under false identity, the IDMax®Filter instantly alerts the authorities by detecting such fraud by rapidly tracing data matches in existing NR. This ensures unprecedented safety in enrolment and card issuance, altogether preventing obtention of a second NCID Card by any citizen.

At step 10, the CCO completes its approval procedures, which culminates in the allotment of a unique ID number, following the methodology described herein under FIG. 1. Privileged numbers are allotted as per eligibility norms to VVIP and VIP citizens, whereas for common citizens desirous of having them, the same is issued at a specified, scaled additional fee, depending on whether the number belongs to the titanium, platinum, gold or silver class. The unique number so allotted is valid for the lifetime of the citizen. For purposes of administrative control of NCID authorities and of Service Provider, the original TCN assigned by ICC to each accepted application form is recorded under the Card History Data (CH) segment of the stored e-File, both at the NR and on the chip of the issued ID Card.

At step 11, CCO authorizes the Service Provider via the SCO to issue the ID Card. This Card Issuance Authorization (CIA) is sent online to the SPR (Service Provider), in convenient batches of optimum size of at least 5,000 e-Files, accompanied by a Card Personalisation Order (CPO), which comprises a tabulated e-Format which includes the critical data to be incorporated on the ID Card.

This includes the CPO serial number, unique ID number allotted to citizen, name of the citizen as it should appear on the Card, citizen's photograph, signature, sex, date of birth and blood group; as well as the date of card issuance and its renewal date, batch code and control code.

At step 12, the NCID Service Provider carries out the instructions contained in the CPO at the high security ID Card Manufacturing Plant using sophisticated equipment, complex processes and custom-designed techniques, where personalisation is completed using the base cards which are produced in bulk embodying various security features and details of issuing authority, and kept ready in a secure and safe environment.

At step 13, the smart card chip of appropriate capacity is embedded on the personalized card.

At step 14, appropriate data of the citizen stored on the NR is loaded onto the card chip by secure means.

At step 15, the card is dispatched to the citizen by secure post or other reliable transmission means.

At step 16, the card is received by the citizen and at step 17, the Proof-of-Delivery (POD) signed by the citizen is received at the jurisdictional ICC, where it is scanned and uploaded to the citizen's e-File. Then a Card Received Confirmation (CRC) is sent from the ICC to the NCO via ZCO and SCO stating that the citizen has physically received his (her) ID Card, with date thereof.

At step 18, the card is activated remotely by the command issued by the control centre of NCO, enabling the citizen to deploy his ID Card.

At step 19, a 6-digit computer generated PIN is sent to the citizen (except minors) by discreet and secure means, same is deployed for e-transactions and various other security-backed online applications.

The method for implementation of the national citizens' card project is unique and unprecedented owing to the novel approach for citizen enrolment, wherein a single high-security identity card replaces all other existing ID and other types of cards and registration certificates issued by various central, state and local authorities, and wherein the said high-security ID card contains distinct segments which hold images/descriptive details of all such other cards via porting key summary data from existing databases and sourcing scanned images of such cards from citizens themselves during the enrolment process, thereby obviating multiple identity and other cards presently held by certain citizens; and consequently, overcoming variance in citizen's name and other key particulars that may appear differently from one card to another, whether caused accidentally or intentionally—as all cards and registration certificates owned by a citizen and tendered at the time of enrolment to the citizen ID Card programme are scanned and uploaded to the ENCID File as described above, to converge therein. Consequently, citizens are automatically barred from providing false/multiple cards they may have acquired clandestinely and hold presently, to the enrolment authorities, as enrolment is completed following a stringent process incorporating biometrics, signature and 3-view photographs of each citizen captured live at the IndiaCard Centre, which are also uploaded to the ENCID File, along with basic particulars of the citizen. Eventually, all such data come to rest in the citizen's e-file at the National Registry as well as reflected on the smart card chip embedded on the Citizen ID Card, according to the present invention.

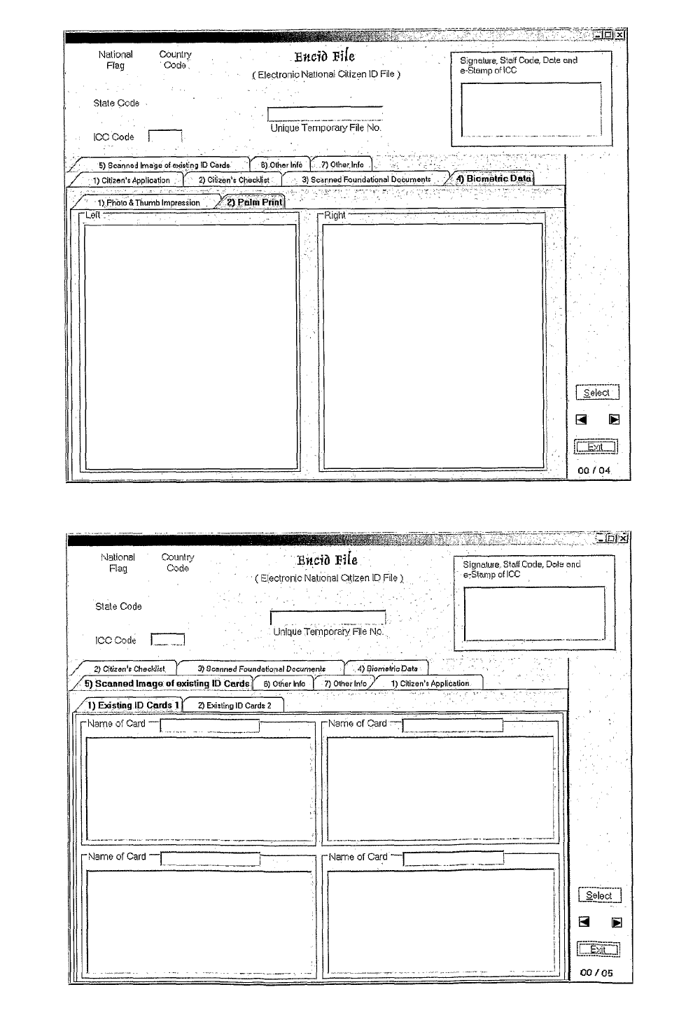

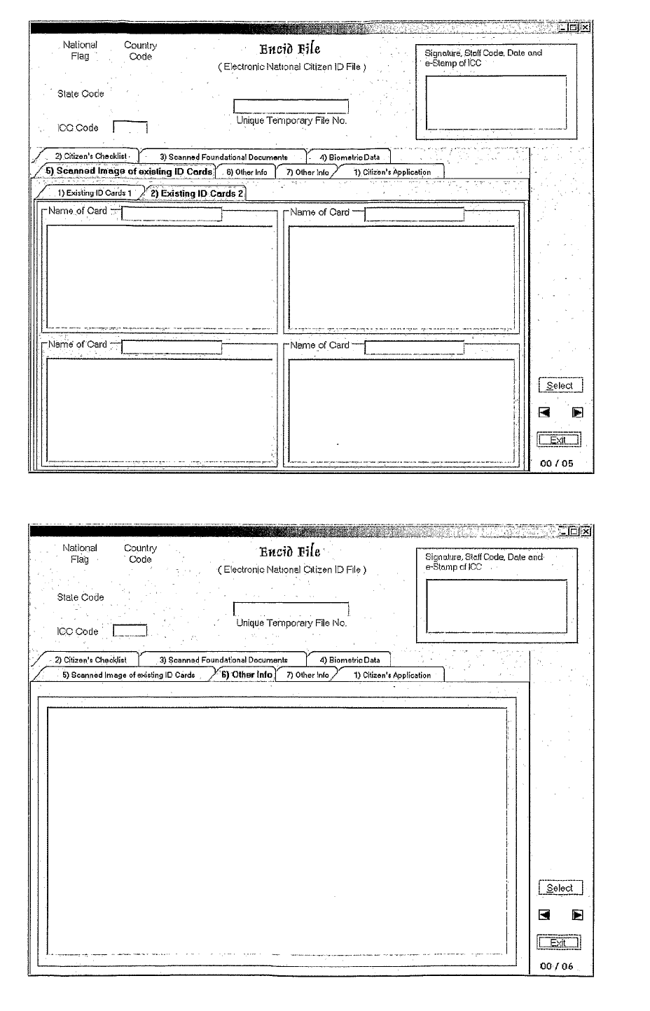

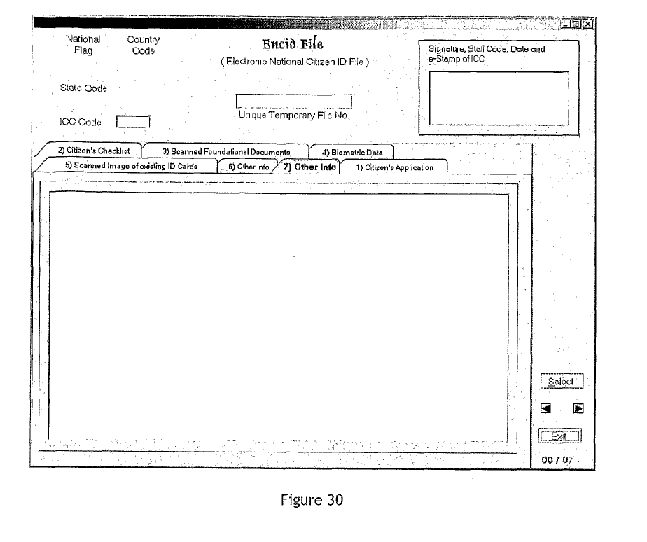

At the India Card Centre, a stringent enrolment procedure is followed for every citizen, and the citizens' application form containing above information is scanned and uploaded in distinct electronic files, created separately for each citizen known as ‘ENCID File’ bearing an ICC-centric distinct access control number, and as illustrated in FIG. 30.

To this ENCID file are also uploaded scanned images of (the obverse and reverse sides) of all the above ID and other cards held by respective citizens for eventual, permanent storage at the National Registry, with corresponding copy also stored on the smart card chip of the new ID Card issued to each citizen.

The originals of all scanned cards/registration certificates are forthwith returned to the citizen along with the application form after capturing their images, with the application form being franked electronically with the date, time and ICC stamp and the name and electronic signature of the officer in charge at such centre. The entire ENCID file is then scrutinized by designated government officials and stringent validation process completed.

Thereafter, the ENCID file is forwarded online to the concerned central government authority for allotment of unique national citizen identification number. Once allotted, this number is valid for the life of the citizen to whom it is allotted, and becomes the permanent reference point for all interaction between the citizen and the government—central, state and local. Thereafter, this unique ID number is transmitted online by the authority issuing the same to all central and state Government departments/agencies, particularly those which have issued the ID and other cards/registration certificates to respective citizen as mentioned above.

The purpose of doing so is to create a retro cross-reference record at each such government agency/department of the new unique ID number appurtenant to the respective card originally issued by them. Example: voter ID card, driving license, BPL card, PDS card. By this method, all future interaction between the citizen and the said agencies/departments will compulsorily reflect the new citizen unique ID number. Consequently, all fake/multiple cards in the possession of unscrupulous citizens would be automatically barred from usage for any application. Respective government departments/agencies would thus be able to automatically weed out and rapidly eliminate all spurious cards hitherto clandestinely obtained by unscrupulous citizens.

The most significant and unprecedented benefit of this methodology is that upon completion of retro cross-referencing as described above, the Government authorities would, as and with effect from a designated cut-off date, acquire by means of appropriate national level legislation, the statutory right to confiscate and appropriate all fixed assets as well as bank deposits and current/savings/other accounts (having credit balances) of citizens which remain devoid of cross-referencing with the new ID Number. Liquidating these assets would provide adequate cash resources to the Government to meet a significant portion of the cost of the new ID Card Project proposed herein and covered by the instant invention. The inherent and significant resultant benefit to respective government agencies/departments who can no longer be deceived by deployment by fake cards is saving of very large amounts of money.

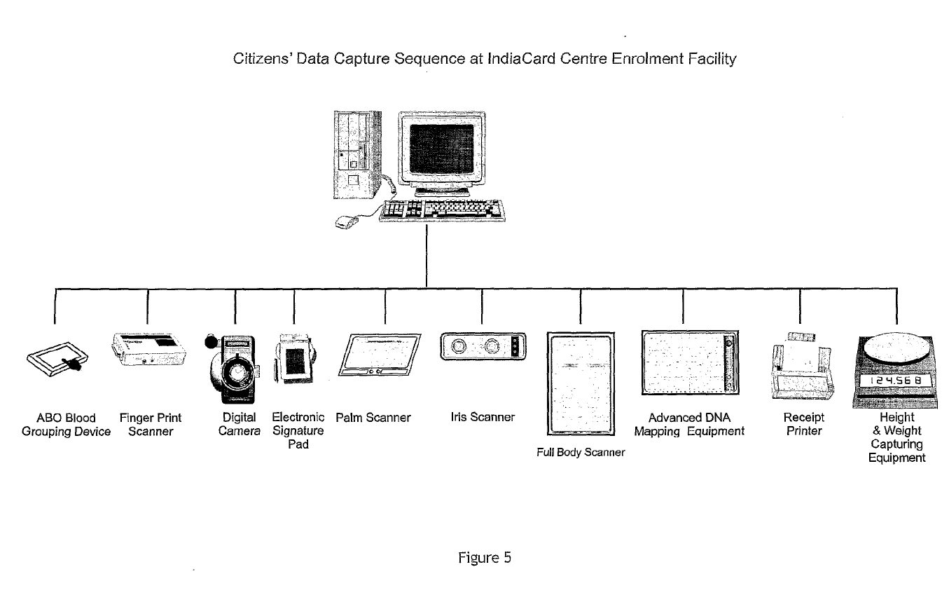

FIG. 5 illustrates the biometric enrolment facility for capturing the biometric data of the applicant at the ICC. The system is connected to various biometric devices such as finger print scanner, digital camera, electronic signature pad, palm scanner, iris scanner, full body scanner and advanced DNA mapping equipment for capturing respective biometric data of the applicant. The range of said biometric enrolment devices installed at each ICC shall be as decided by the NCID authorities, based on specific levels of security needs as evaluated by them, following guidelines from the central home ministry.

FIG. 6 illustrates the exemplary system showing the data flow of each applicant sent for verification to various departments from ZCO. The applicant's data as described in his/her application and as supported in the foundational documents submitted therewith, and biometrics captured at ICC is routed by ICC to ZCO. Said ZCO sends data on selective basis to various departments for verification via wired or wireless means. Each department includes one or more terminals, workstations that are either standalone or connected together through a local area network via networking means to an application server which holds the database of the citizens having their record or data in that department. Each said department verifies the data received from ZCO with reference to its own electronic database/physical records, and after verification is positive, confirms the veracity thereof to the ZCO via electronic or conventional means. If verification is negative, same is communicated to ZCO, which in turn informs concerned ICC to direct the applicant to cure the deficiency/remedy the defect and resubmit his/her application.

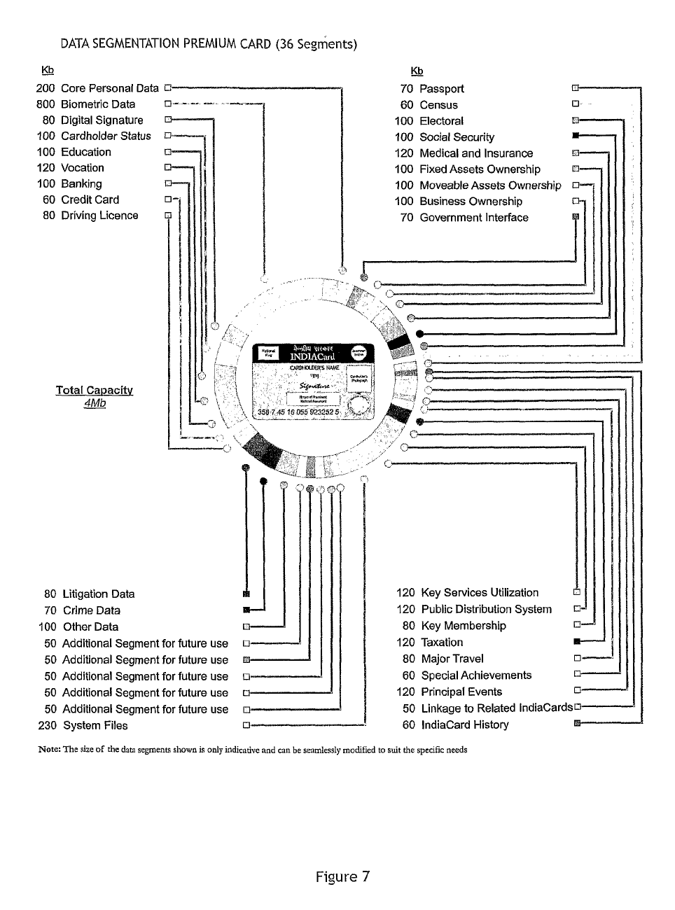

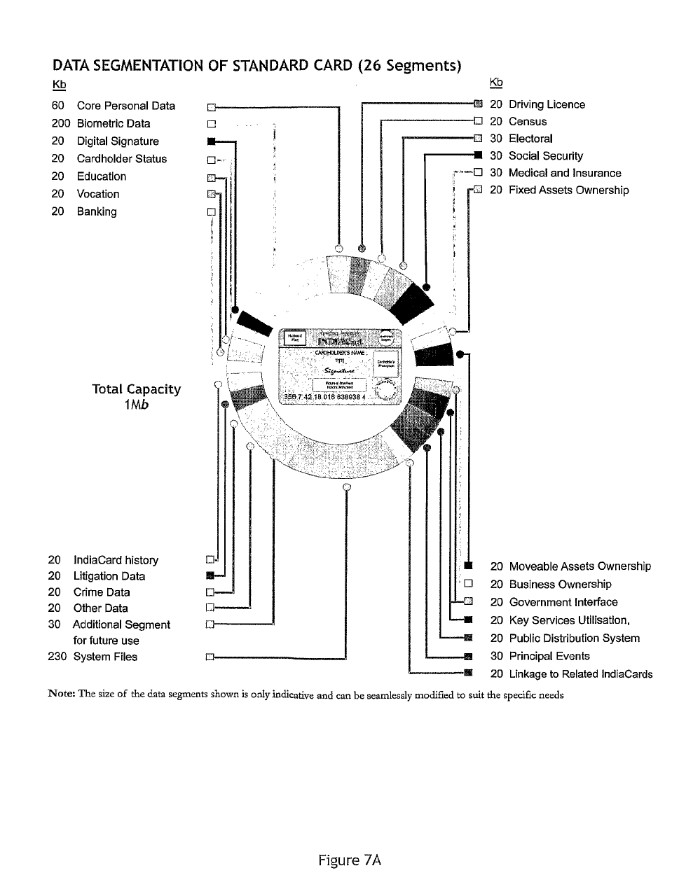

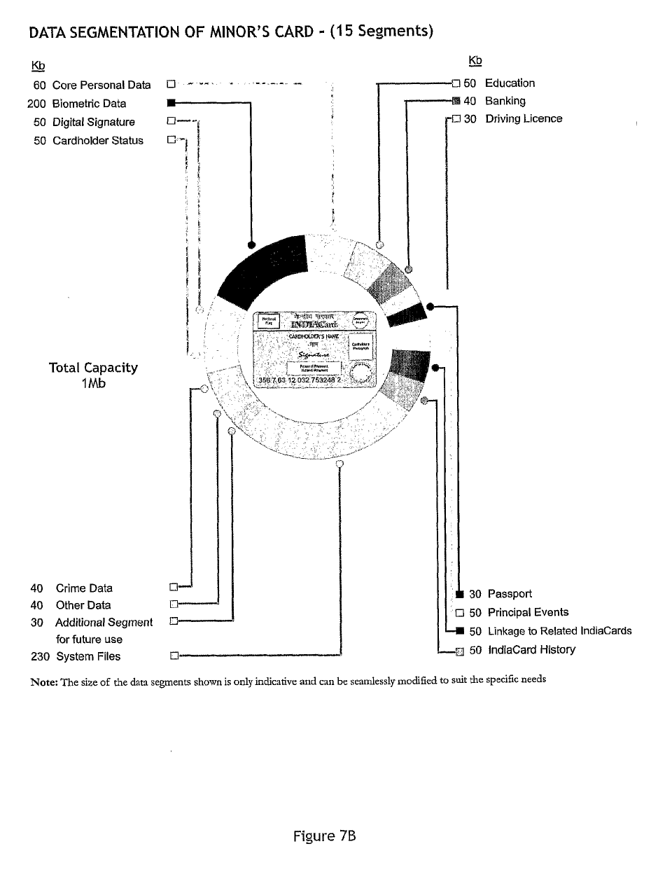

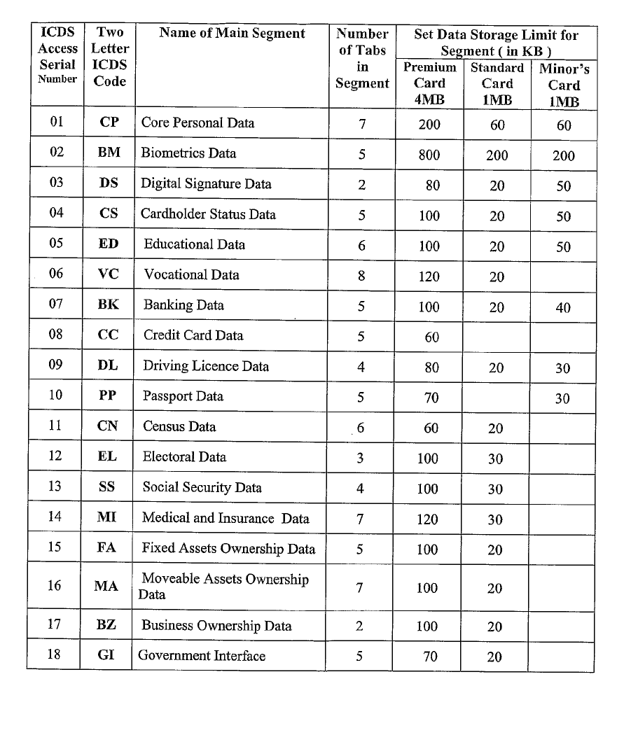

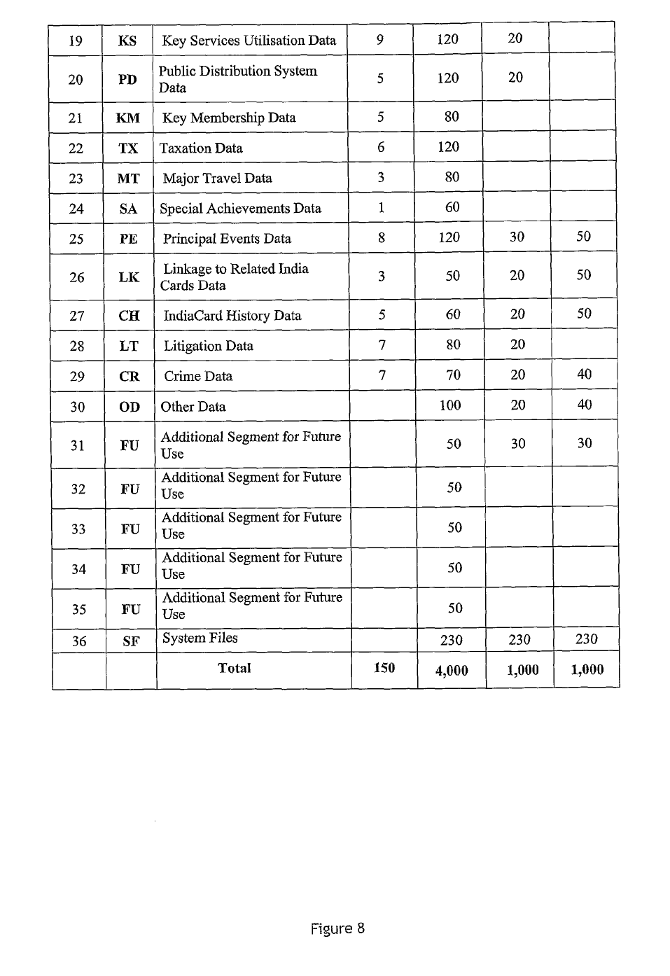

FIG. 7 illustrates the unique structure of segmented data stored on the memory chip of the ID card. The various segments have been represented by means of a doughnut chart, as applicable to the Premium Version of the ID Card.

As described above, the memory capacity of the chip on the National Citizen ID Card can vary from 1.0 MB for Standard Version and Minor's Version to 4 MB for Premium Version (or higher as desired or as technology advances). Also, the number of segments in each card varies according to the deployment needs of the smart card. The Premium Card consists of 36 segments, which number may vary in future according to the variations of the applications loaded on the card. This Premium Card is intended for issuance to citizens in upper economic strata. The Standard Card has 26 segments, which may again vary depending on the requirements of the applications to be performed by the Card. The Standard ID Card is designed and intended to be issued to the ‘common man’ i.e., majority of the population of the country will possess this type of ID Card. This entry level ID Card is designed to cover all basic applications and essential facets of interface with government. The Minor's ID Card has 15 segments and is intended for those below 18 years of age, designed to contain all essential data applicable to minors. When an upgrade is desired from the Standard Version of the ID Card, same can be replaced by the Premium Version of ID Card with minimal effort and at a nominal cost, retaining the same unique identity number originally allotted to the citizen. Similarly, when a minor attains the age of 18 years, said Minor's ID Card is replaced by the Standard or Premium ID Card, as the case may be.

FIGS. 7-A&7-B The key personal data and biometrics of each citizen being embedded on the smart card chip of the said ID card would render it impossible for any person to make false identity claims or for manipulation of data contained thereon. Moreover, the said high security ID card contains on its smart card chip distinct segments for data storage pertaining to the citizen under respective heads as shown in FIGS. 7, 7A and 7B respectively for each category of card, with the size of the memory capacity of said chip being variable from the sub 100 kb to the megabyte range, according to the needs of each ID project implementing authority and the type of ID Card issued and its applications/functionalities.

FIG. 8 illustrates the unique segments on the memory chip of the ID Card comprise the following:

core personal data, biometric data, digital signature, card holder status, education, vocation, banking, credit card, driving license, passport, census, electoral, social security, medical and insurance, fixed assets ownership, moveable assets ownership, business ownership, government interface, key services utilisation, public distribution system, key membership, taxation, major travel, special achievements, principal events, linkage to related IndiaCards, IndiaCard® history, litigation data, crime data, other data, additional segments for future use, system files, appurtenant to the Premium ID Card. Said list of segments is commensurately abridged in respect of the Standard ID Card and the Minor's ID Card. Each segment contains the data specific to one domain or department in terms of functionality in well-defined, precise formats. Each department or agency can access only that data segment which is relevant to their department/operations via user level controls and special calibration of reader units in which the card is inserted for performing the transaction. Each department or an agency has user level or administrator level access to corresponding segment linked to roles and responsibilities. Any unauthorized personnel within respective department or agency is precluded from viewing of the data. The data that can be viewed by all departments and agencies in common is the segment titled ‘core personal data’ of the citizen. Whenever, the fresh data concerning each citizen is input to CDR by authorized personnel of concerned operating department/agency with their digital signature and authentication e-stamp, the same validated data is ported to relevant segment of ID card via card writer Unit, when the NCID Card submitted by citizen at any ICC for updation. The data on the card is stored in an encrypted form so as to prevent unauthorized access to the confidential data. The data on the card is stored in a Write Once Read Many (WORM) format to prevent tampering with the data.

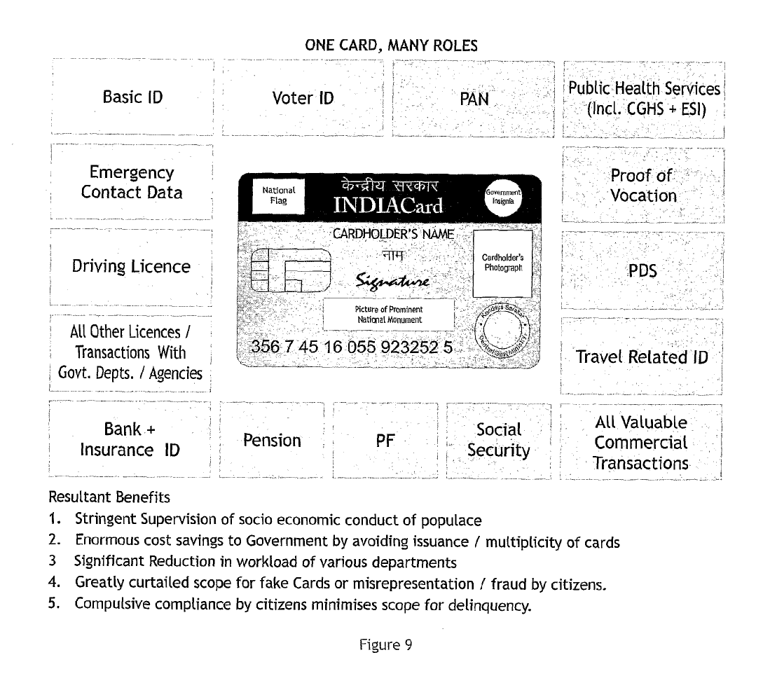

An exemplary system for the usage of NCID having multiple functions is now explained by referring to FIG. 9. The system comprises citizen's NCID card, card reader and writer unit in which the ID card is inserted to initiate a transaction, in any of the named departments/agencies, including PDS, RTO, Electoral etc. The authorized official of said department is enabled to access only the particular segment appurtenant to said department, in addition to the core personal data segment. The citizen's identity is verified and then allowed to perform desired transaction pertaining to that particular segment. After the transaction is performed, the updated data is stored in the department database and subsequently sent to the NR through secure data transmission channels. In the same way, various other transactions can be performed by citizens in respect of all other departments/agencies.

In case of remote department access, the designated official, authorised to verify the data of any citizen located in a remote location will log into the specified sector of NR using preset user login controls, as per the hierarchy in the dept. Then, the dept official verifies the data of the citizen available in the NR, pertaining to his dept. if there is any discrepancy between the data on the chip and the NR, then, there will be further processes to continue enquiries, etc. If there is no variation, then, the citizen is certified to be bona fide and will be allowed to avail facilities as per the e-governance policies. The typical scenario could be a border control post/remotely located dept where wired connectivity is not generally available.

Another scenario could be that of some natural calamity, when the conventional connectivity is not available, but, the citizens are to be allowed some relief measures immediately, based on the genuine claims of the citizens.

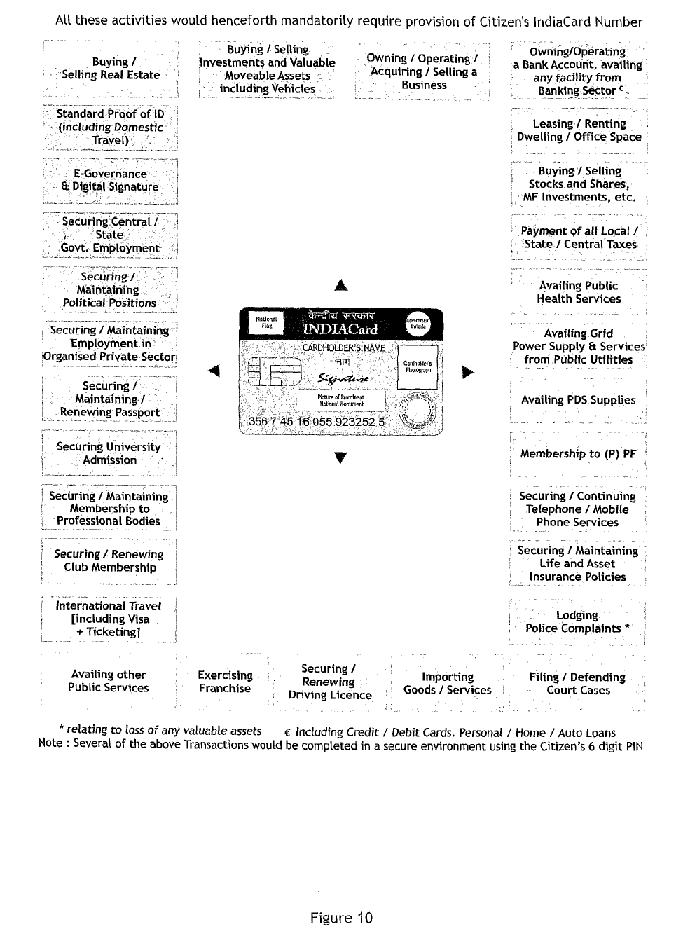

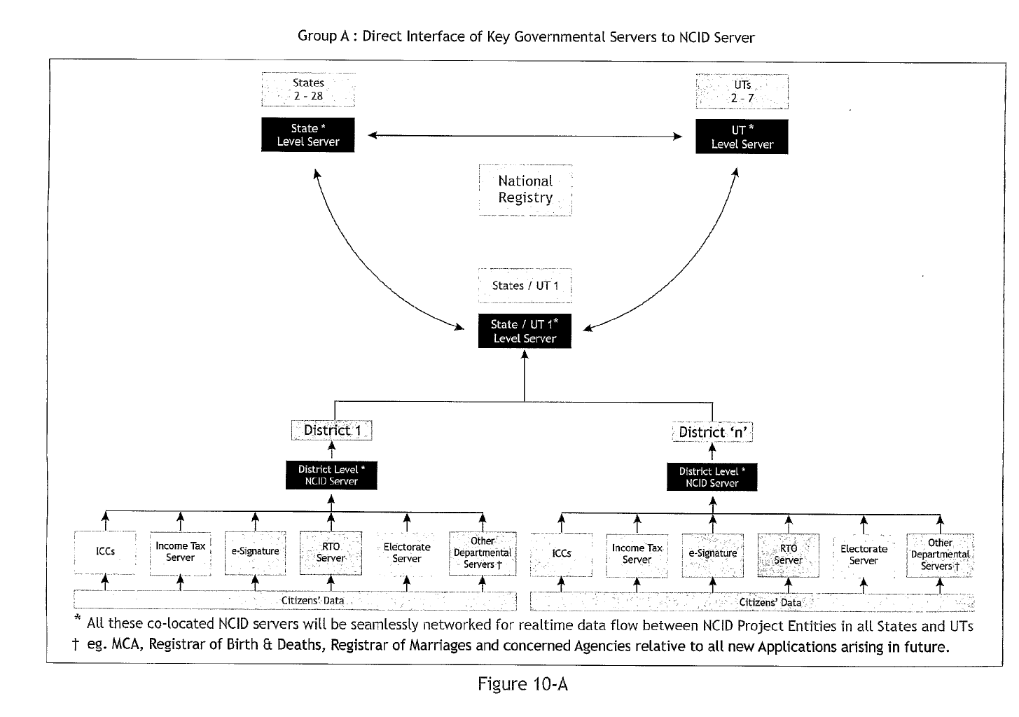

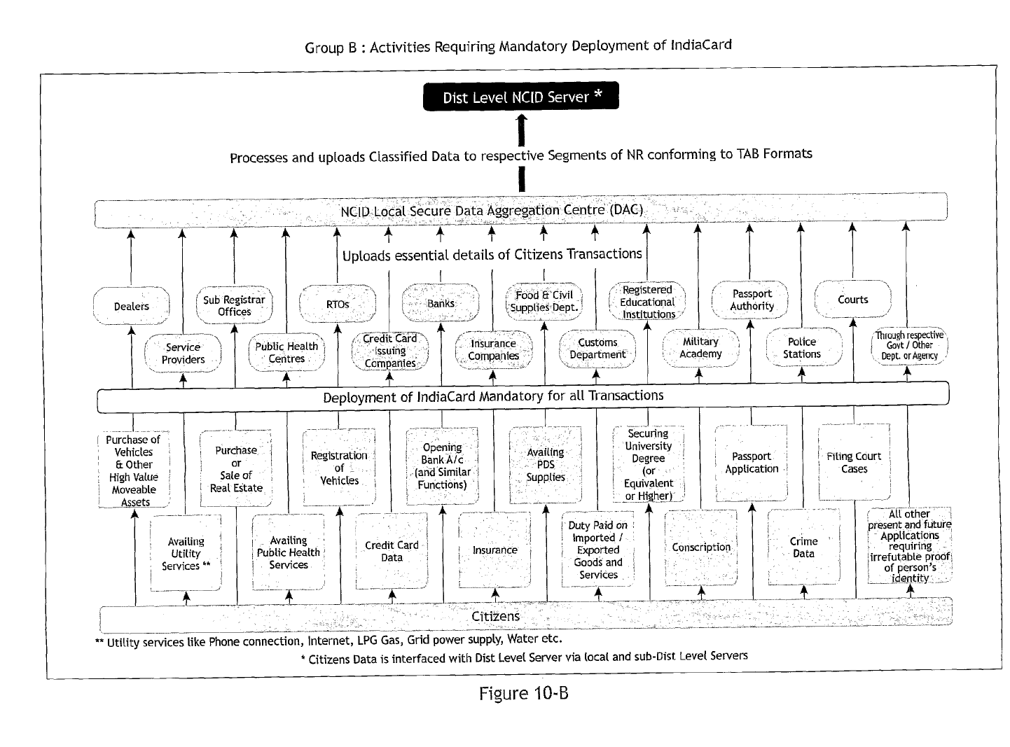

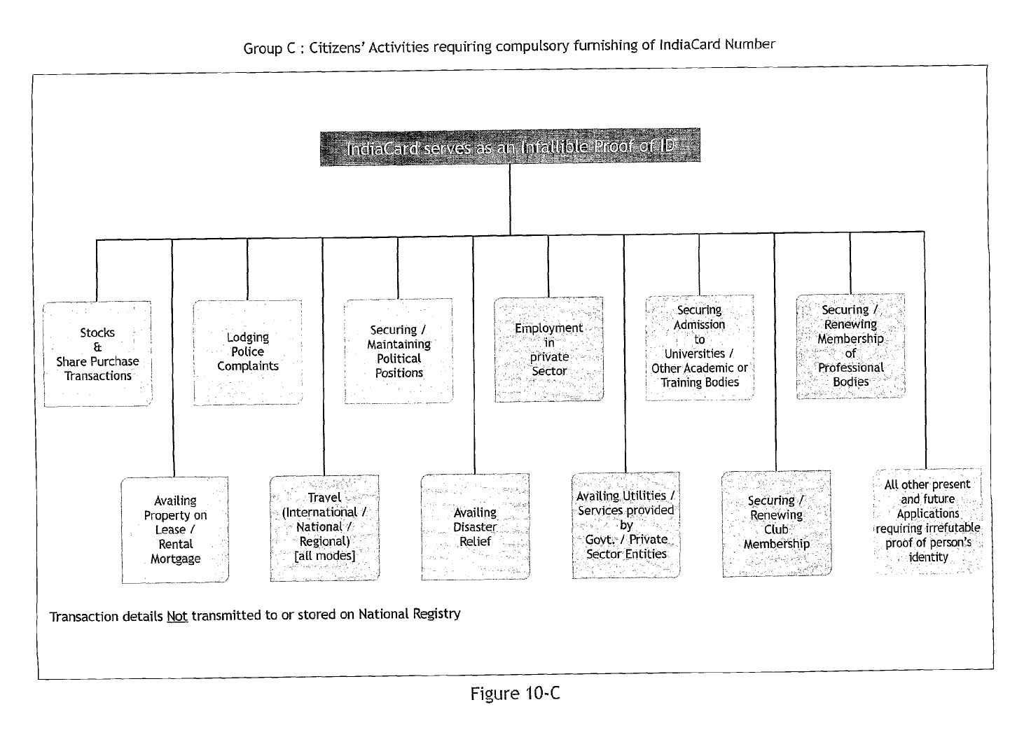

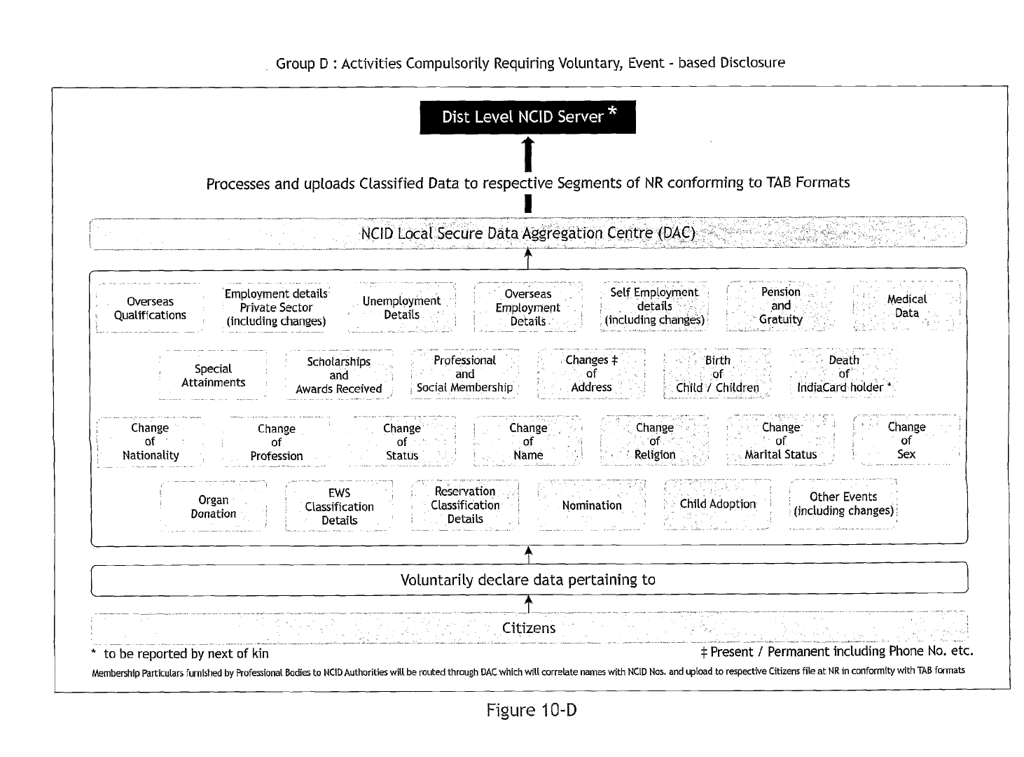

FIG. 10 illustrates the ID Card deployment Schematic, which shows the unique and comprehensive range of applications for which this Card can be deployed across the country, replacing all existing forms of identity reference. Accordingly, this ID Card represents an extremely reliable and powerful tool for interface between citizens and government/other relevant undertakings, thereby facilitating easy interaction and conduct of all economic, social and commercial activity. All this is achieved with utmost speed and convenience to citizens, ensuring at the same time, that the economic conduct of citizens is always pursued within a disciplined framework, precluding/thwarting fiscal conduct/actions which are against the best interests of the country. Furthermore, all modern e-Governance applications are also concurrently facilitated by the use of this ID Card, as shown in the deployment schematic.

The card deployment schematic shown in FIG. 10 is further elaborated by FIGS. 10A, 10B, 10C and 10D which explain the method of interaction between various Government agencies and other operating agencies vis-à-vis citizens in respect of each of the groups of the transactions described in respective charts. The purpose of so classifying the named activities is to simplify and render more efficient the process of such interaction for mandatory versus non-mandatory services/transactions.

FIG. 10-A: The various transactions described at FIG. 10A relate to citizens' transactions, summary of which are directly transmitted by respective service providers/agencies to the NCID server for storage in respective citizen's e-file.

FIG. 10-B The activities illustrated at FIG. 10B relate to activities requiring mandatory deployment of the citizen ID card for the various transactions by citizens, as shown therein.

FIG. 10-C FIG. 10C illustrates citizens' activities requiring compulsory furnishing of their citizen ID Card Number for the various transactions shown therein, in respect of which the physical deployment of the ID card is not essential.

FIG. 10-D FIG. 10D illustrates the activities which require compulsory, voluntary event-based disclosure by citizens of relevant data in respect of each of the events shown therein, to respective authorities shown therein,

By means of the above process described the whole gamut of interactive relations on a continuing basis between citizens versus government and other operating agencies is rendered extremely efficient and is greatly simplified.

The card deployment schematic shown in FIG. 10 is further elaborated by FIGS. 10A, 10B, 10C and 10D which explain the method of interaction between various Government agencies and other operating agencies vis-à-vis citizens in respect of each of the groups of the transactions described in respective charts. The purpose of so classifying the named activities is to simplify and render more efficient, the process of such interaction for mandatory versus non-mandatory services/transactions.

The various transactions illustrated at FIG. 10A relate to direct interface of e-governmental server to NCID server.

The transactions illustrated at FIG. 10B relate to activities requiring mandatory deployment of the Citizen ID Card for the various transactions shown therein.

FIG. 10C illustrates citizens' activities requiring compulsory furnishing of their national citizen ID Card number for the various transactions shown therein, in respect of which the actual deployment of the ID card is not essential.

FIG. 10D illustrates the activities which require compulsory voluntary event-based disclosure by citizens in respect of the various events described therein.

By following the procedures and practices described above, the whole gamut of interactive relationship between citizens versus government and other operating agencies is rendered extremely efficient and simple, making the deployment of the Citizen ID Card truly user-friendly and hassle free.

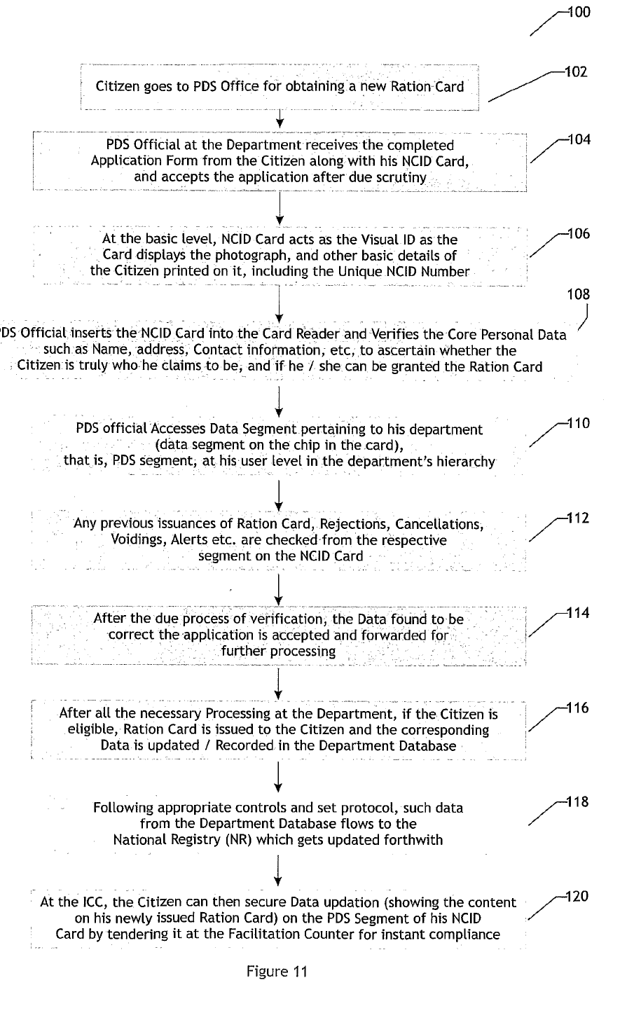

FIG. 11 illustrates the method 100 for performing transaction under the Public Distribution System (PDS) by citizens.

At block 102, the citizen goes to PDS office with a smart card for obtaining a Ration Card.

At block 104, the authorized PDS official receives the completed application form from the citizen along with NCID card, and accepts the application after due scrutiny.

At block 106, PDS official verifies the visual identity of the citizen by viewing photograph on the card.

At block 108, PDS official inserts the NCID card in the card reader and verifies the identity of the citizen by viewing core personal data.

At block 110, PDS official accesses the data segment pertaining to his department which he is authorized to access at his user level in the department's hierarchy.

At block 112, any previous data in the segment i.e. issuance of Ration Card, rejection, cancellation, voidings, alerts etc. are checked from the appropriate segment by the authorized PDS official.

At block 114, after the verification is completed, the application is accepted and forwarded for further processing.

At block 116, after the processing is complete and the citizen is found to be eligible the Ration Card is issued to the citizen and the corresponding data is updated in the department database.

At block 118, the updated data from the department database is sent to the NR through data transfer protocols.

At block 120, citizen approaches the ICC for updations of NCID card of that particular PDS segment by showing the content from the newly issued Ration Card or from the NR. But if the citizen does not get the data updated periodically at the ICC, alerts or reminders will be sent by the NR to the citizen for performing the updations.

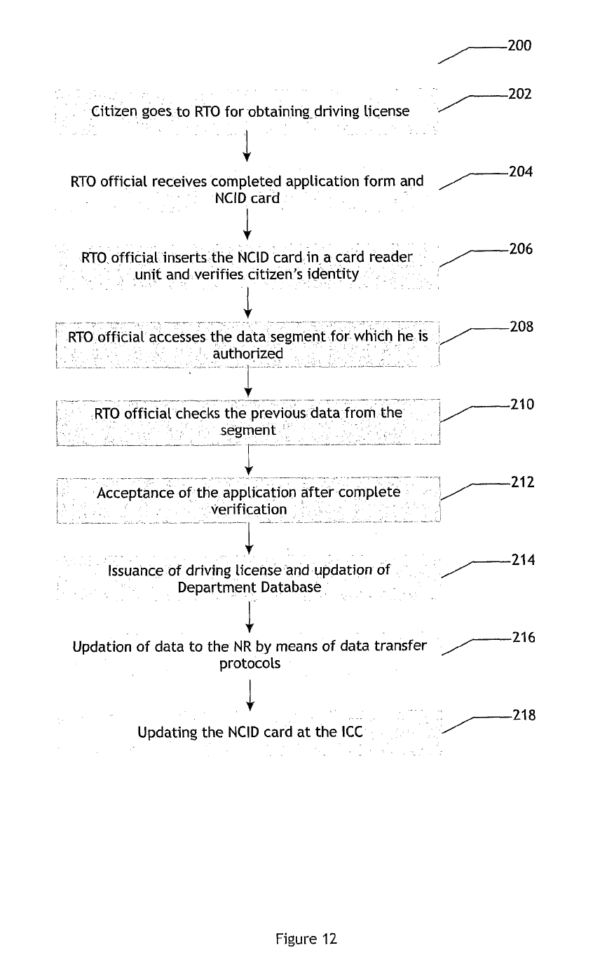

FIG. 12 illustrates the method 200 for the card usage by citizens for performing transactions at the Regional Transport Office (RTO).

At block 202, the citizen goes to RTO with a smart card for obtaining a driving license.

At block 204, the authorized RTO official receives the completed application form from the citizen along with NCID card, and accepts the application after due scrutiny.

At block 206, RTO official inserts the NCID card in the card reader and verifies the identity of the citizen by viewing core personal data.

At block 208, RTO official access the data segment pertaining to his department which he is authorized to access at his user level in the department's hierarchy.

At block 210, previous data in the segment i.e. issuance of license, rejection, cancellation, voidings, alerts etc. are checked from the appropriate segment by the authorized RTO official.

At block 212, after the verification is completed, the application is accepted and forwarded for further processing.

At block 214, after the processing is complete and the citizen is found to be eligible the license is issued to the citizen and the corresponding data is updated in the department database.

At block 216, the updated data from the department database is sent to the NR through data transfer protocols.

At block 218, citizen approaches the ICC for updations of NCID card of that particular Driving Licence segment by showing the content from the newly issued driving license or from the NR. But if the citizen does not get the data updated periodically at the ICC, alerts or reminders will be sent by the NR to the citizen for performing the updations.

The newly issued driving license on the NCID card is viewed by traffic control/transport department authorities. The transport authorities access the Driving Licence segment on the NCID Card via user level password control and the data is verified on the spot using a handheld card reader device. If required, the transport authorities can access the central server i.e. National Registry online by wireless network and verify relevant particulars of the citizen.

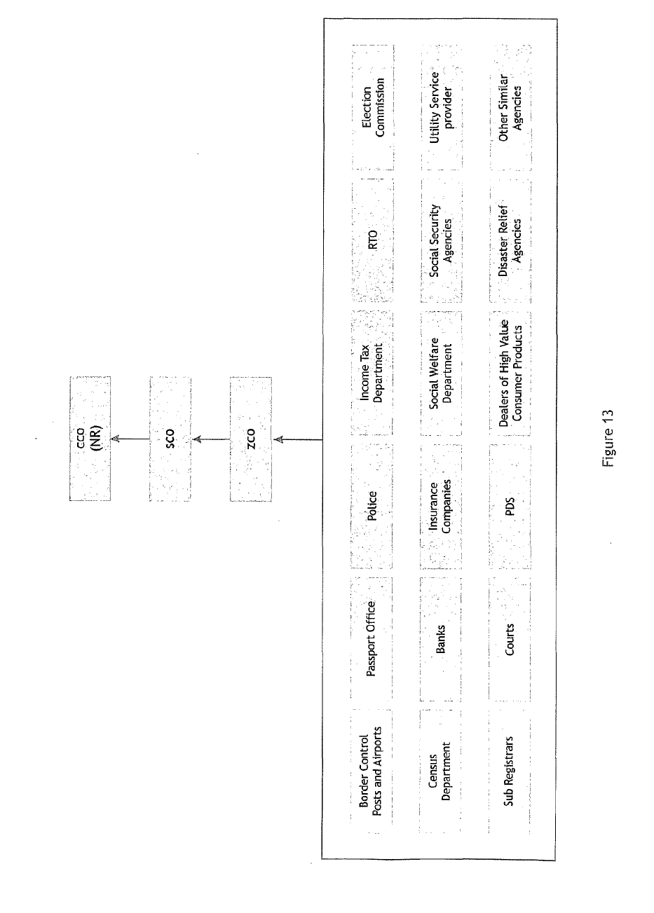

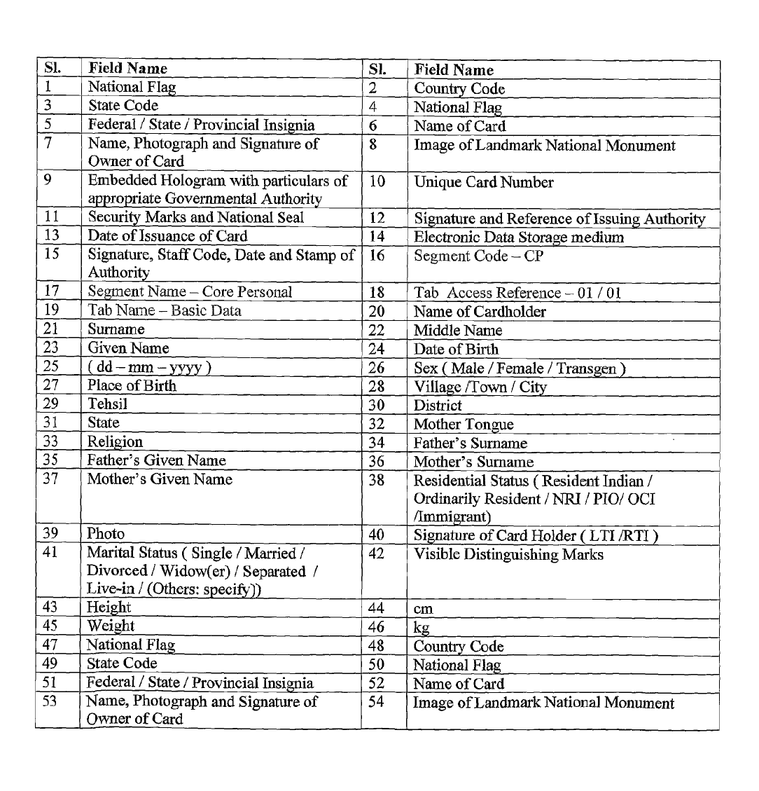

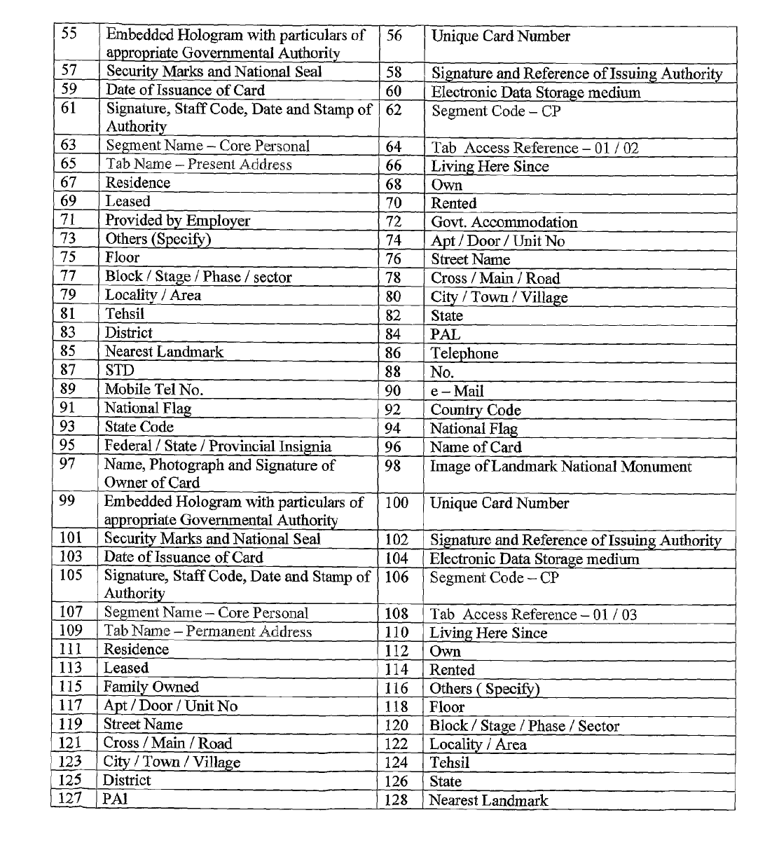

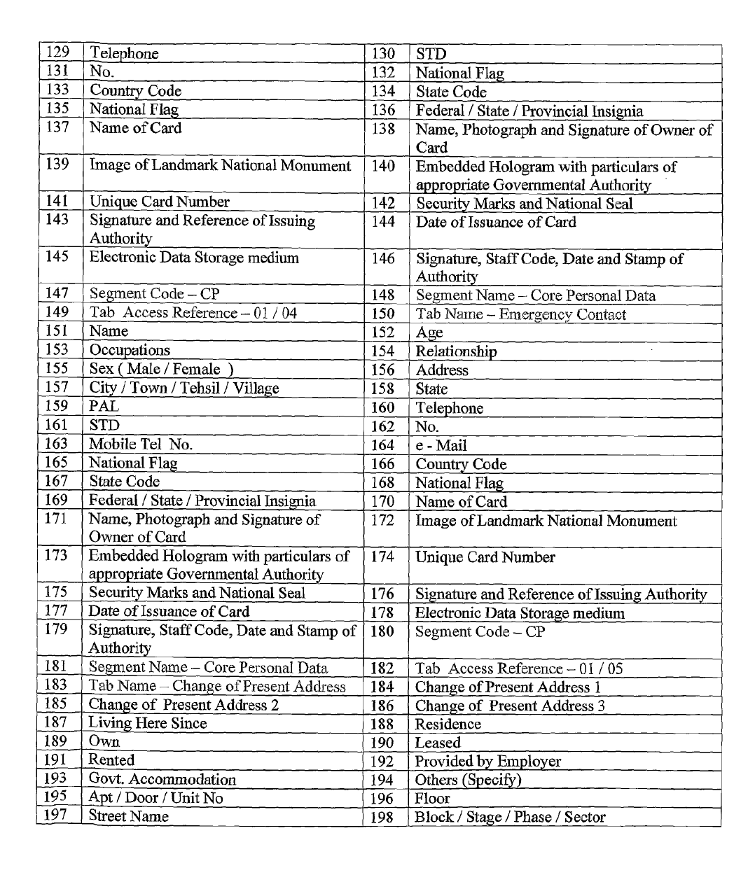

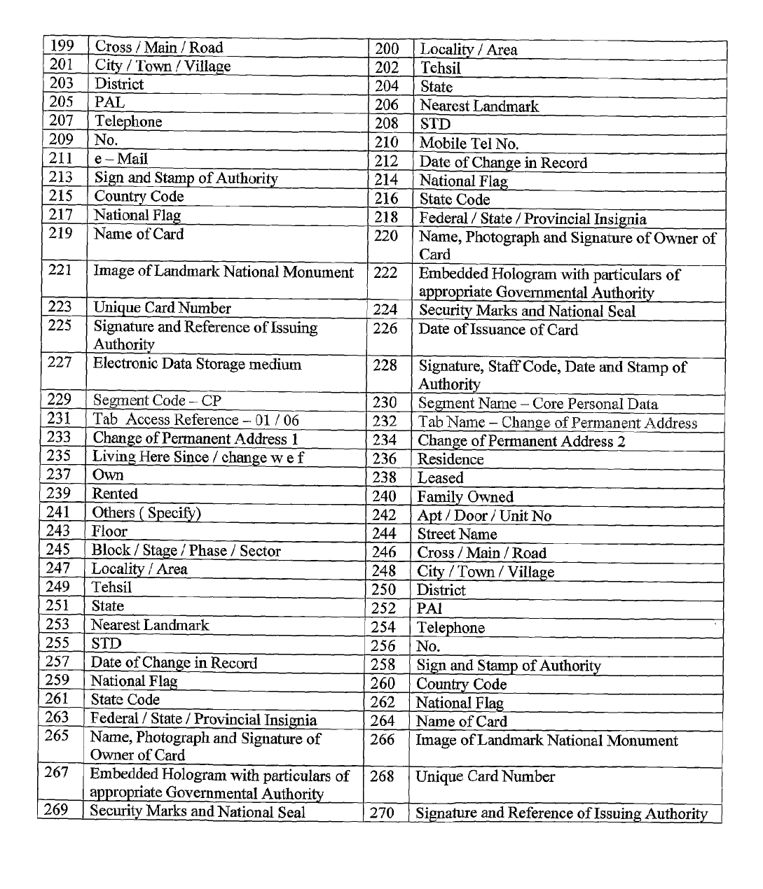

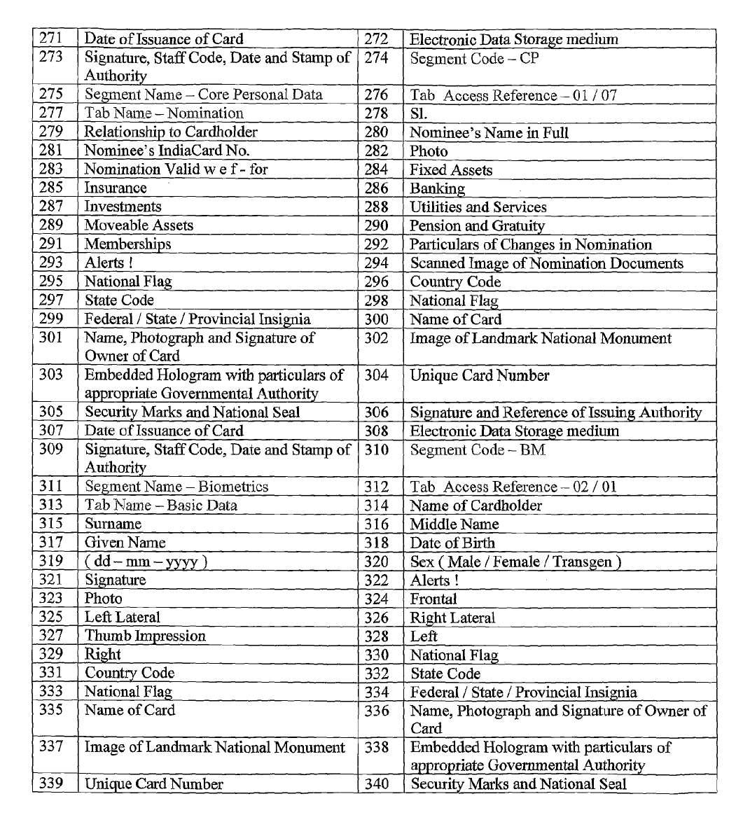

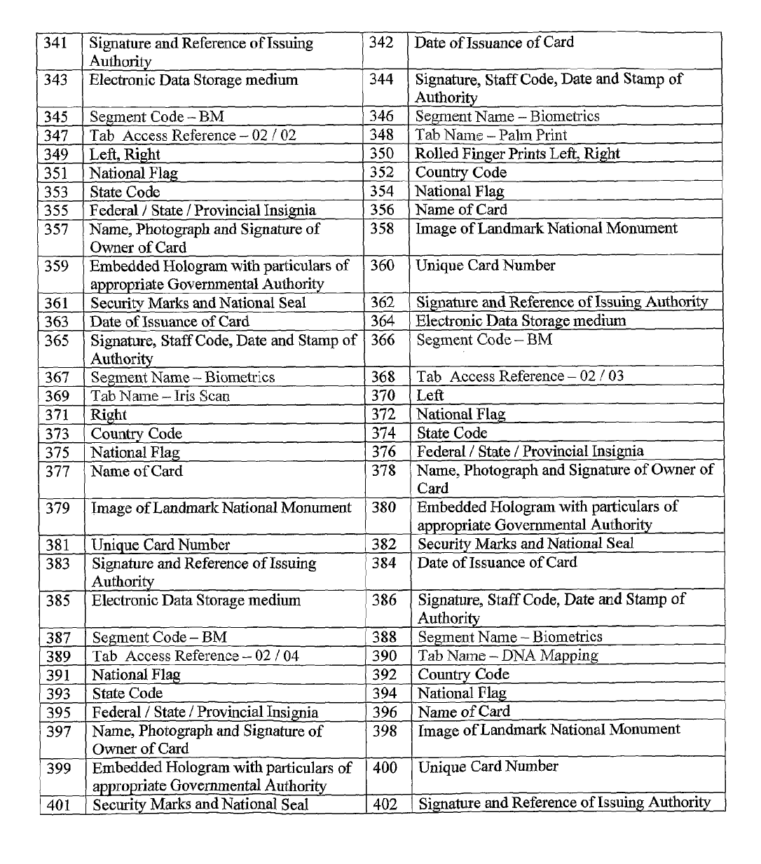

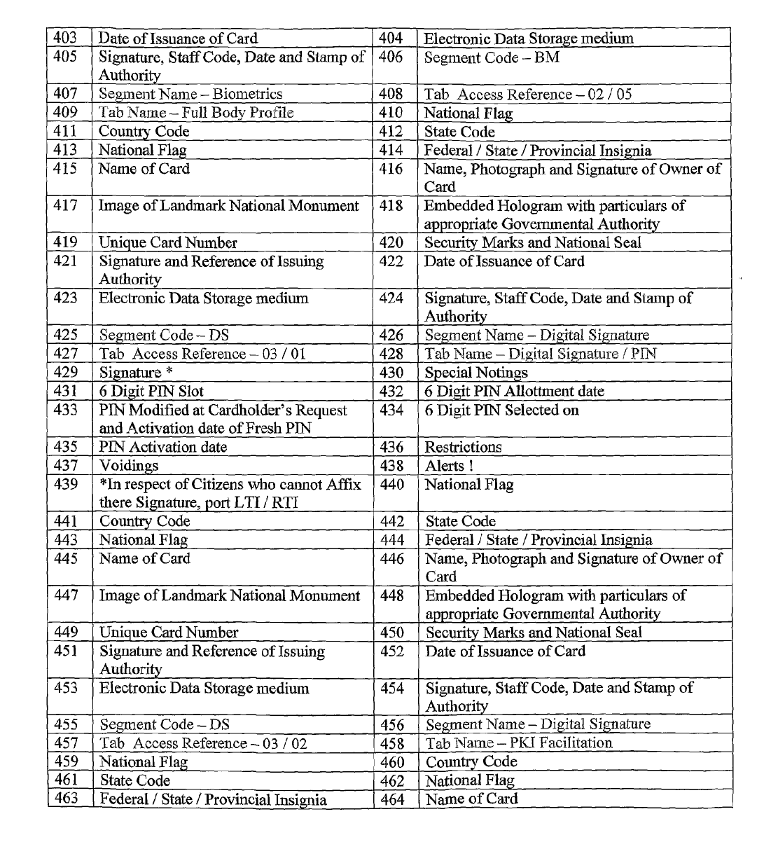

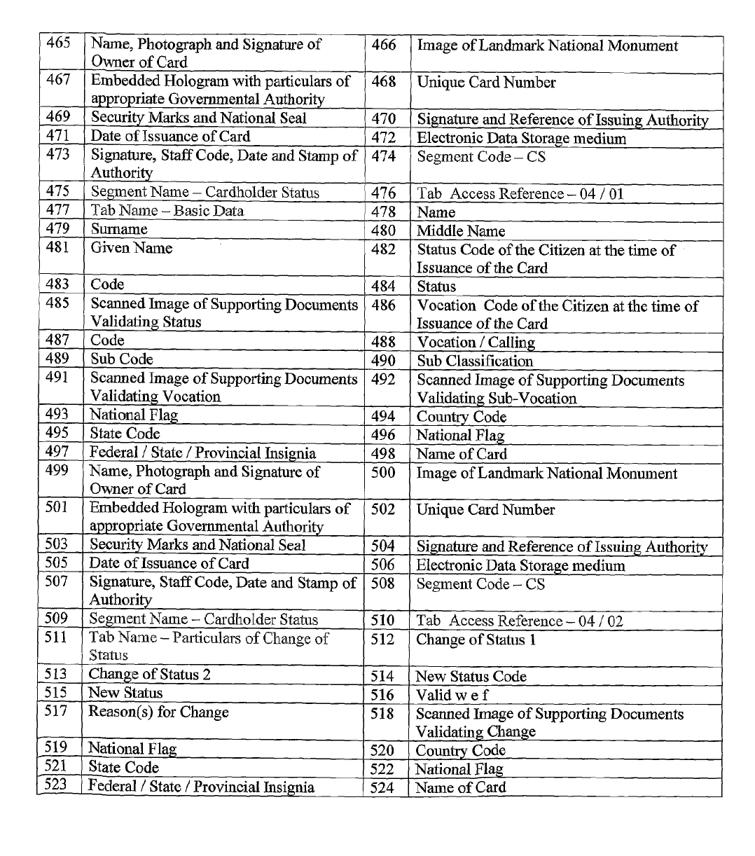

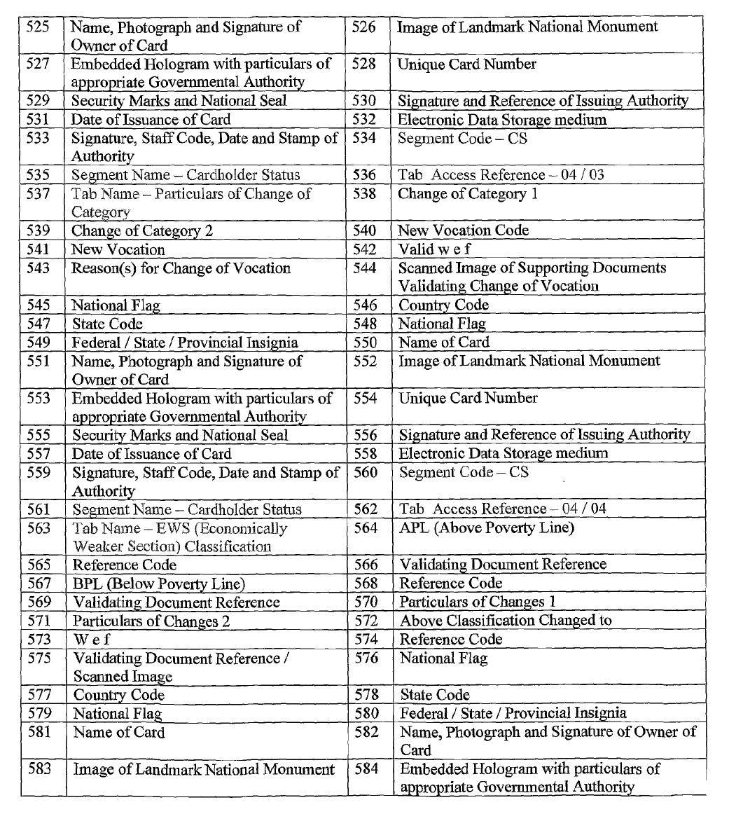

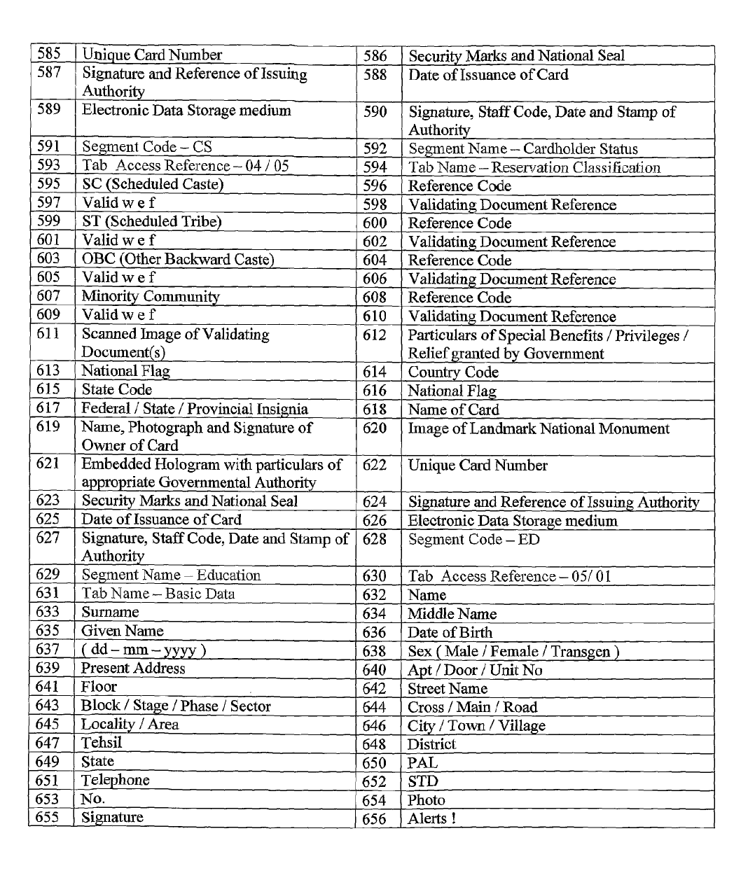

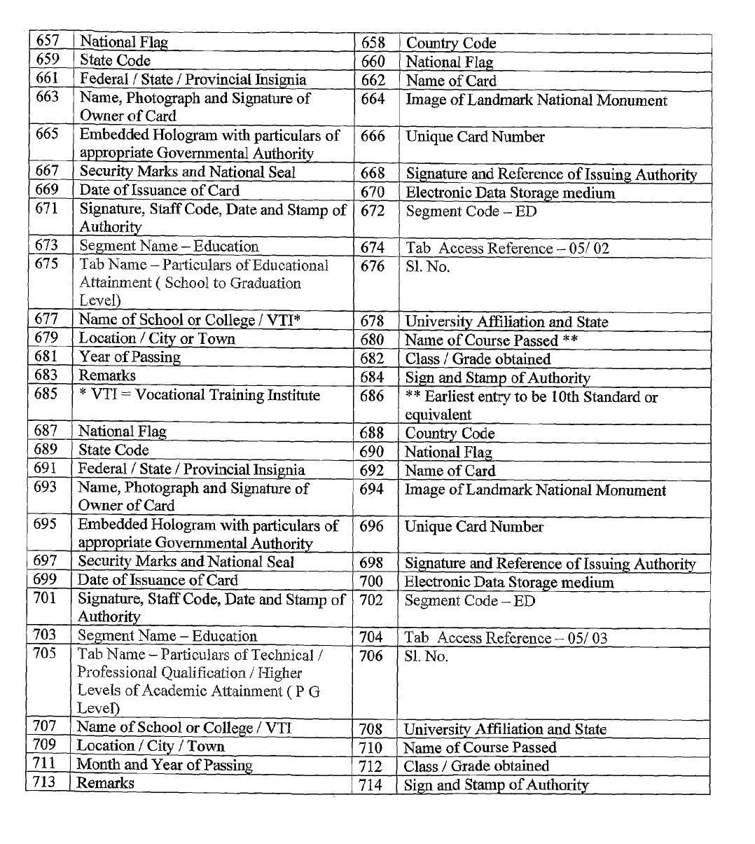

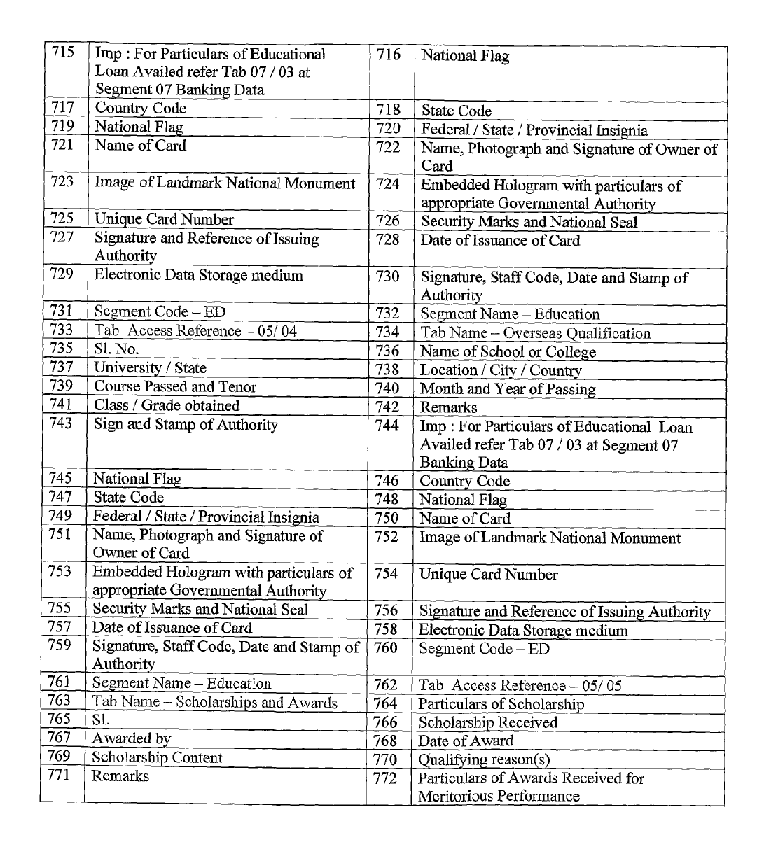

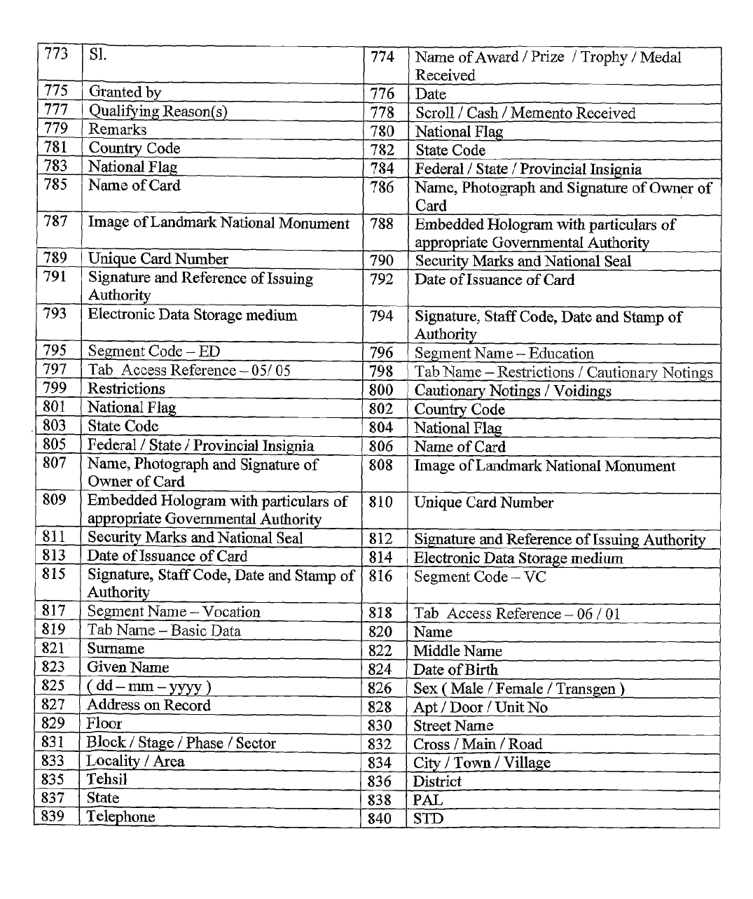

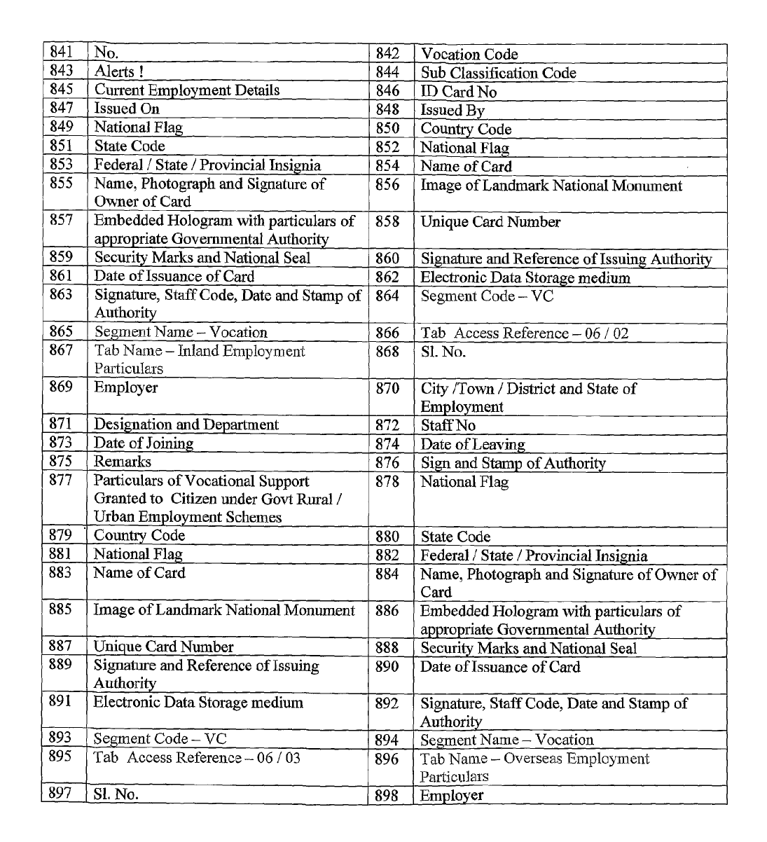

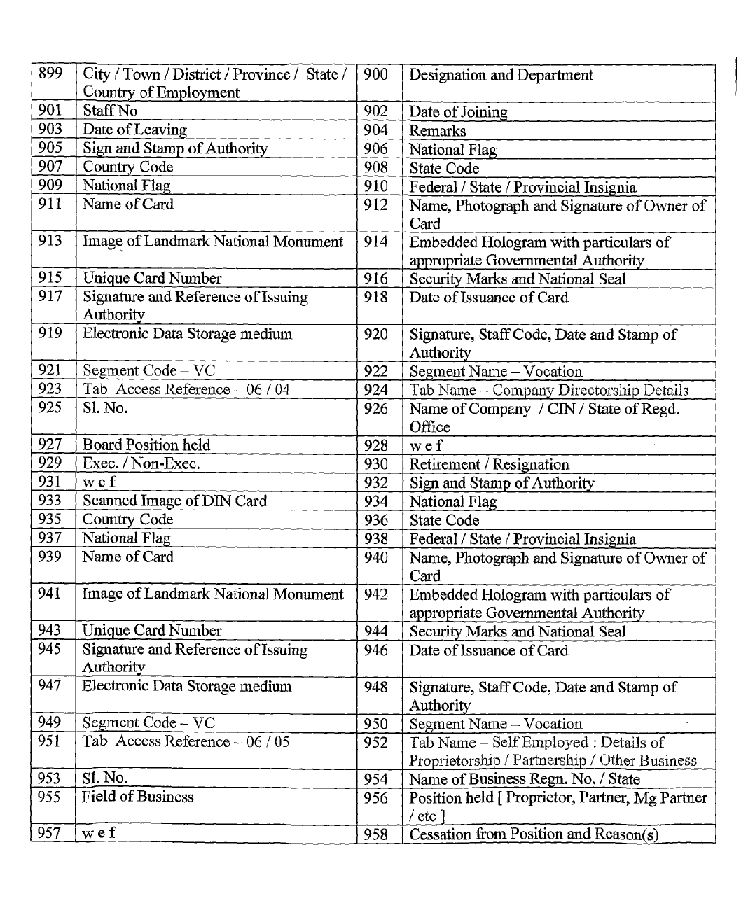

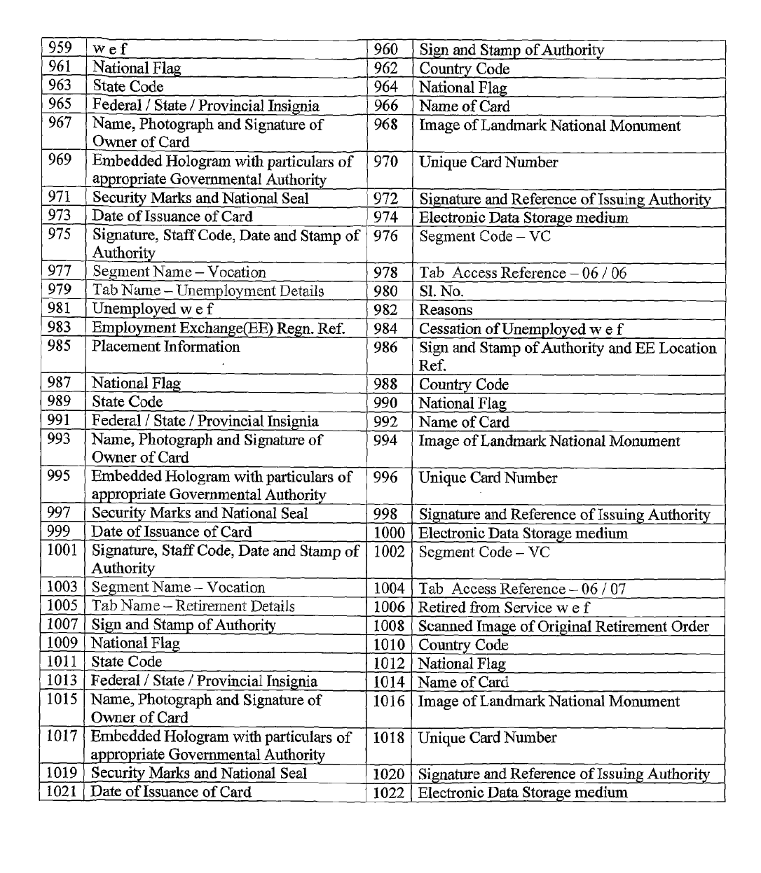

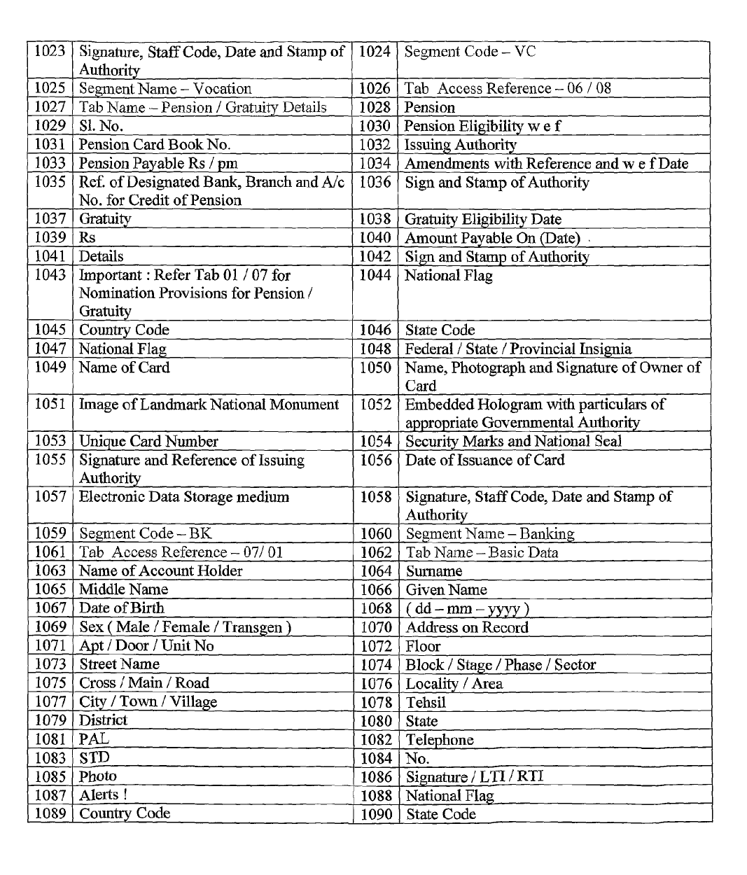

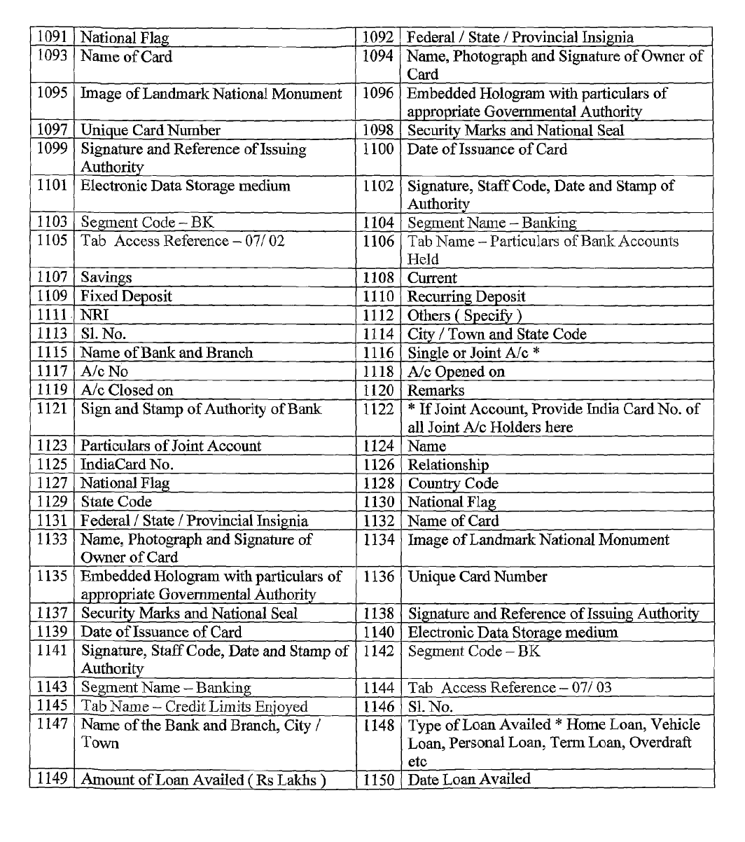

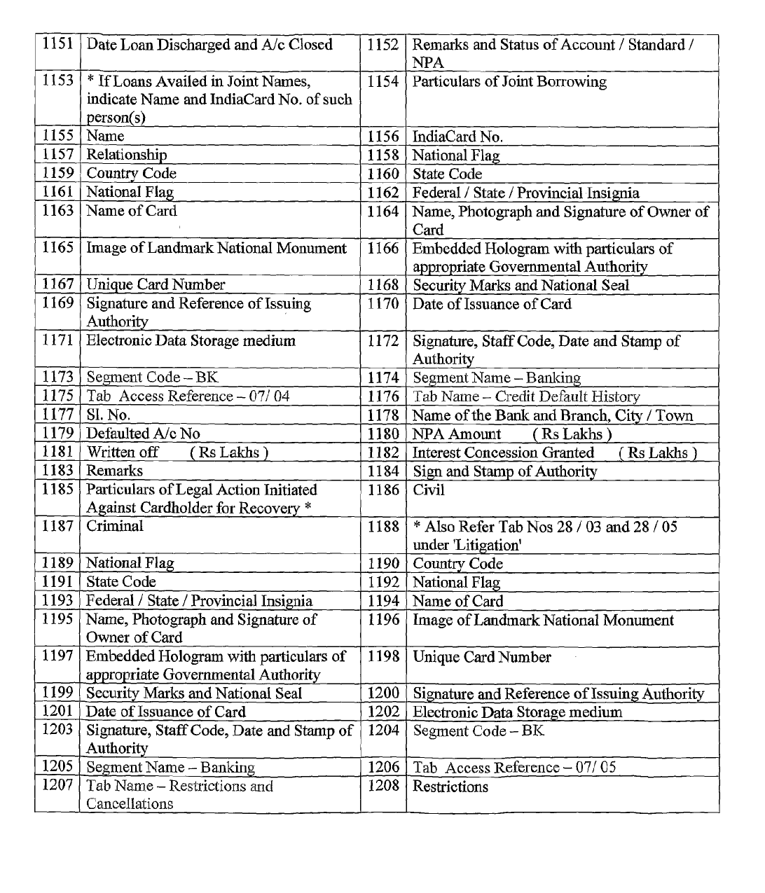

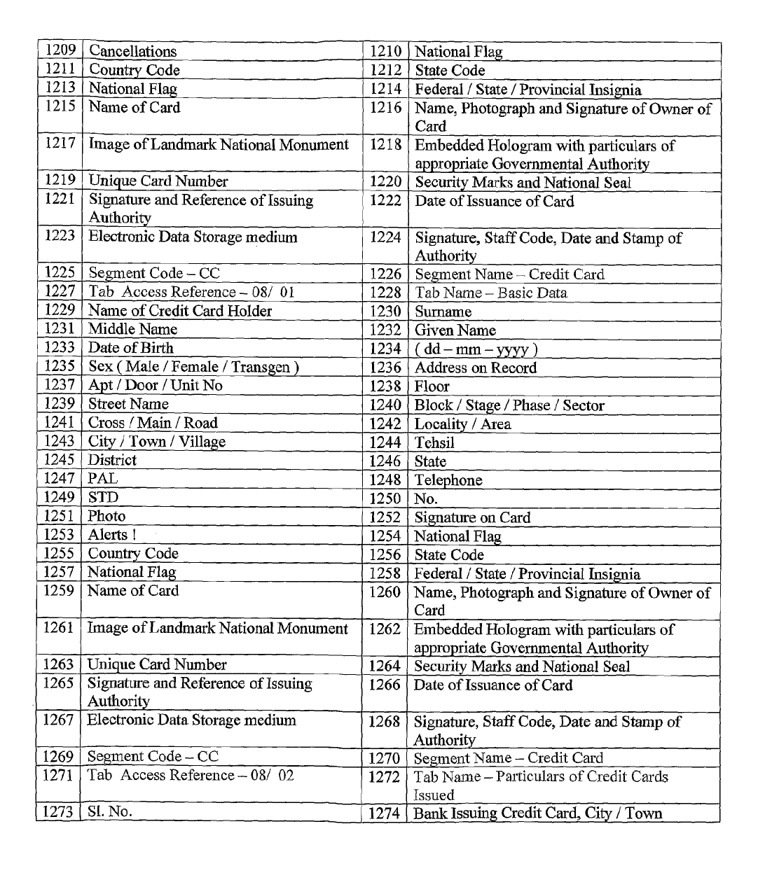

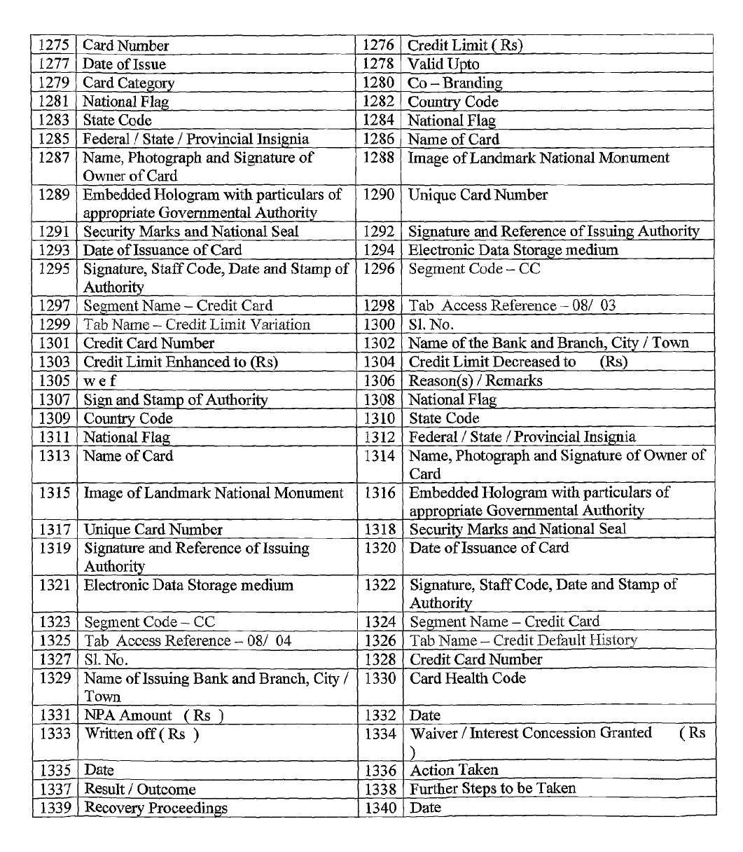

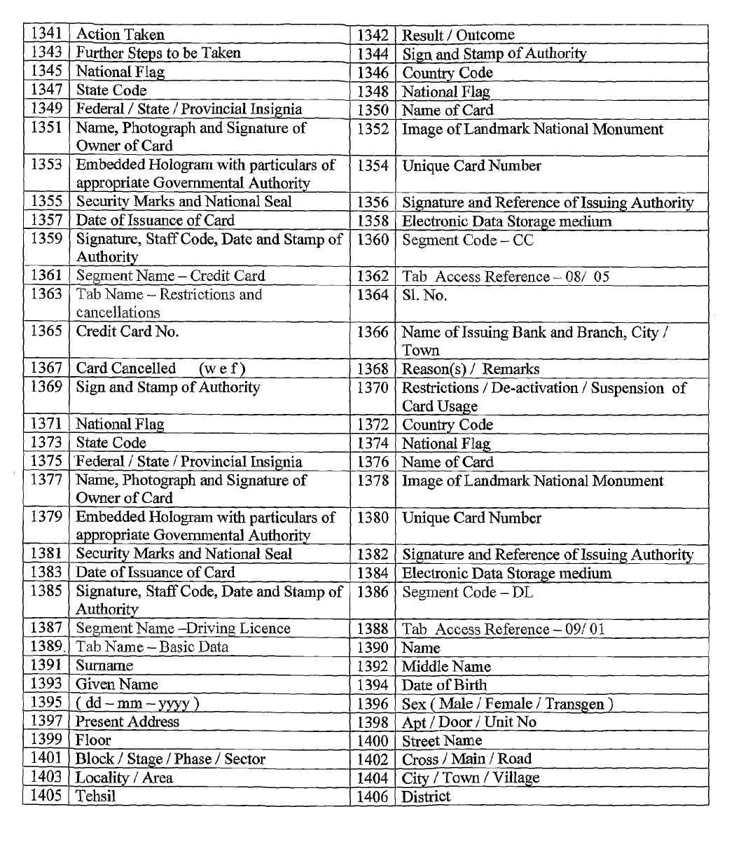

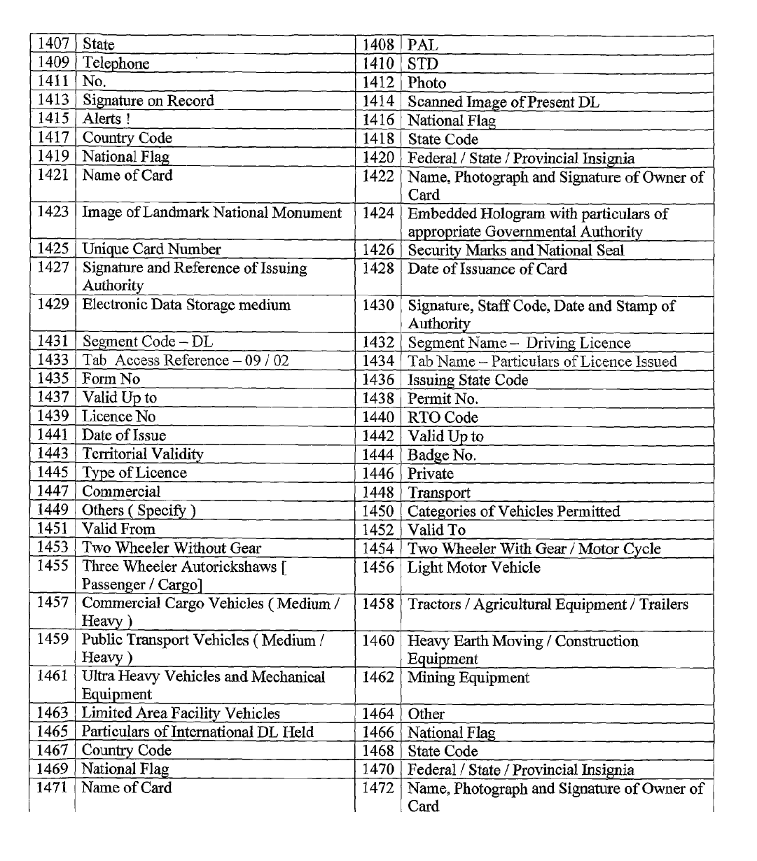

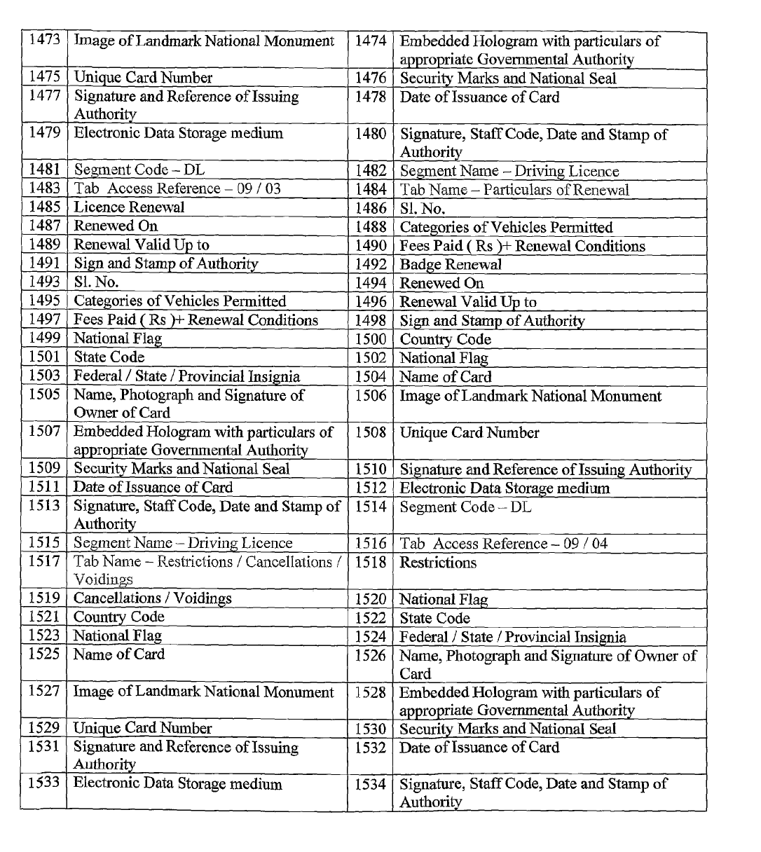

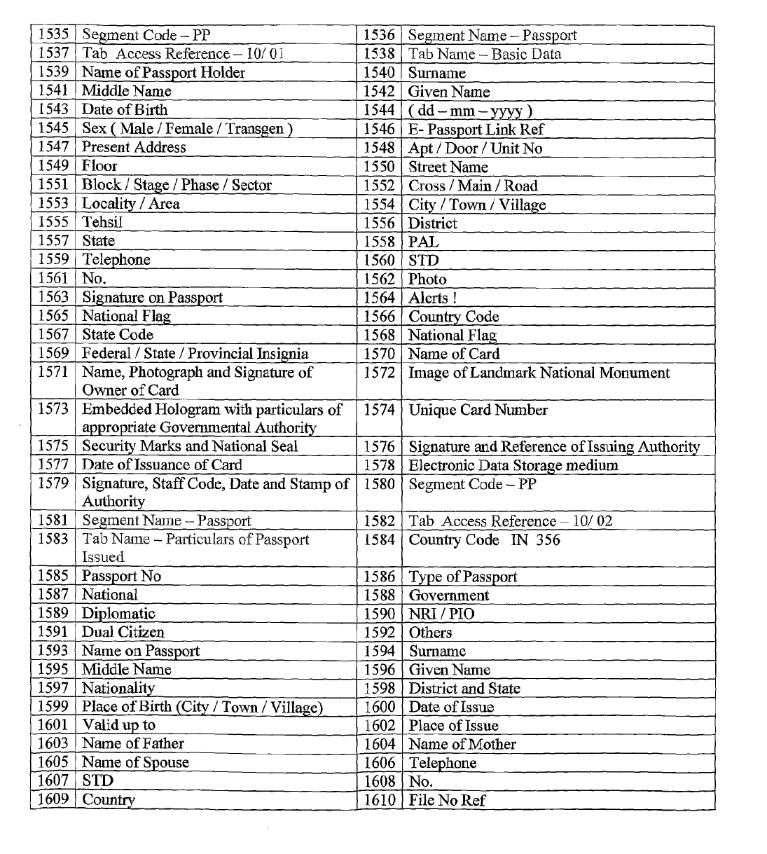

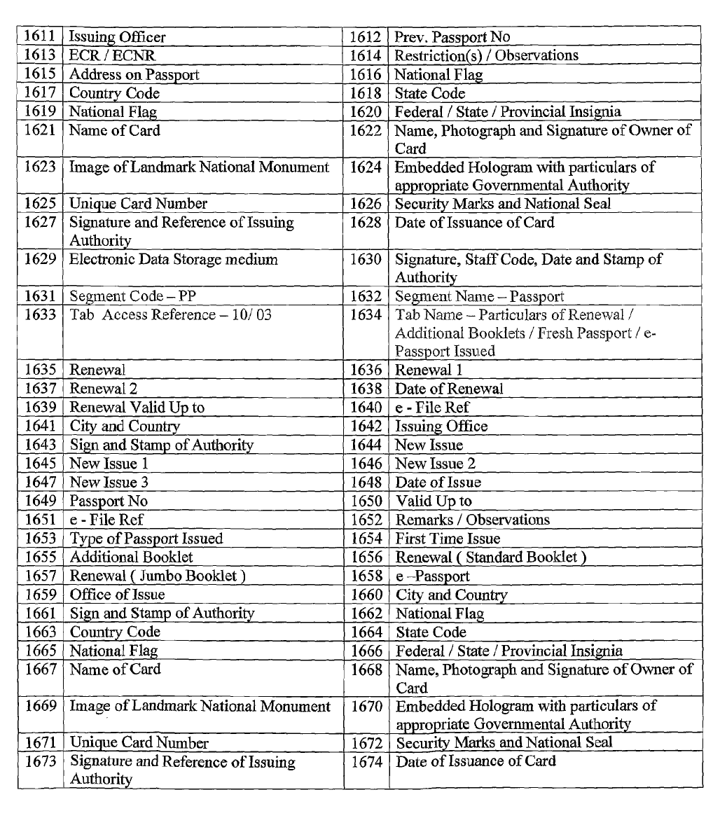

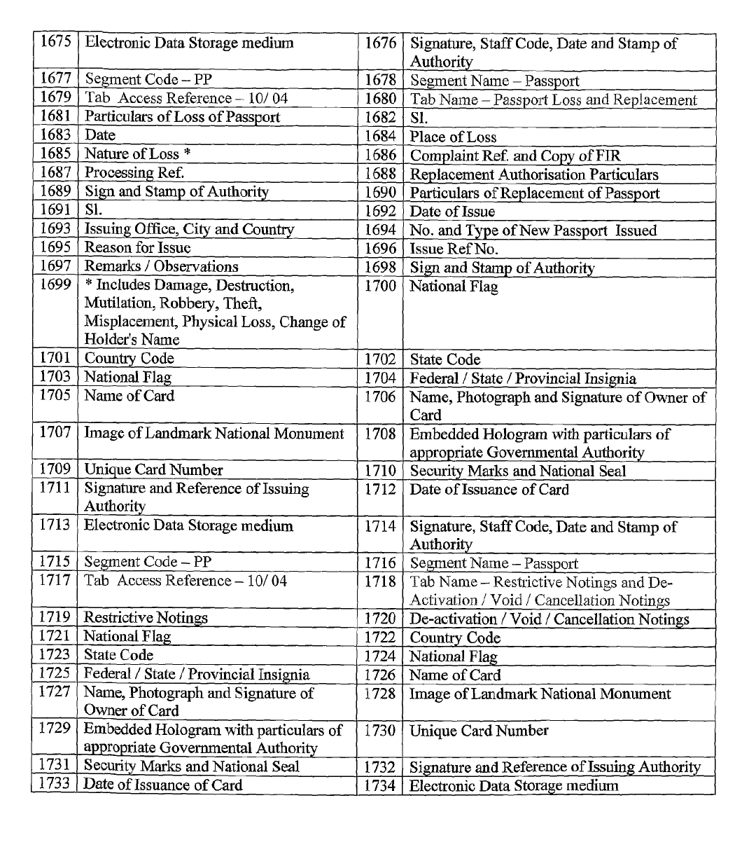

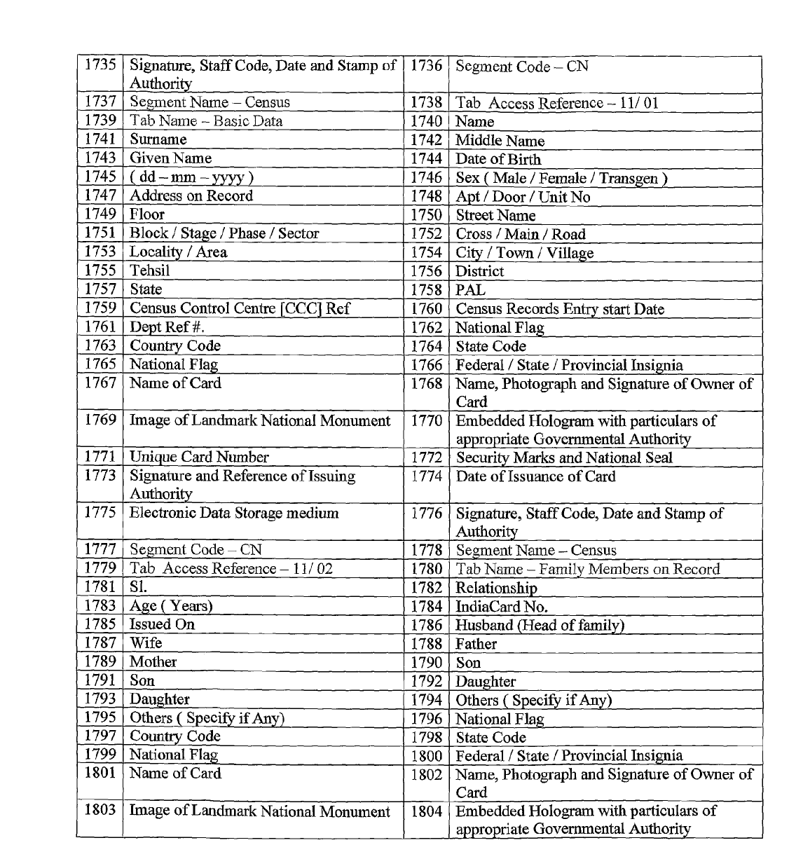

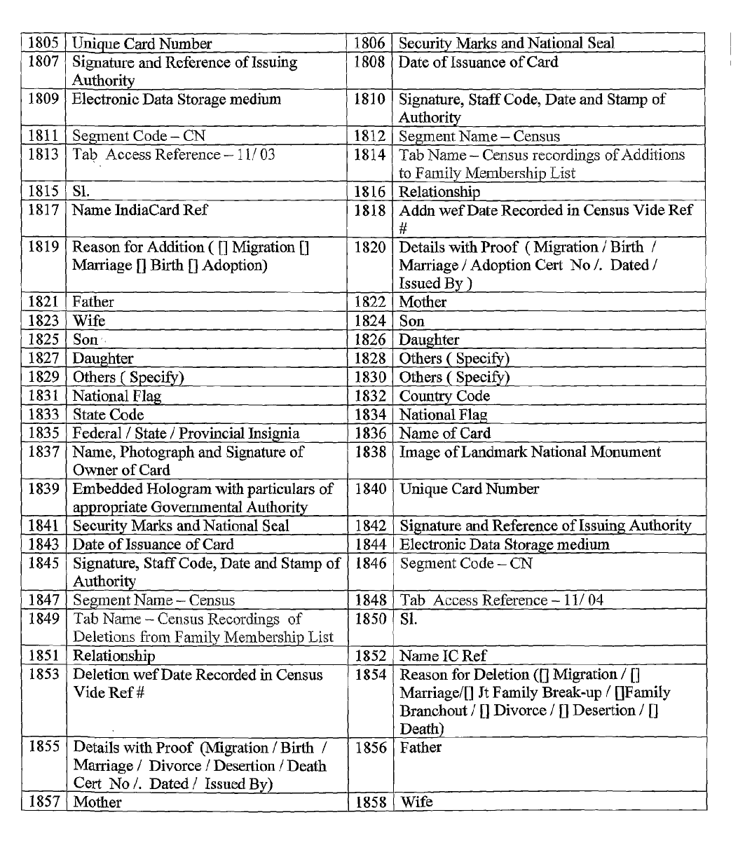

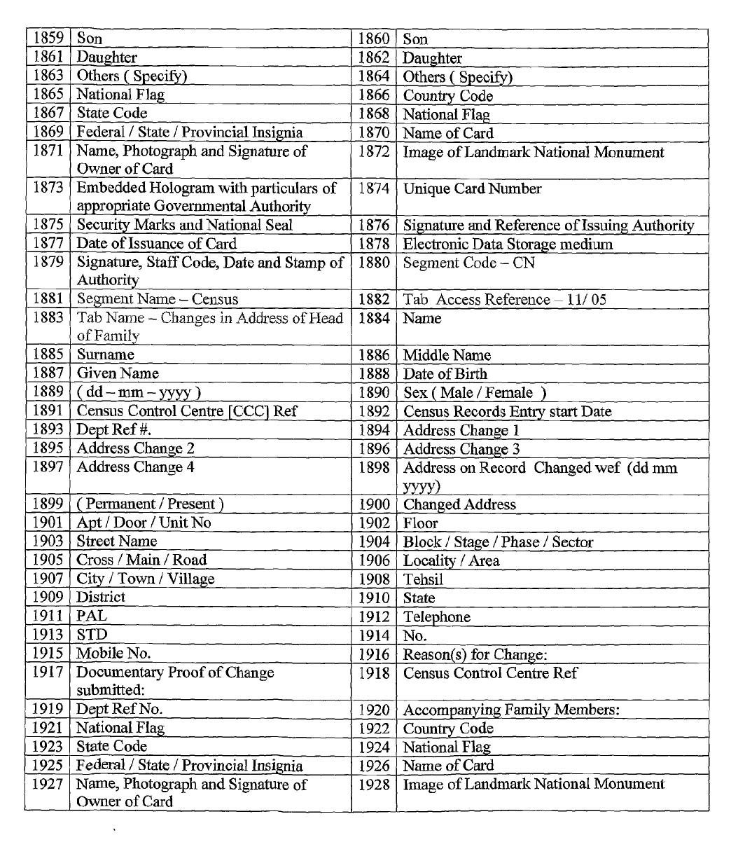

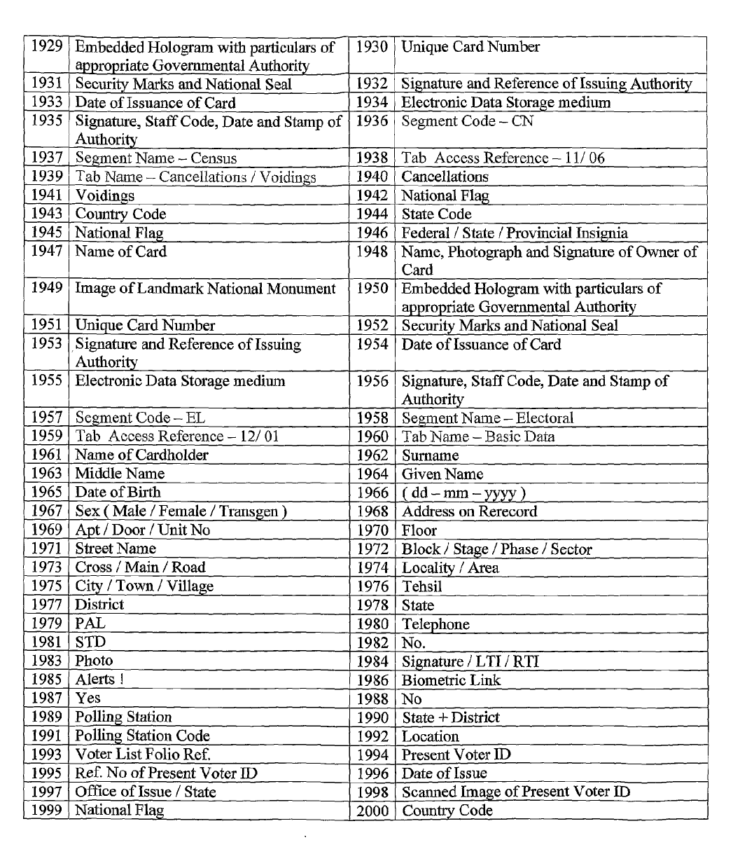

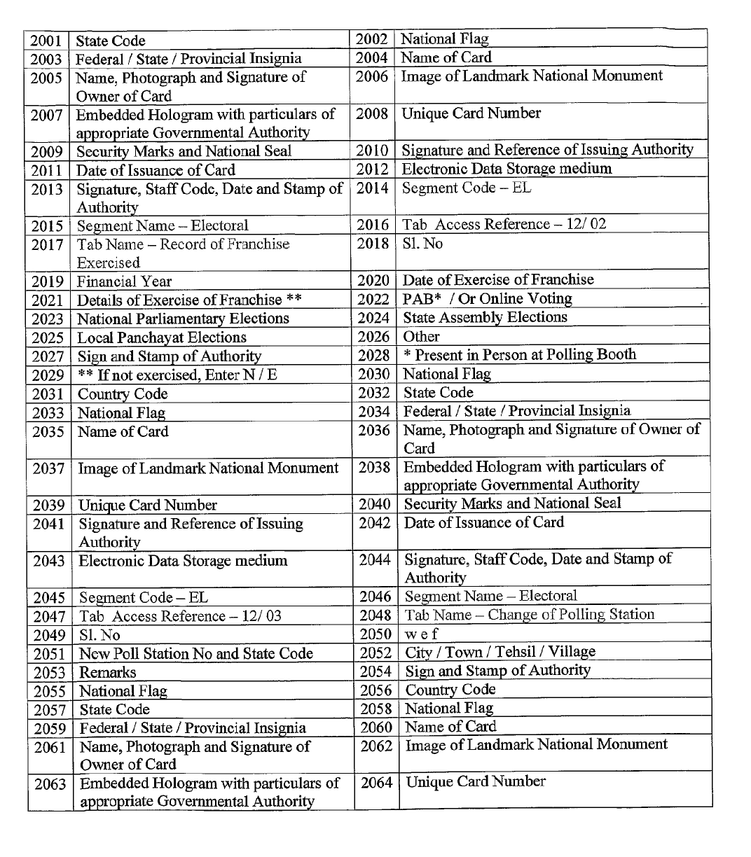

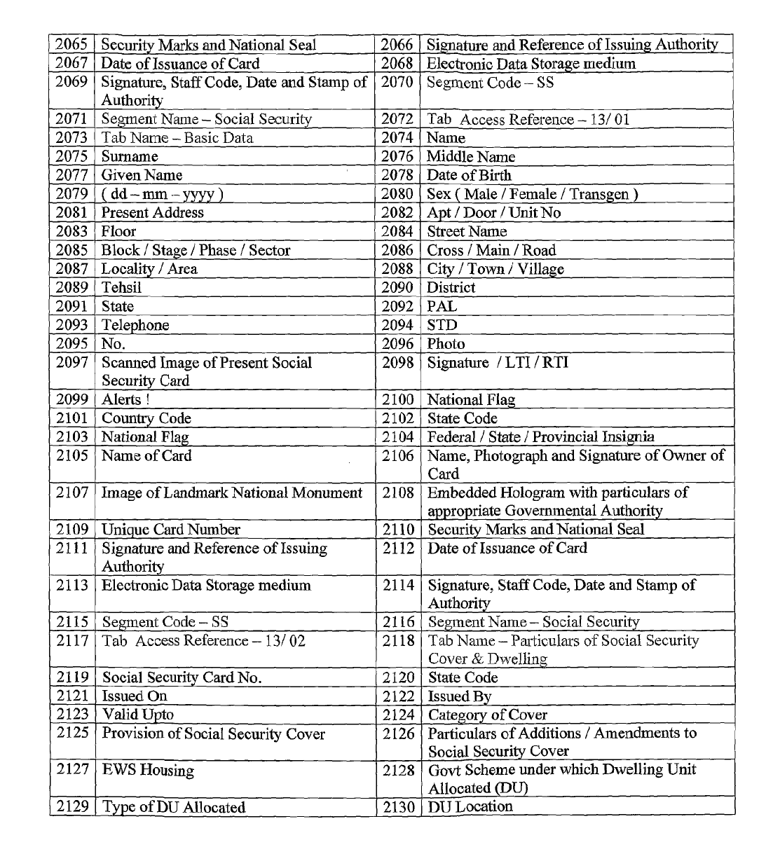

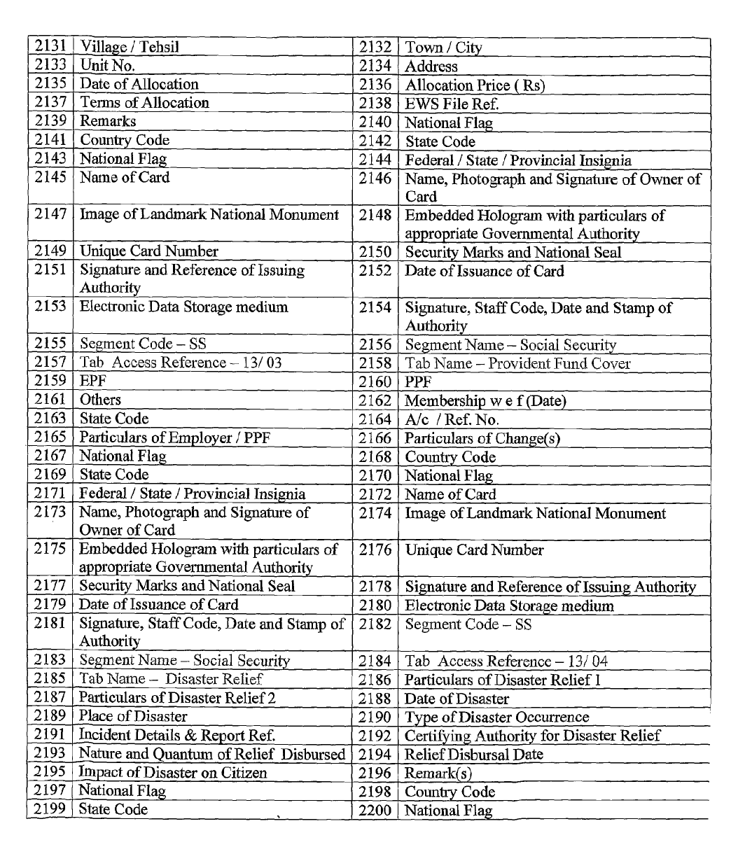

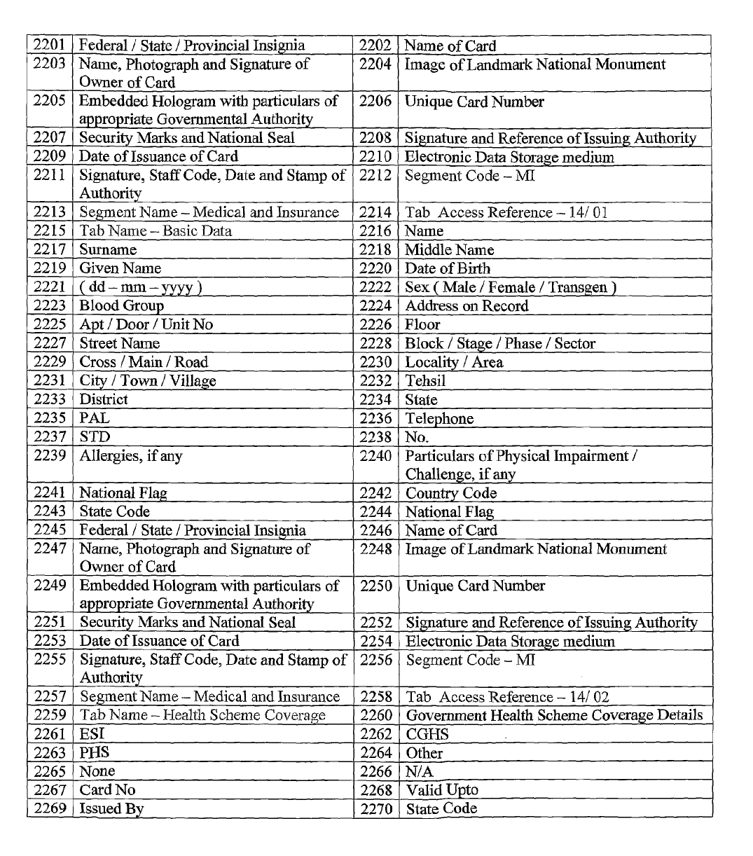

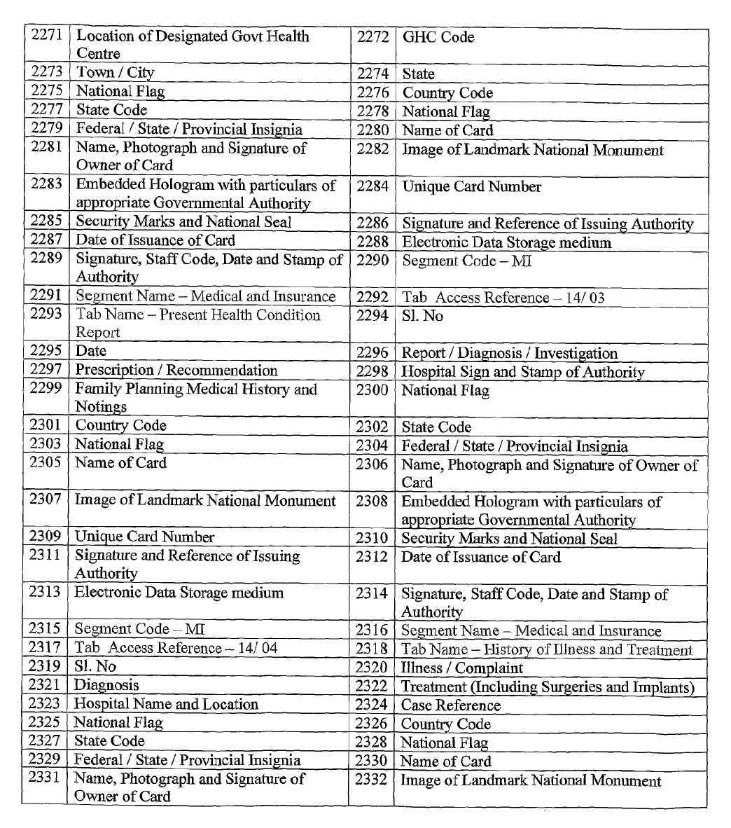

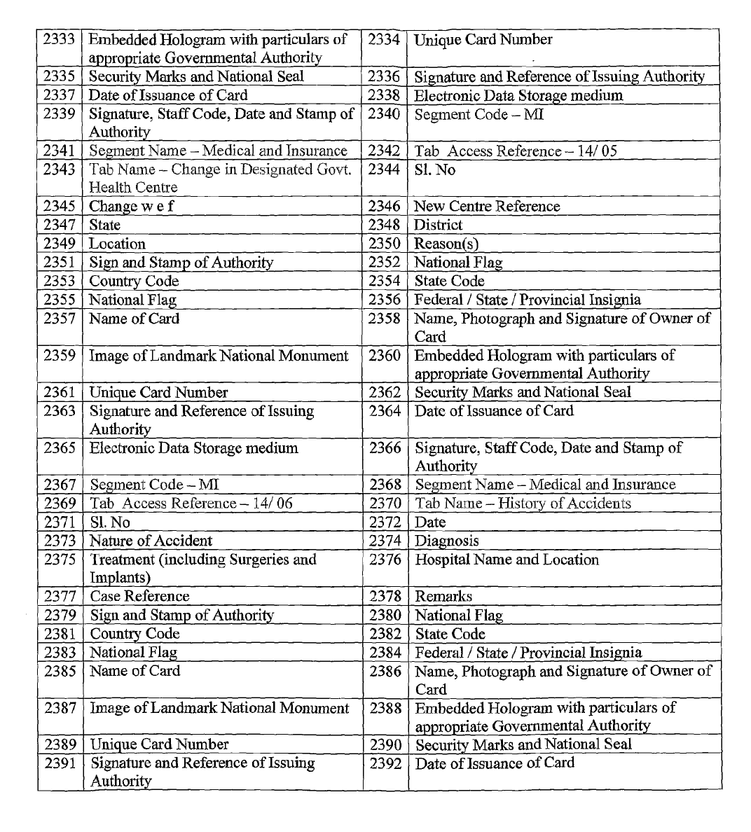

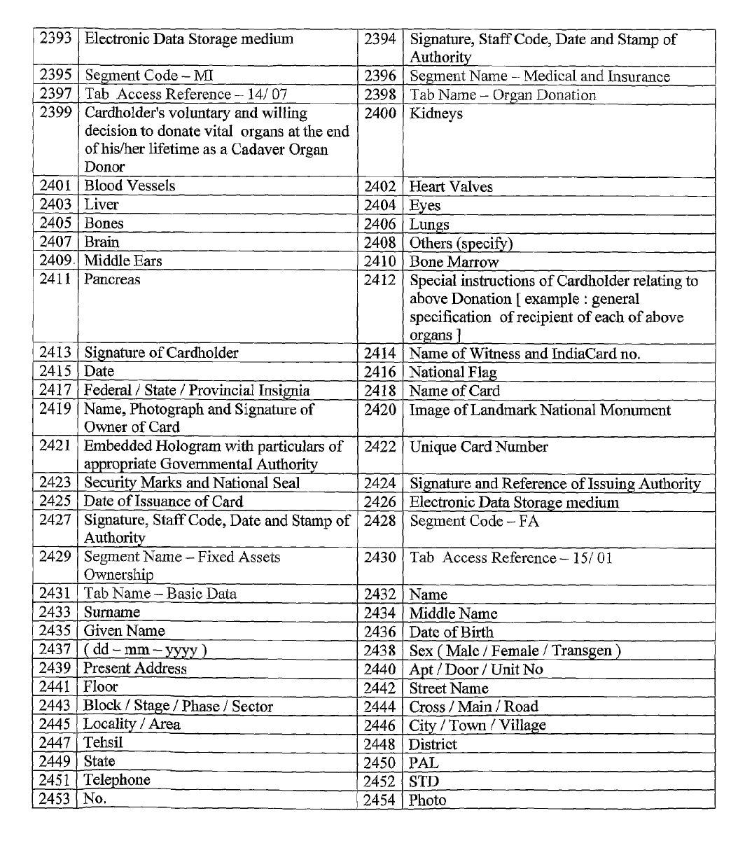

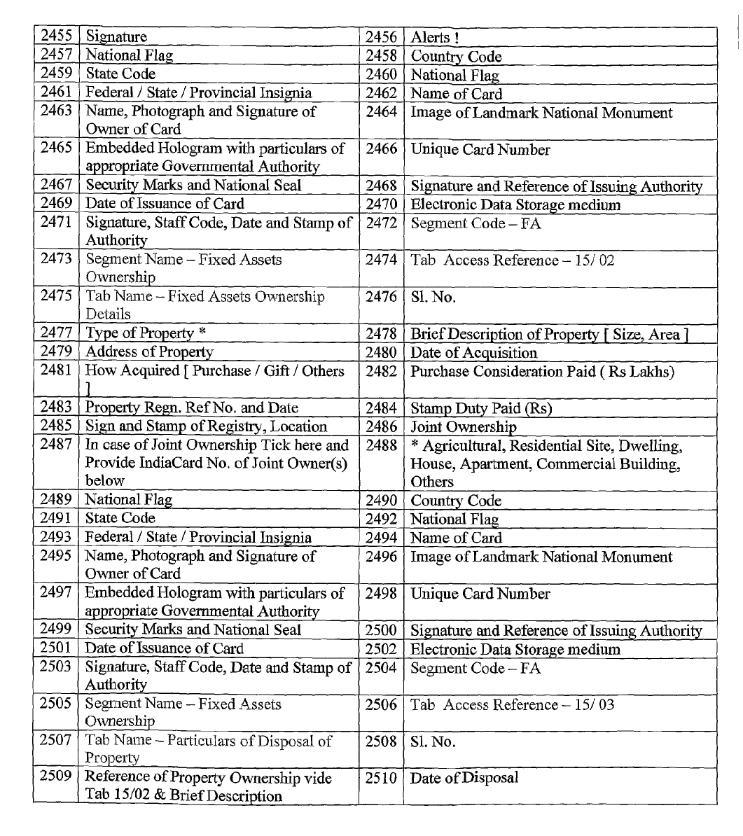

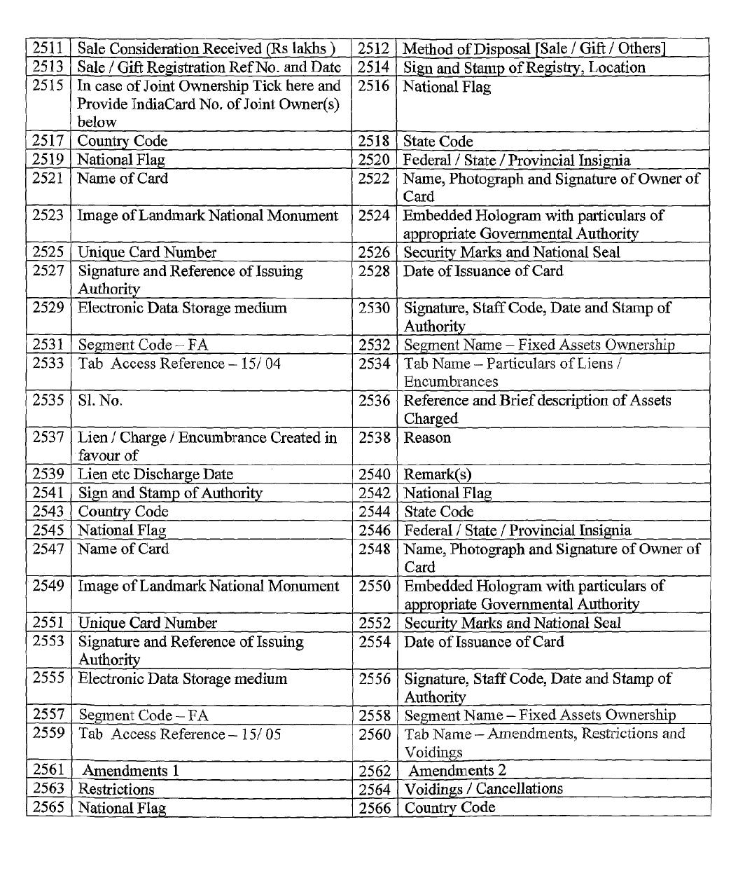

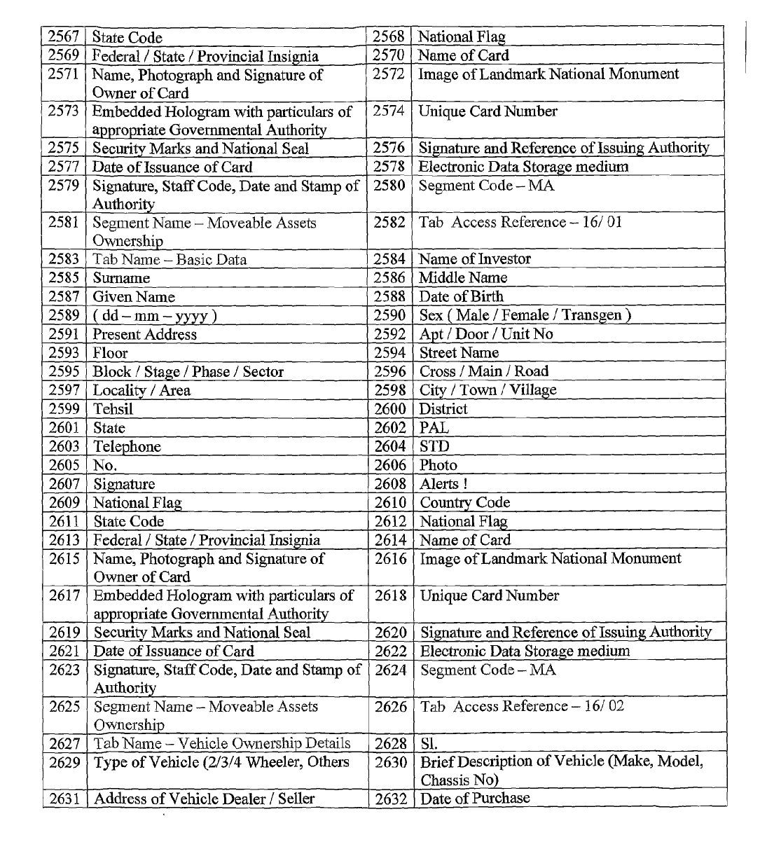

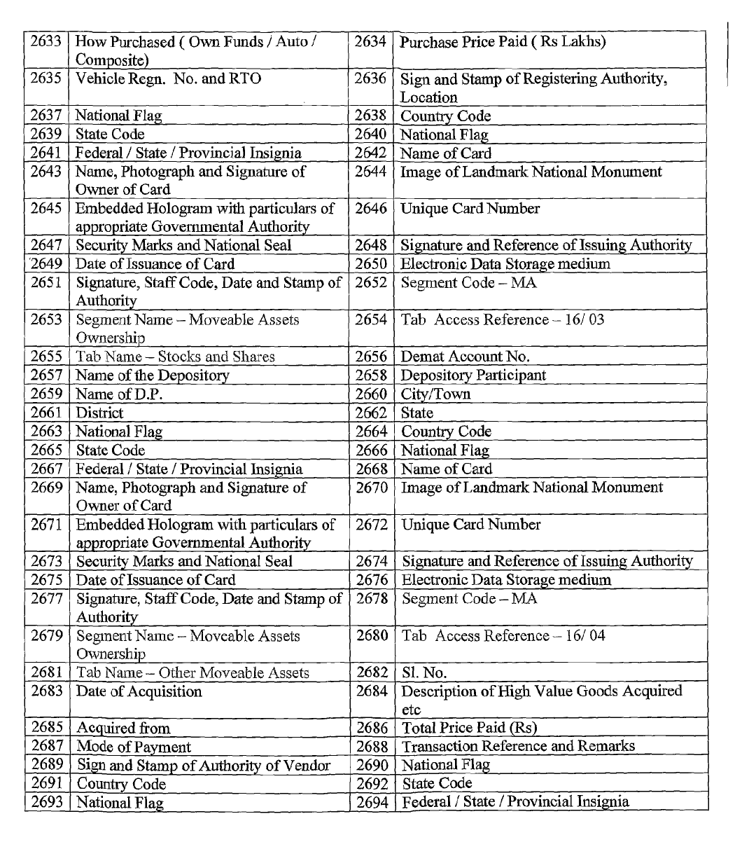

FIG. 13 illustrates the Schematic showing flow of citizen's data from Implementing and Operating Agencies of the NCID Programme to the National Registry and between such Agencies inter se, according to the present invention.

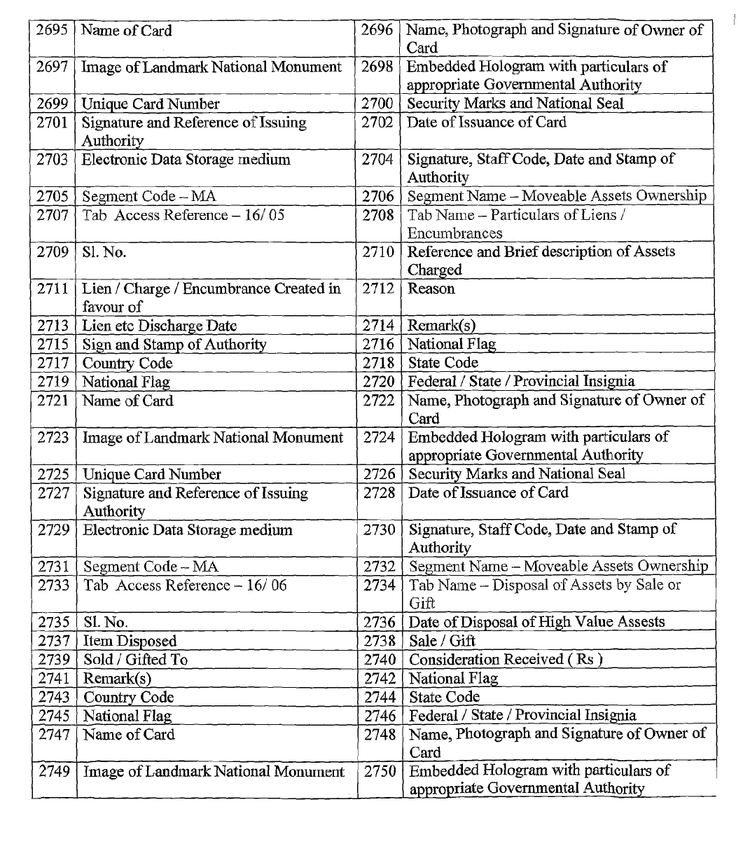

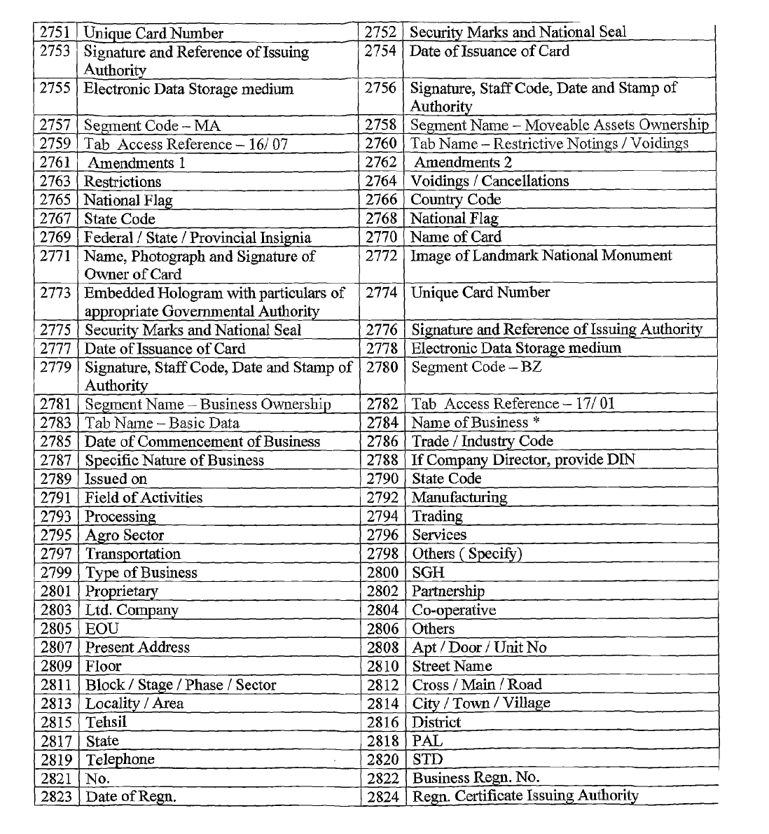

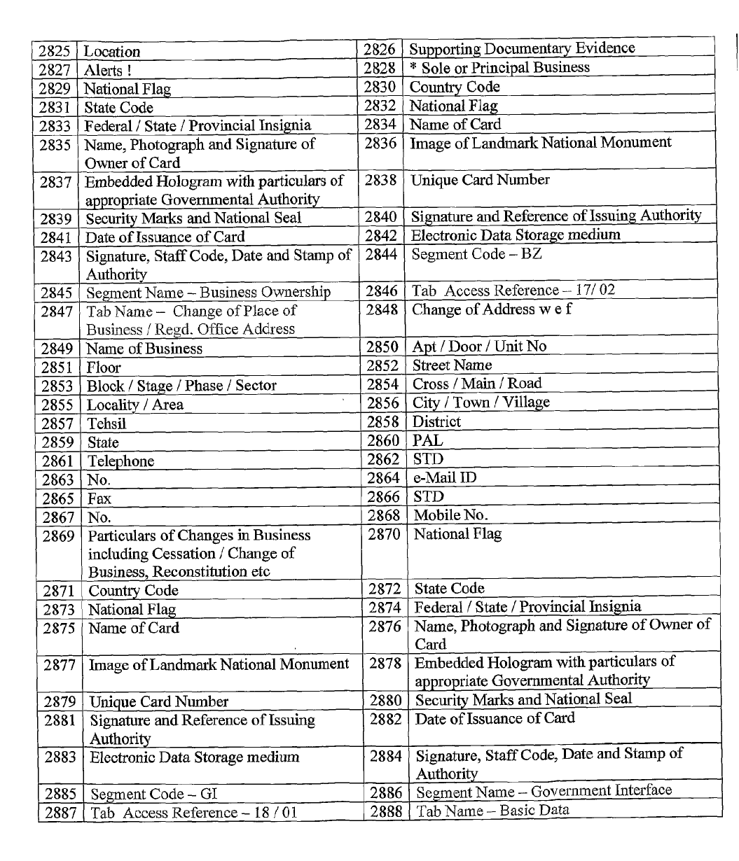

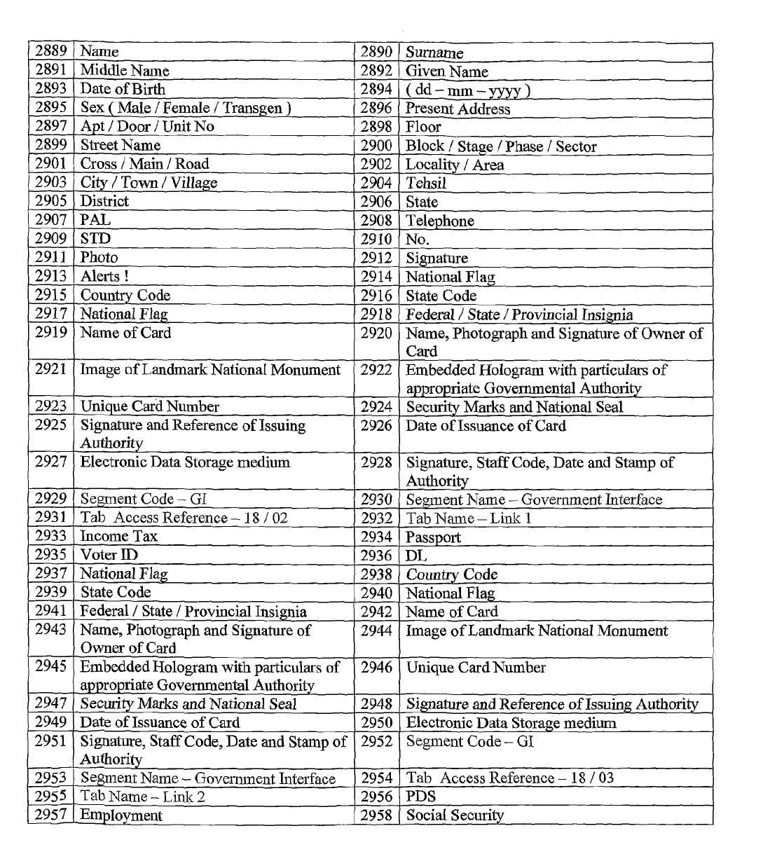

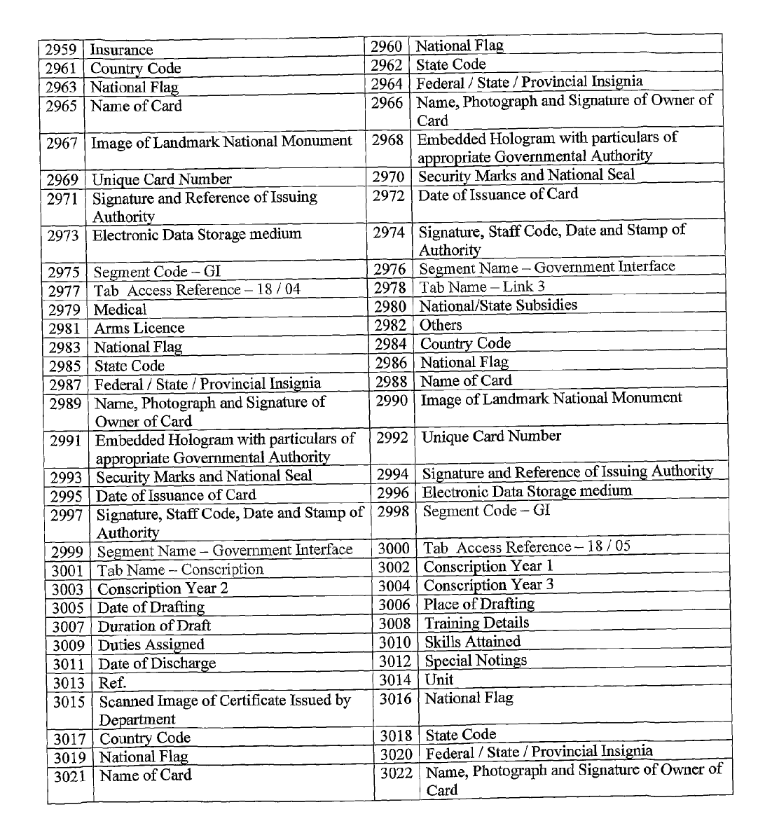

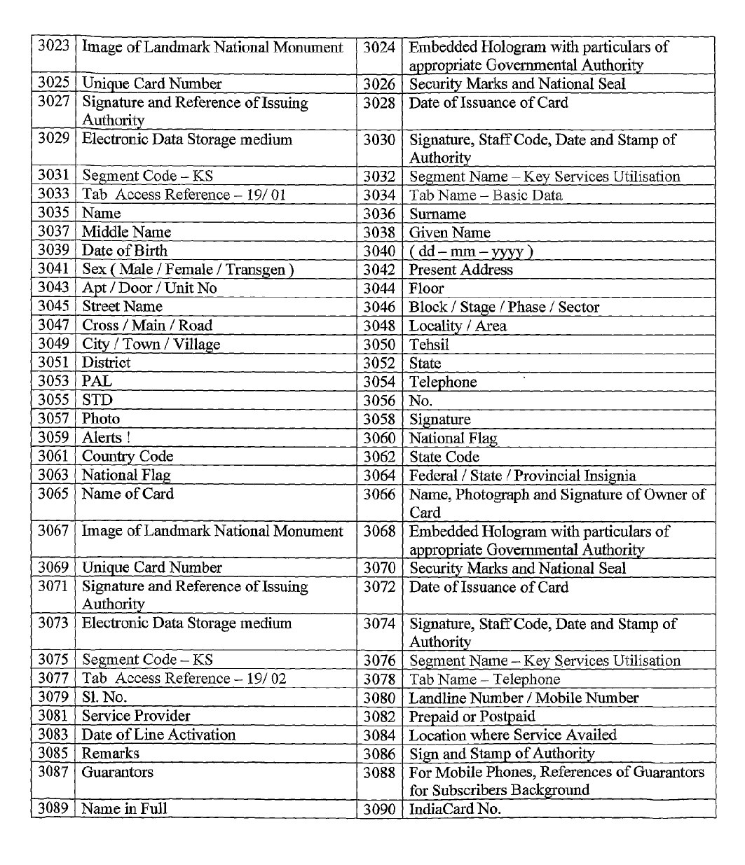

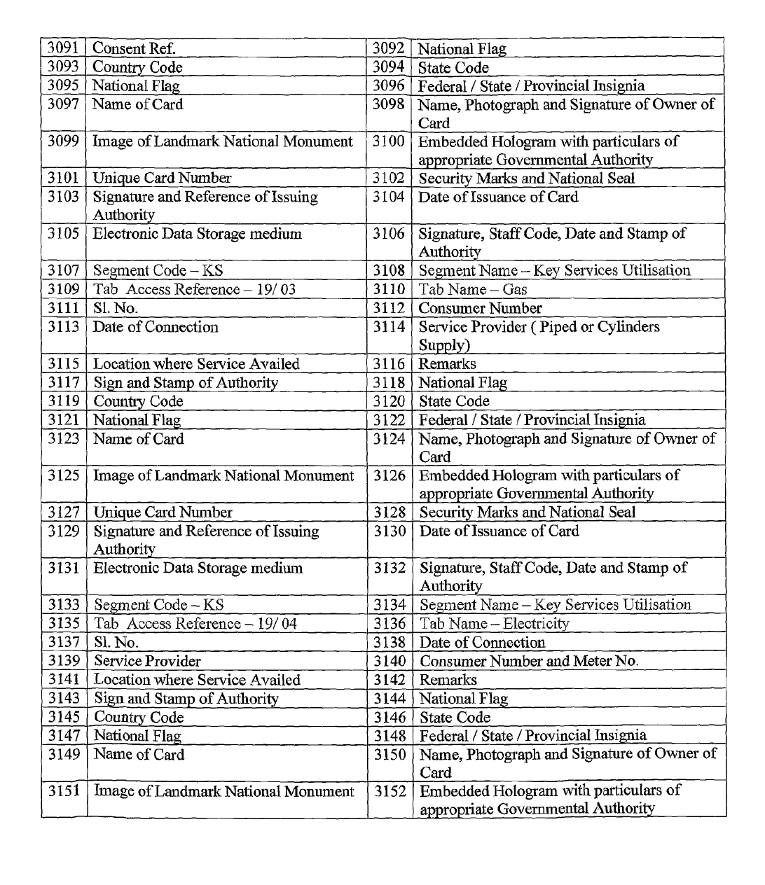

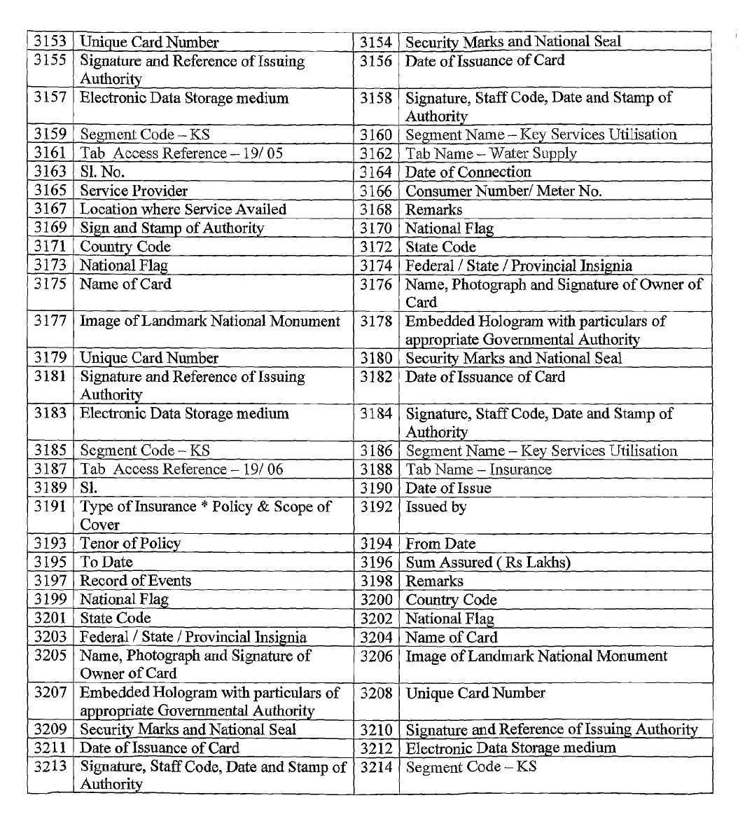

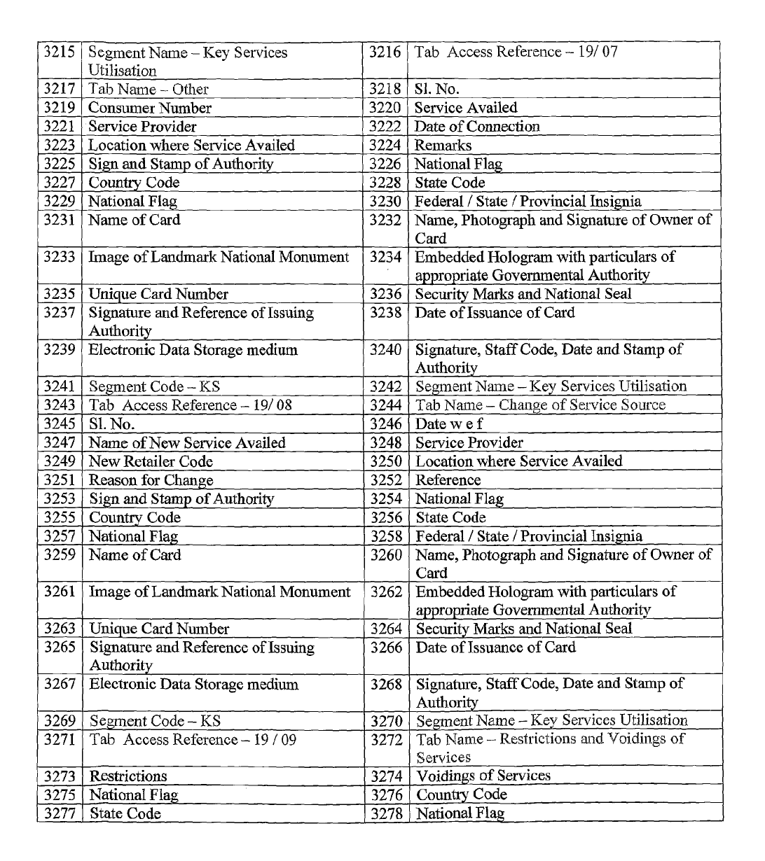

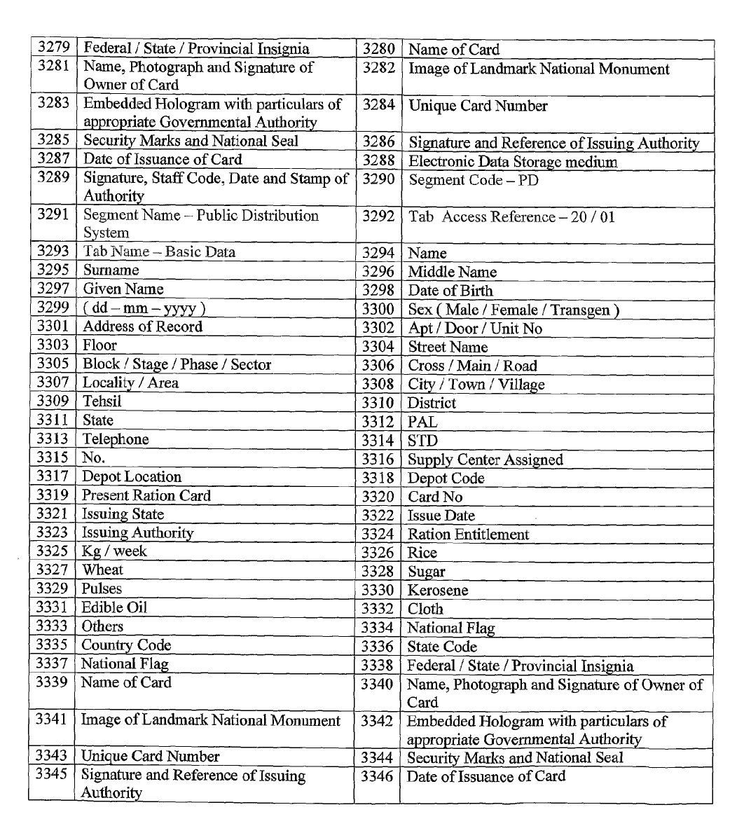

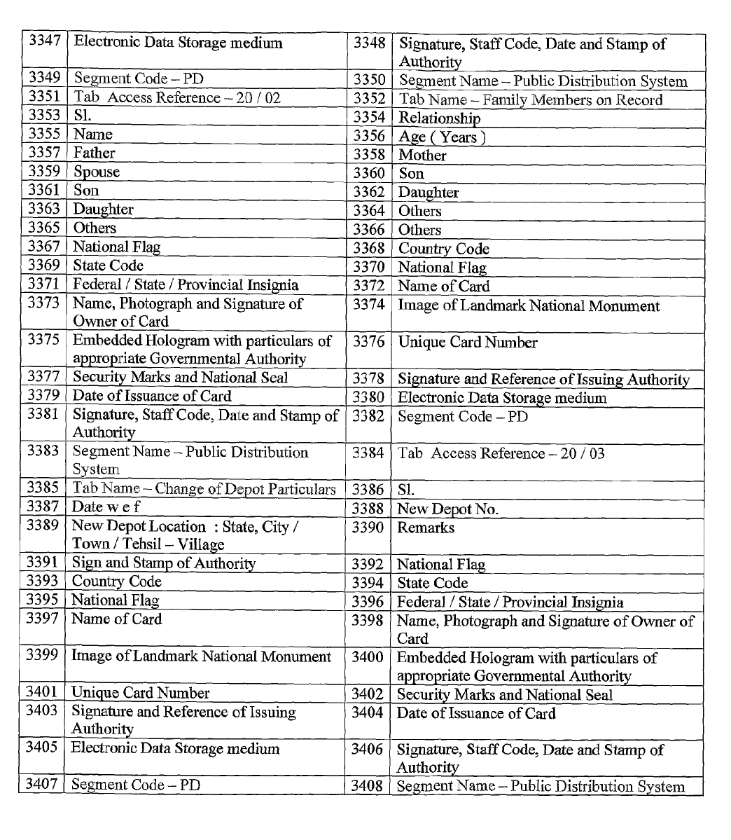

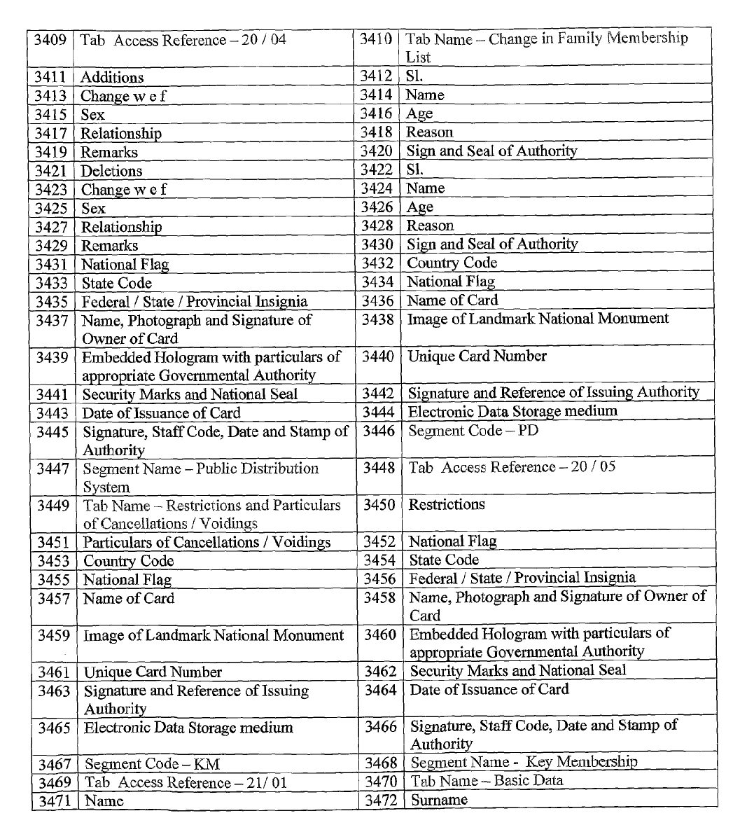

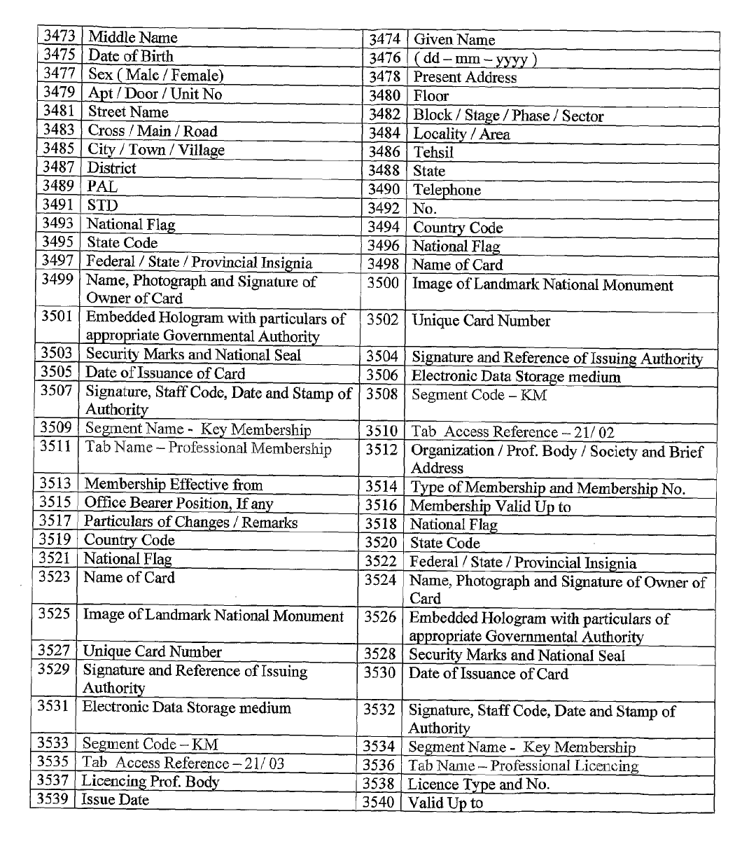

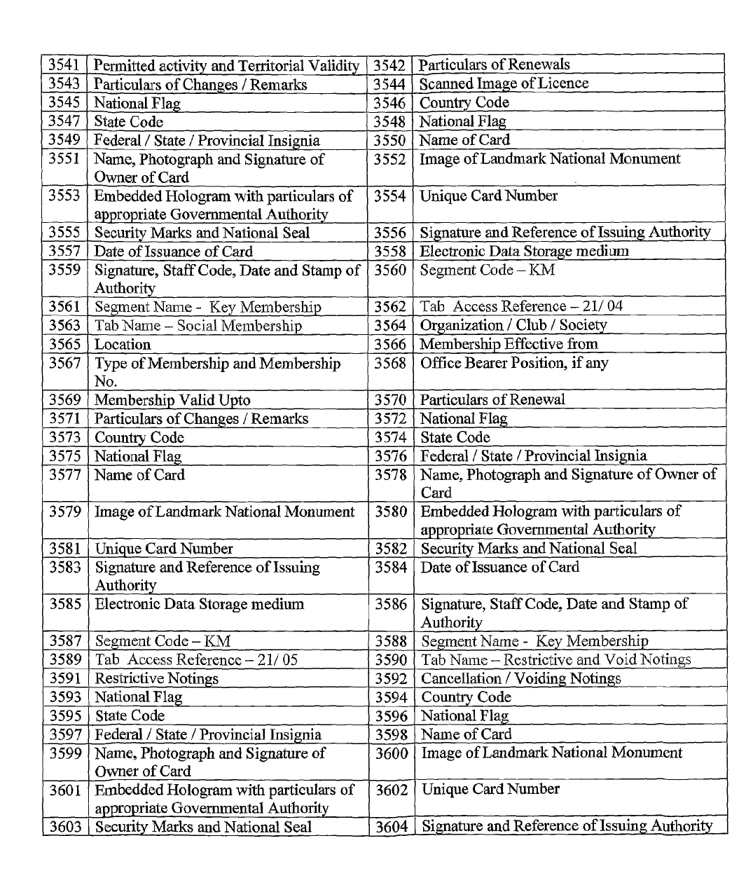

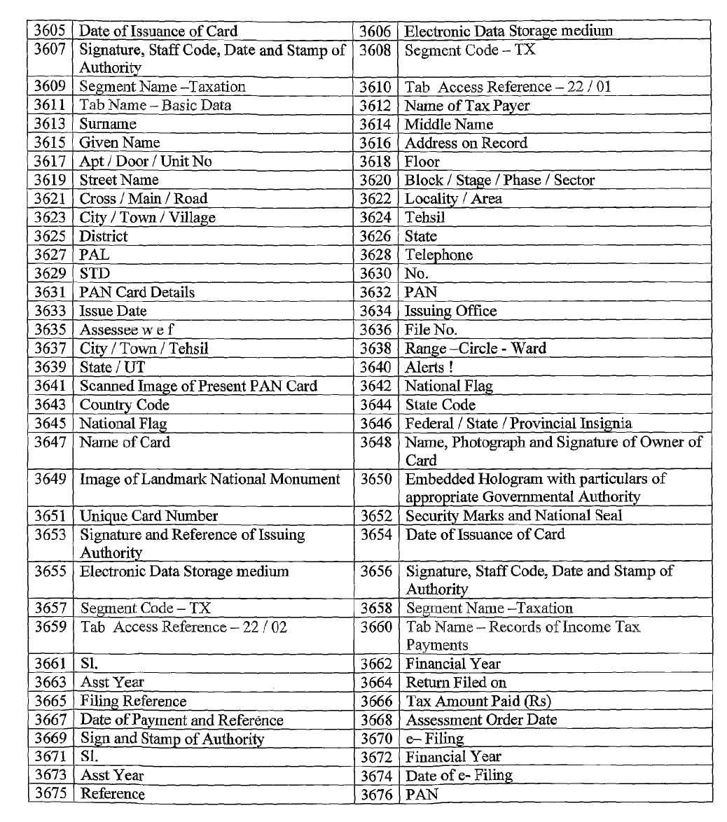

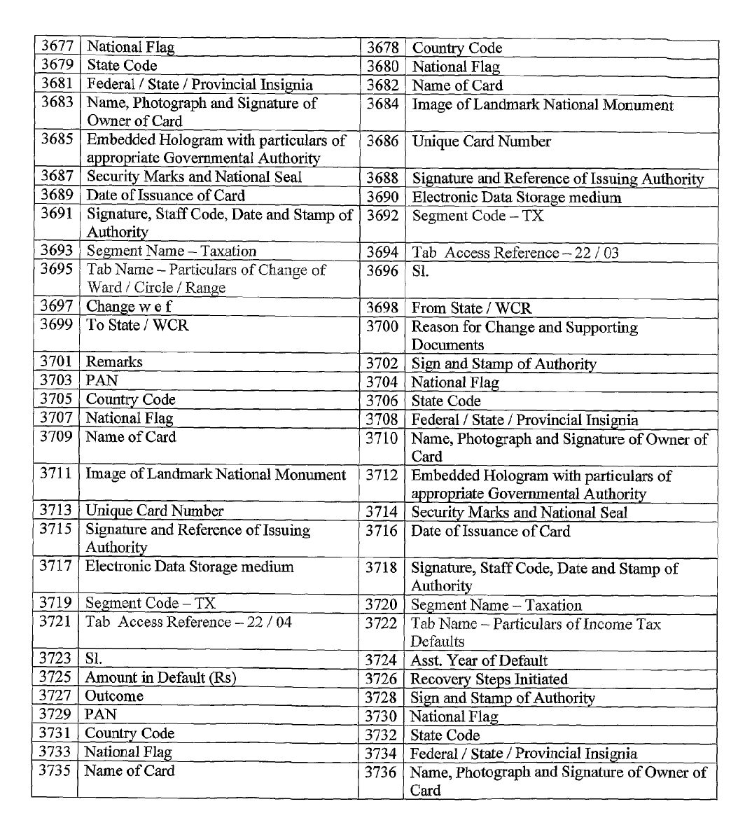

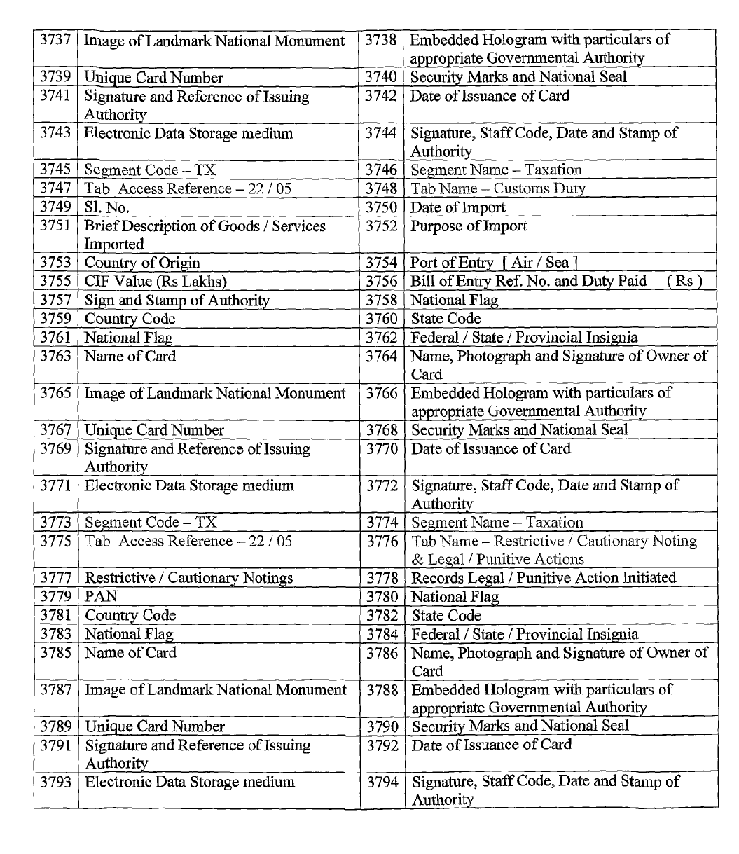

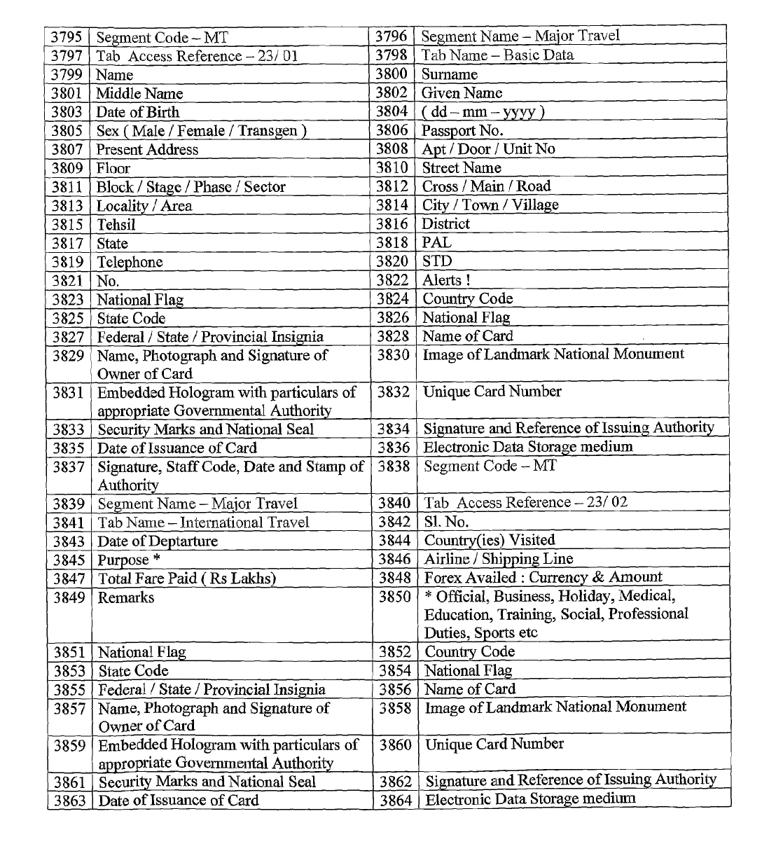

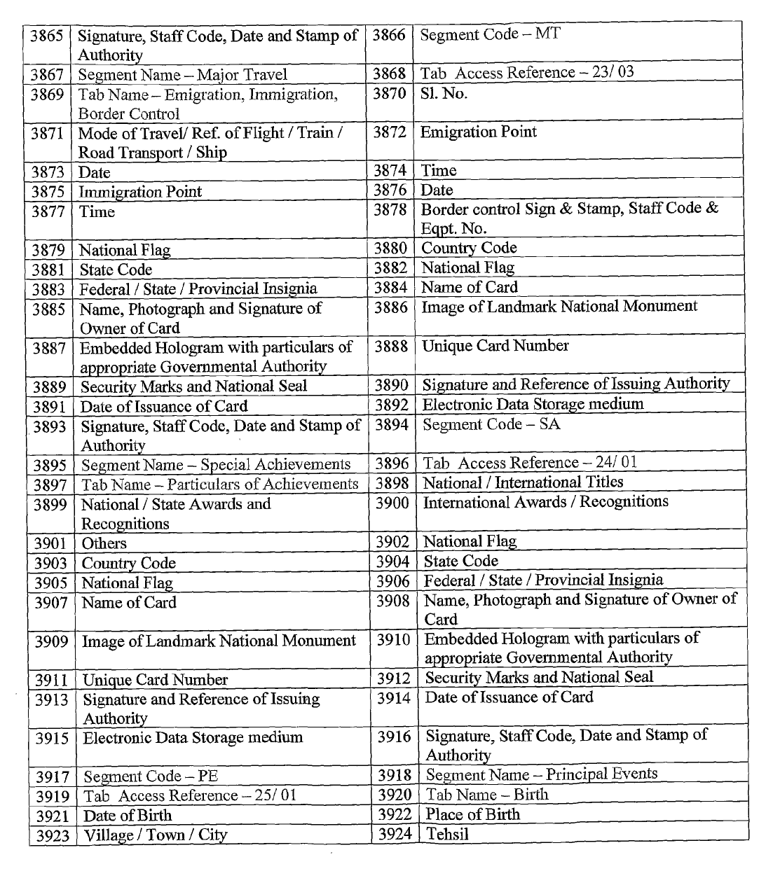

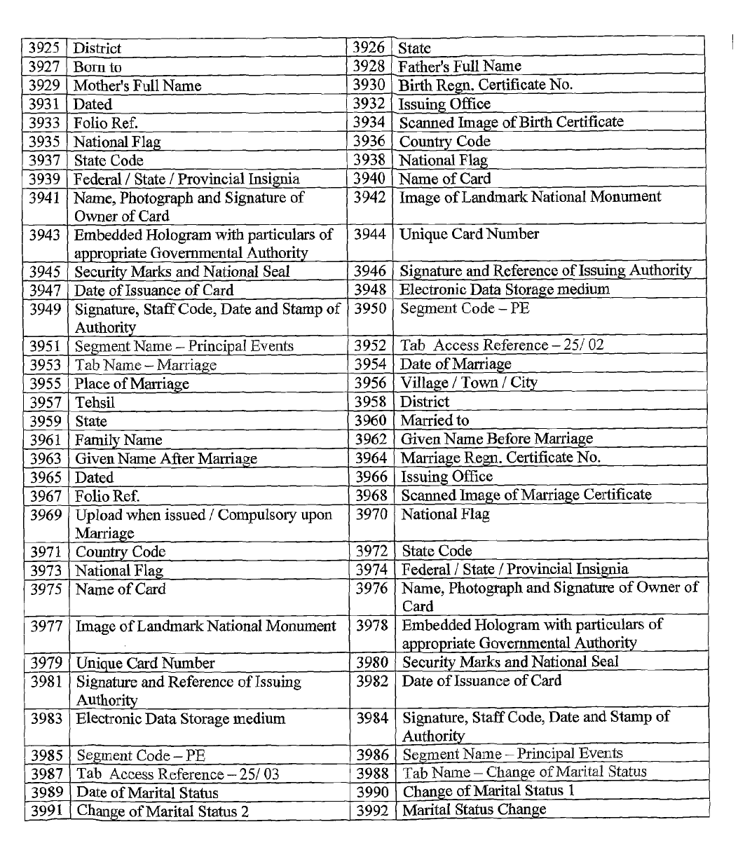

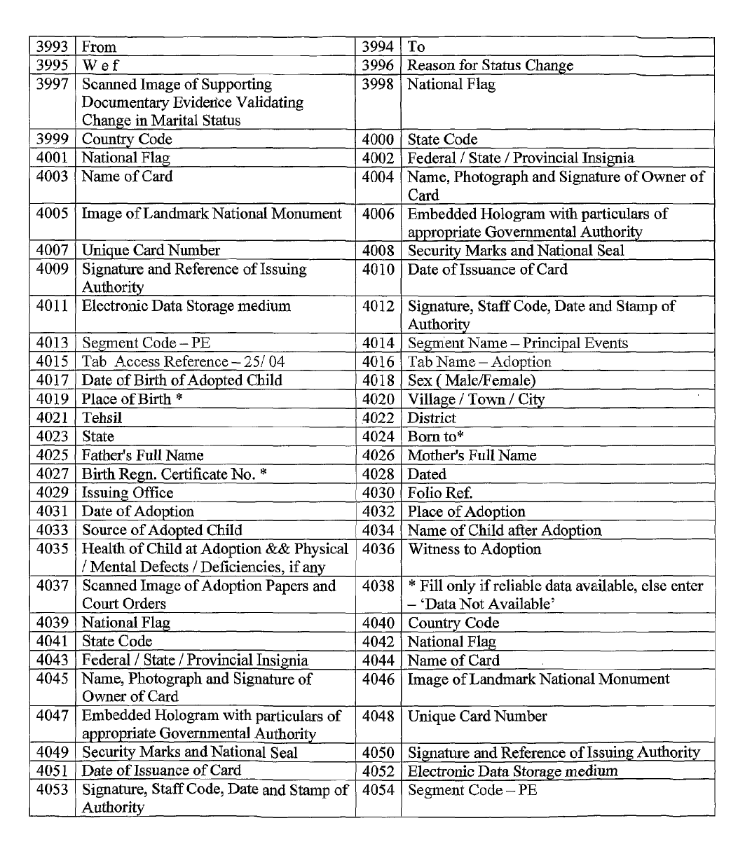

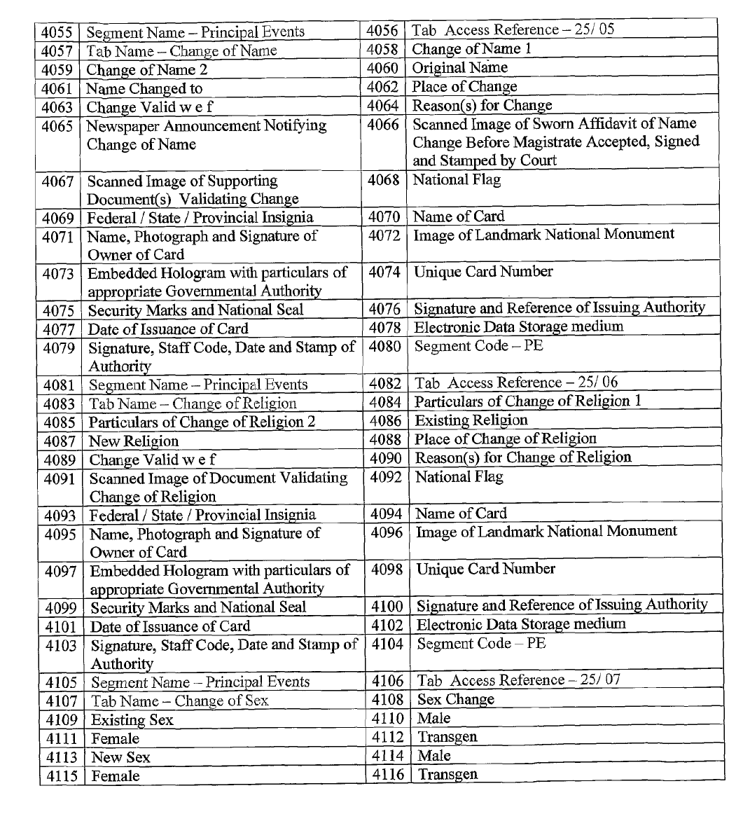

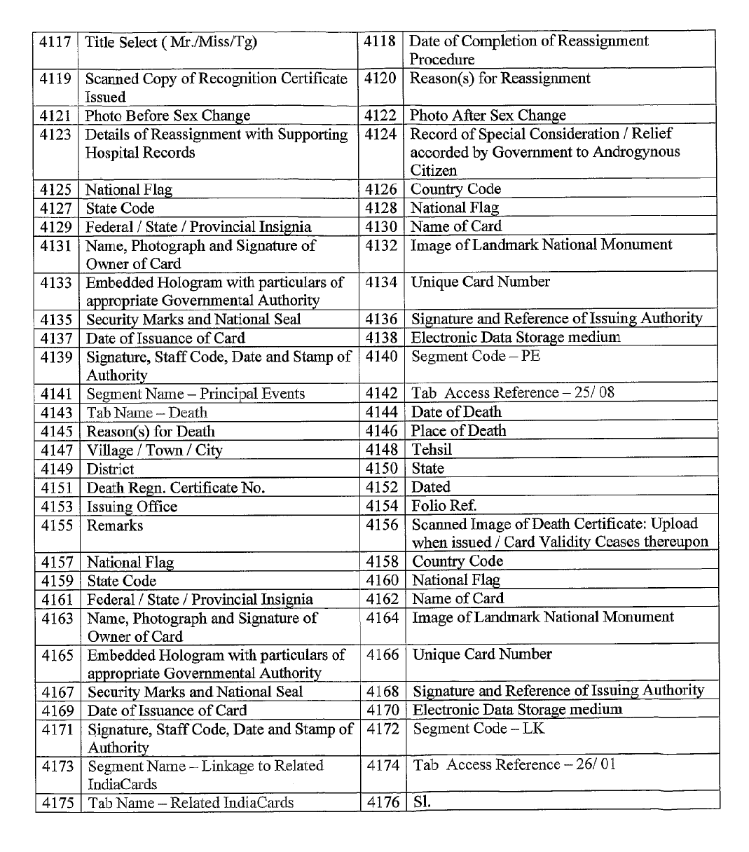

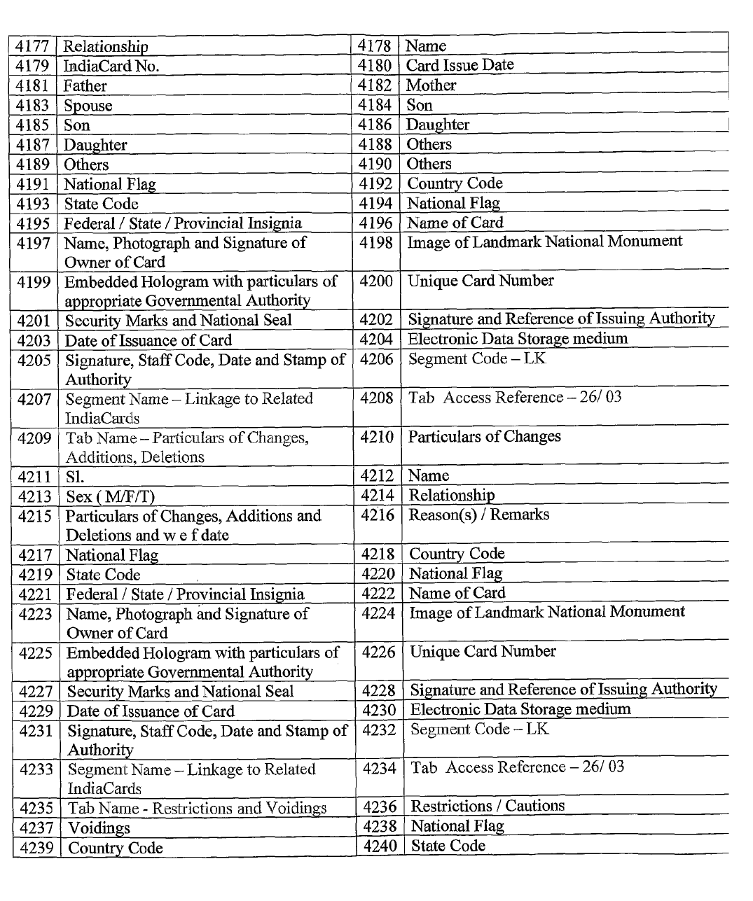

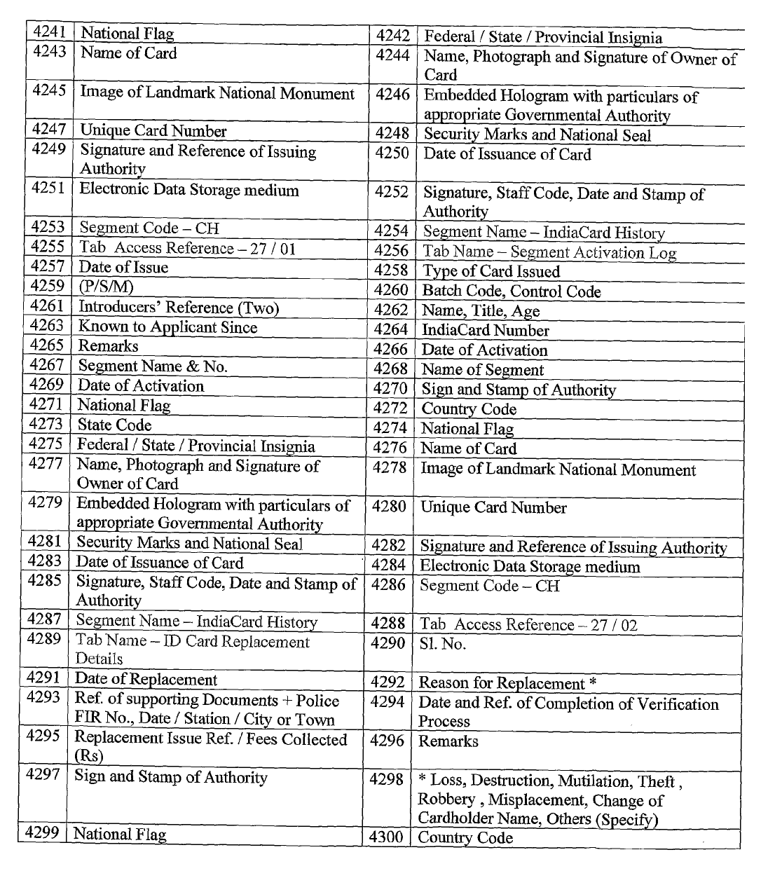

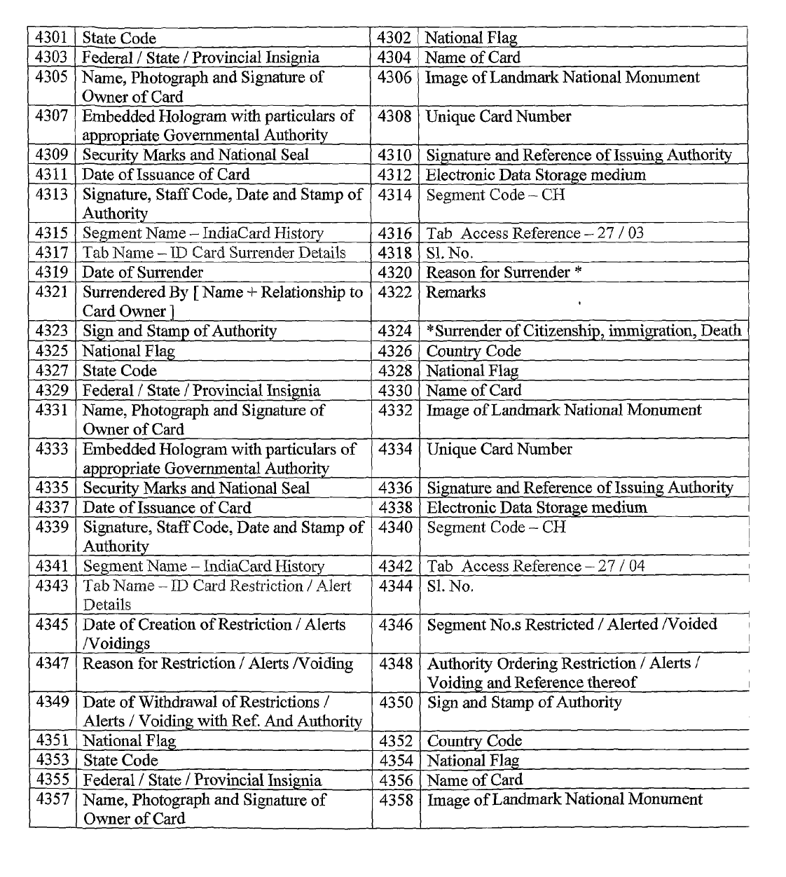

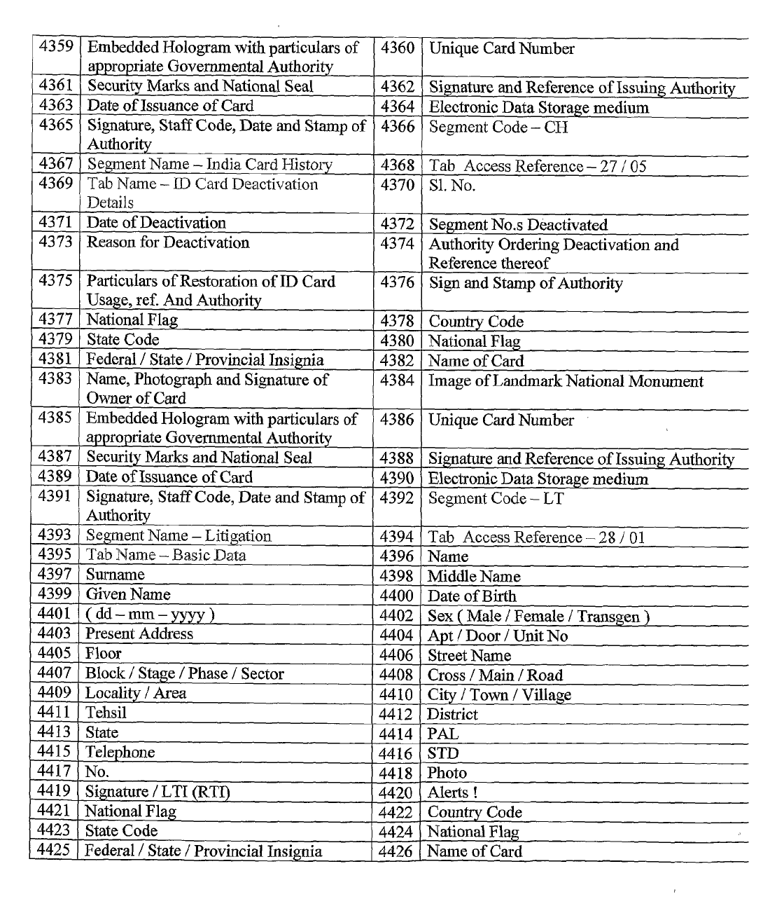

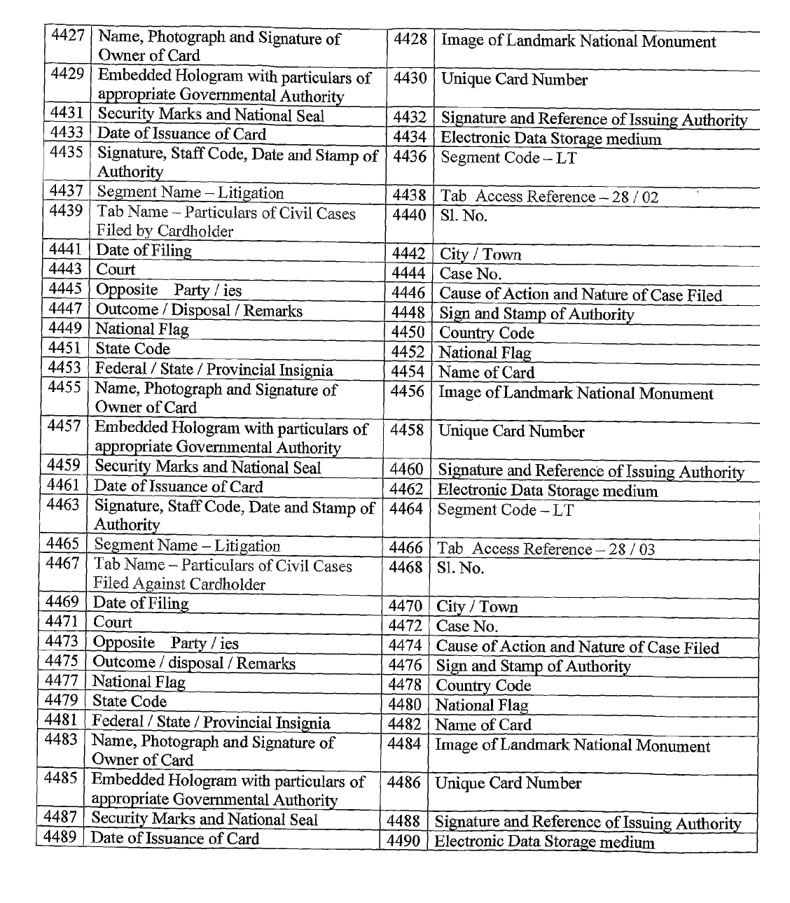

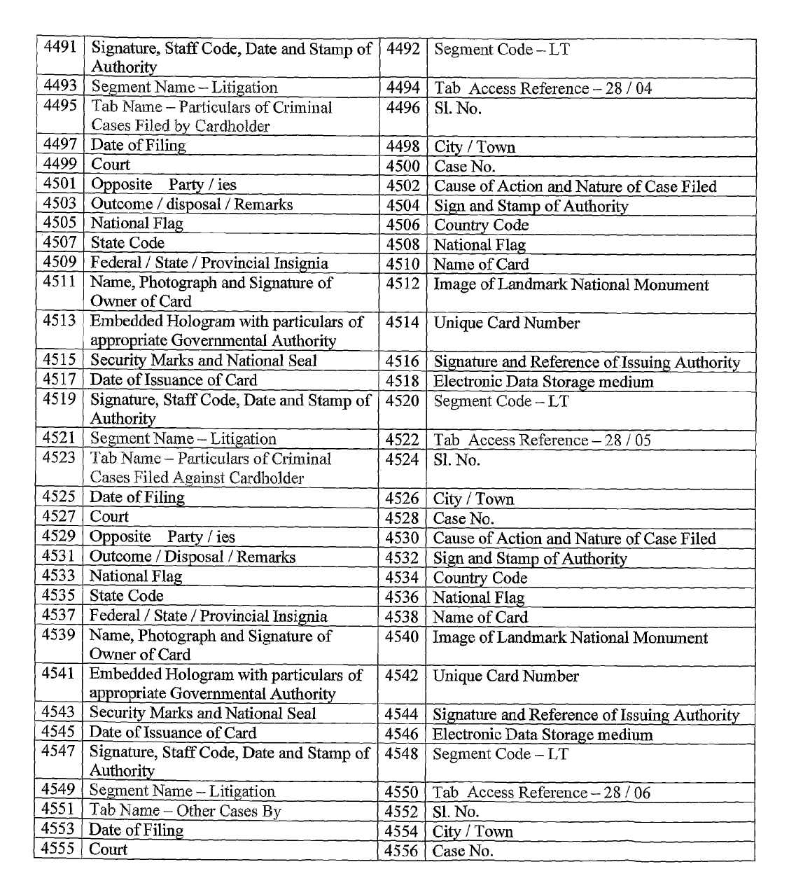

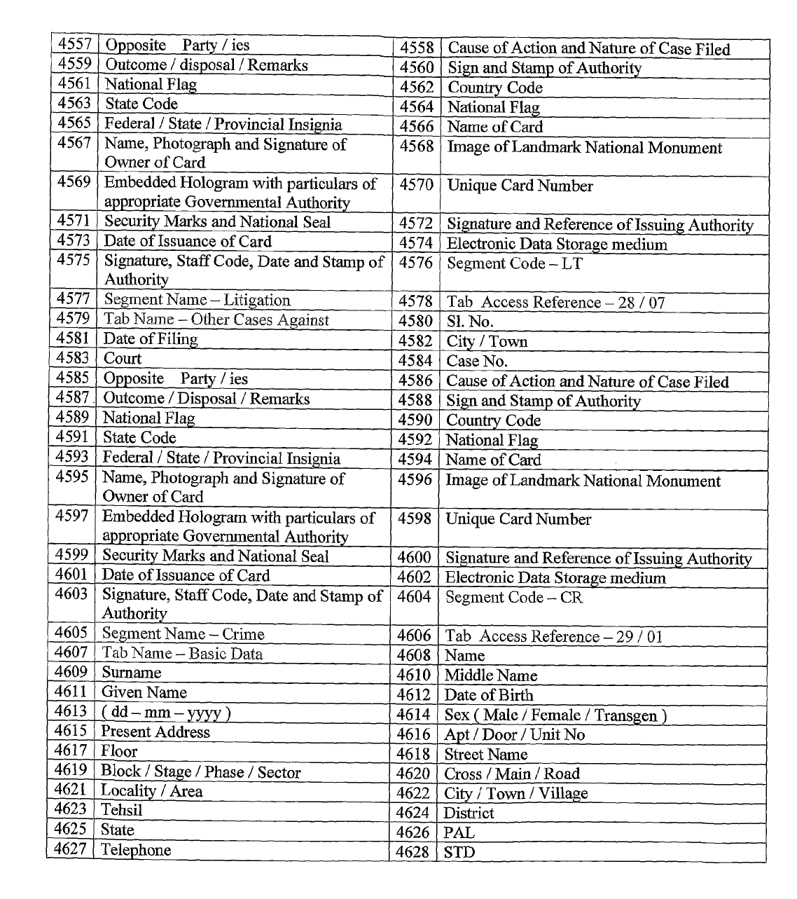

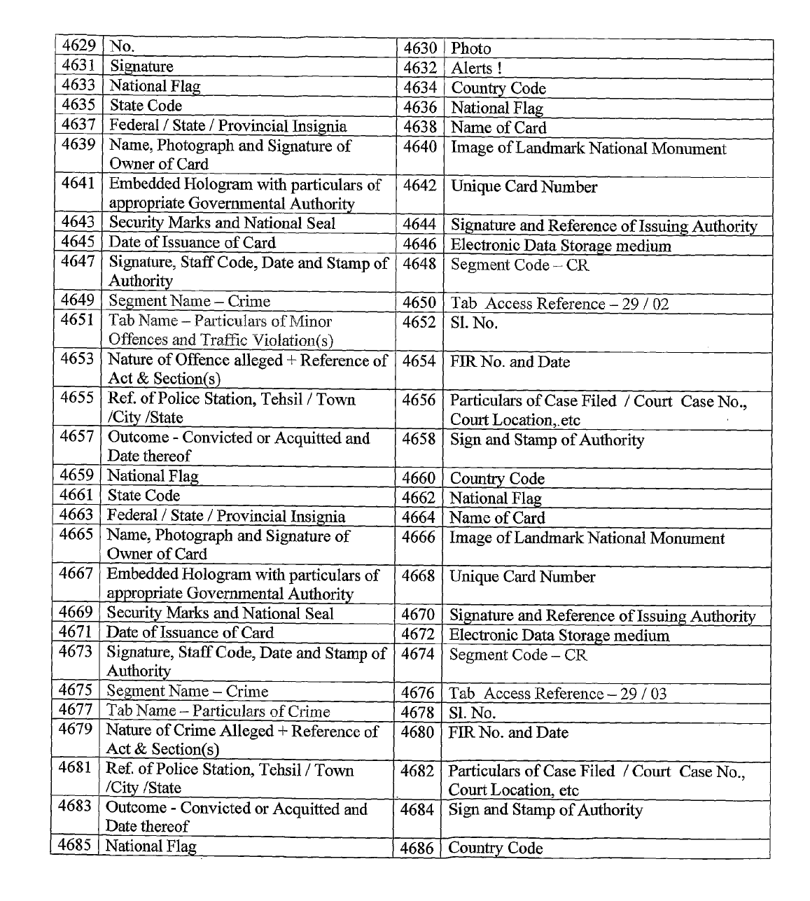

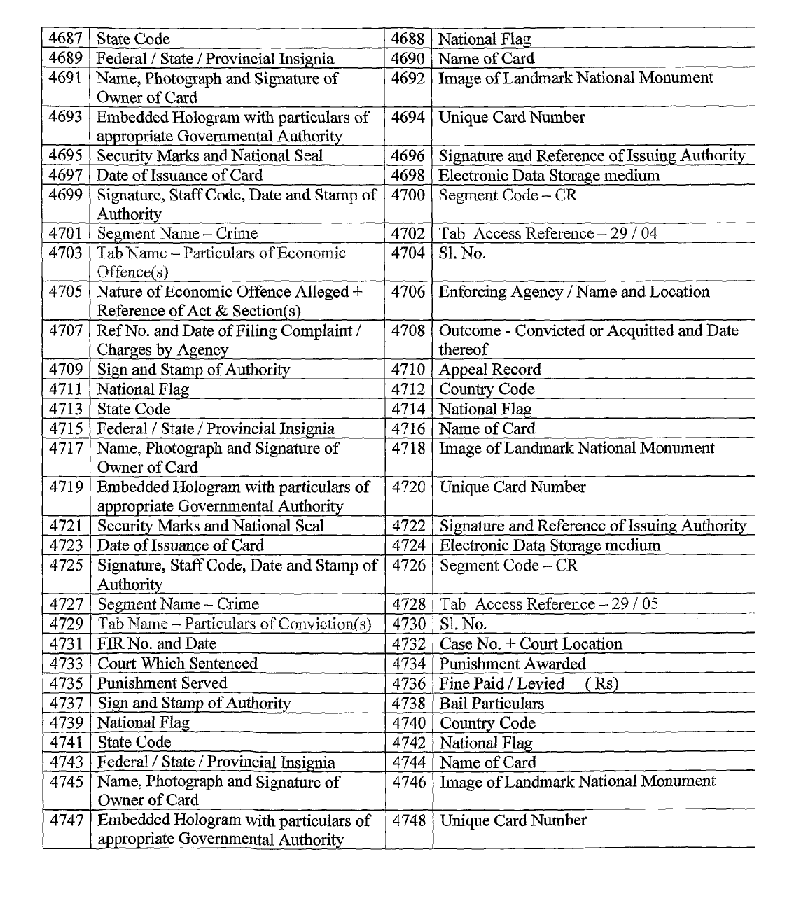

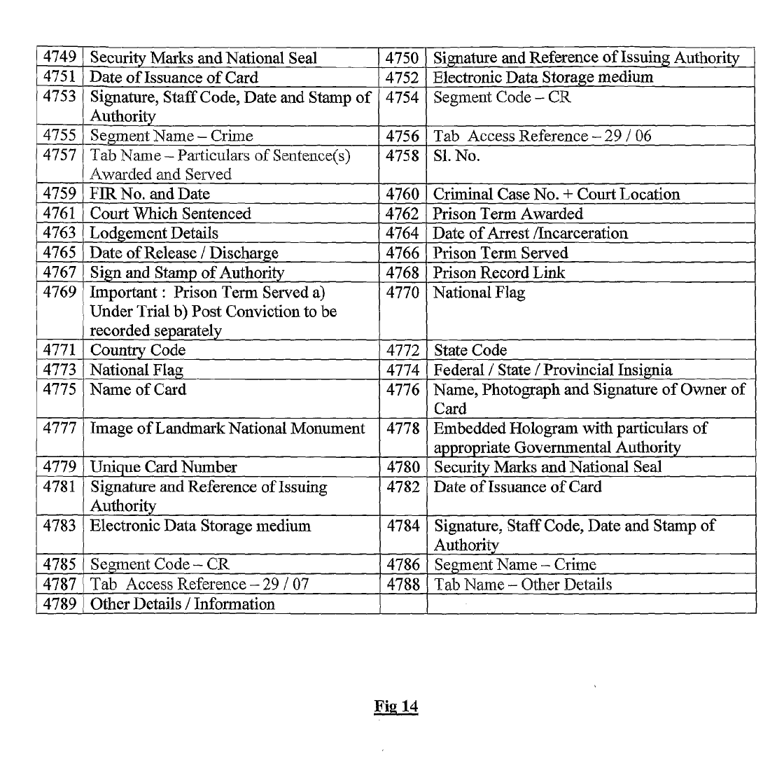

FIG. 14 illustrates the sequential Conglomeration of Data Fields of all Tabs and Sub Tabs in National Registry and on memory chip of citizen ID Card, herein seen in English which will be facilitated in Hindi and in all official Indian languages in due course.

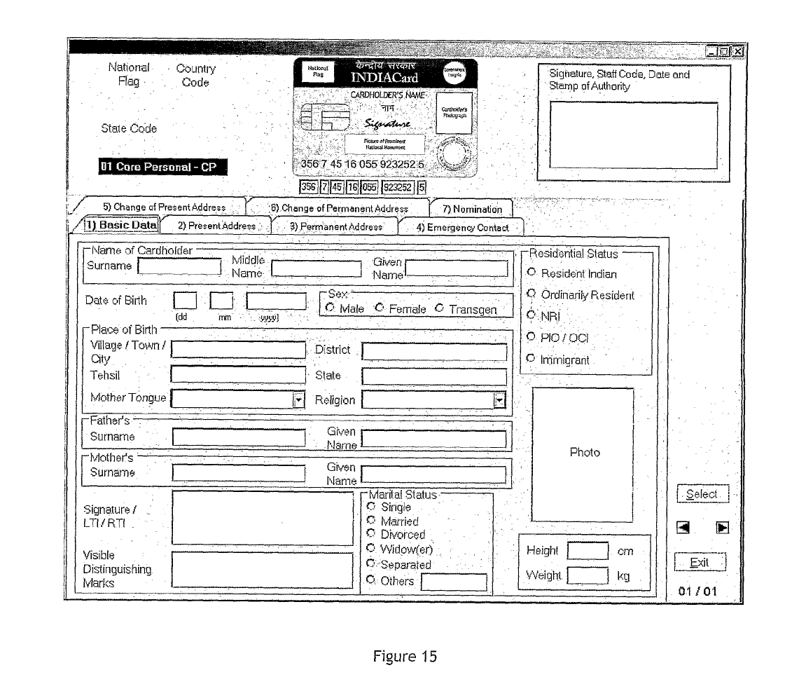

FIG. 15 illustrates the design, content, inter-linkage, functionality and configuration of specially designed and developed Tabs to store Core Personal Data of Citizens which is displayed when the data embedded in the chip on the card is called up for review, according to the present invention. The sub-Tabs thereof contain further elaboration of the configurations and arrangements for systematically classifying, storing and accessing data of each Citizen appurtenant to said main Tab.

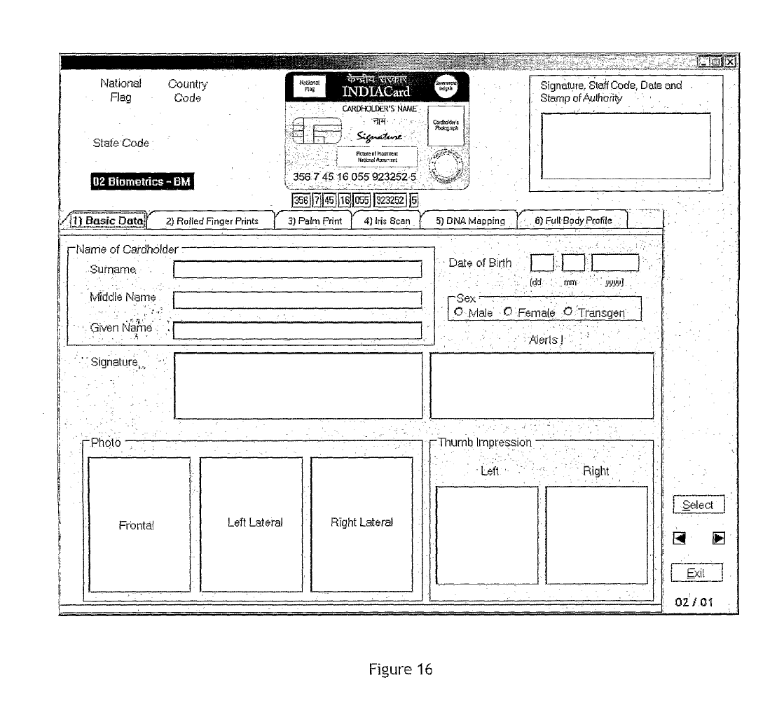

FIG. 16 illustrates the design, content, inter-linkage, functionality and configuration of specially designed and developed Tabs to store Biometric Data of Citizens which is displayed when the data embedded in the chip on the card is called up for review, according to the present invention. The sub-Tabs thereof contain further elaboration of configurations and arrangements designed for systematically classifying, storing and accessing data of each Citizen appurtenant to said main Tab.

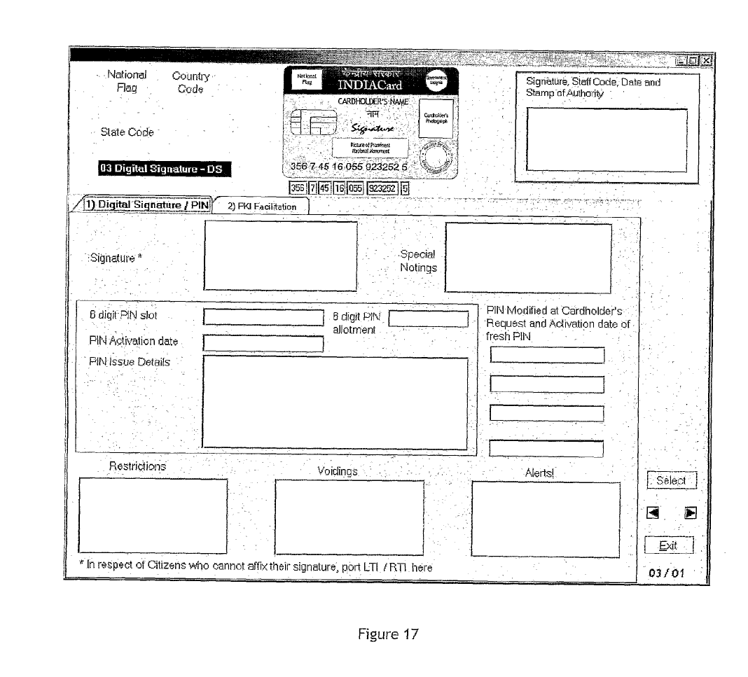

FIG. 17 illustrates the design, content, inter-linkage, functionality, and configuration of specially designed and developed Tabs to store Digital Signature Data of Citizens which is displayed when the data embedded in the chip on the card is called up for review, according to the present invention. The sub-Tabs thereof contain further elaboration of the configurations and arrangements designed for systematically classifying, storing and accessing data of each Citizen appurtenant to said main Tab.

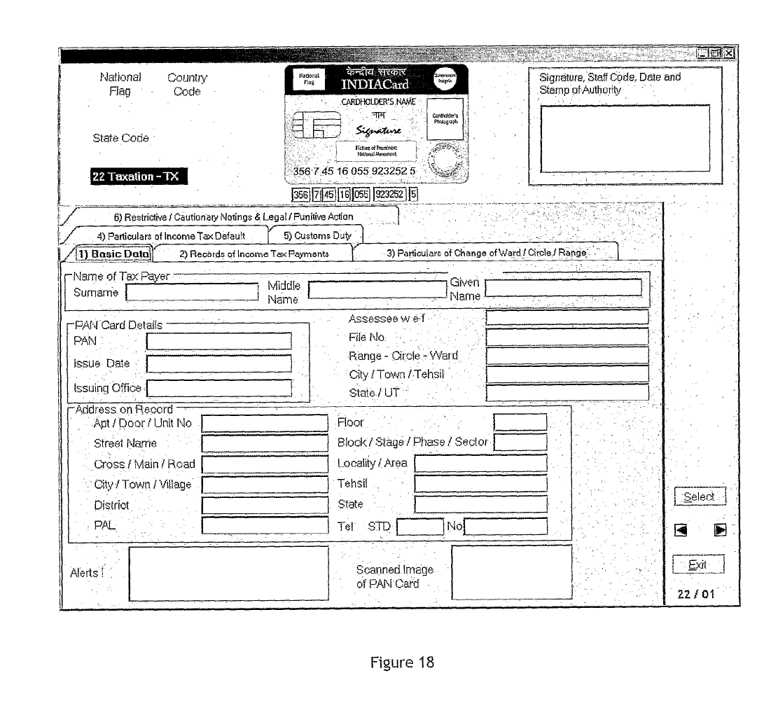

FIG. 18 illustrates the design, content, inter-linkage, functionality and configuration of specially designed and developed Tabs to store Direct Taxation Data of Citizens which is displayed when the data embedded in the chip on the card is called up for review, according to the present invention. The sub-Tabs thereof contain further elaboration of the configurations and arrangements designed for systematically classifying, storing and accessing data of each Citizen appurtenant to said main Tab.

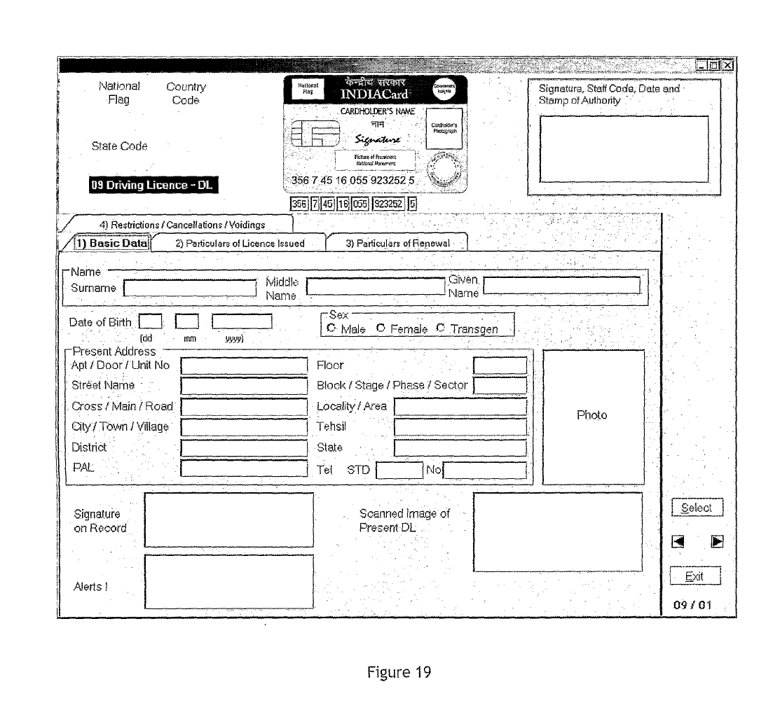

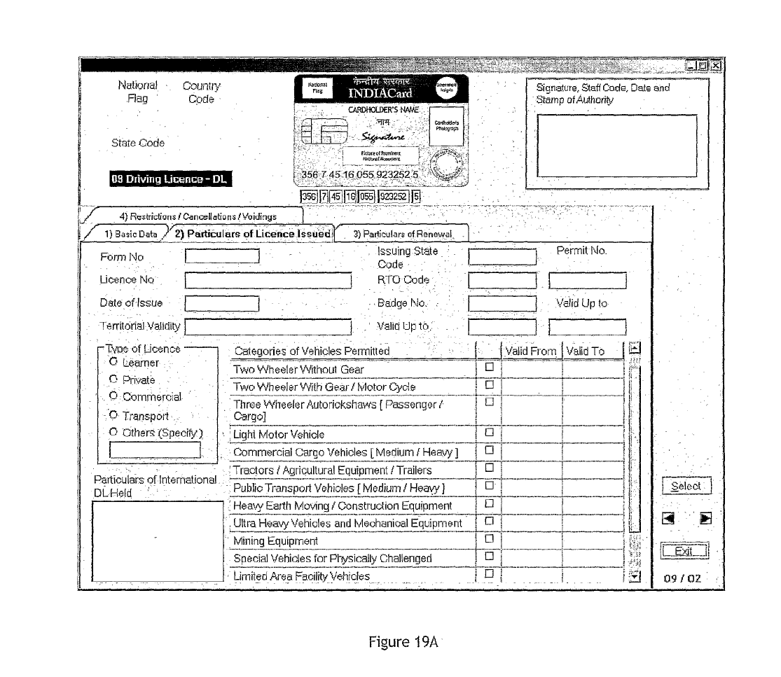

FIGS. 19 and 19A illustrate the design, content, inter-linkage, functionality and configuration of specially designed and developed Tabs to store Driving Licence Data of Citizens which is displayed when the data embedded in the chip on the card is called up for review, according to the present invention. The sub-Tabs thereof contain further elaboration of the configurations and arrangements designed for systematically classifying, storing and accessing data of each Citizen appurtenant to said main Tab.

FIG. 20 illustrates the design, content, inter-linkage, functionality and configuration of specially designed and developed Tabs to store Electoral Data of Citizens which is displayed when the data embedded in the chip on the card is called up for review, according to the present invention. The sub-Tabs thereof contain further elaboration of the configurations and arrangements designed for systematically classifying, storing and accessing data of each Citizen appurtenant to said main Tab.

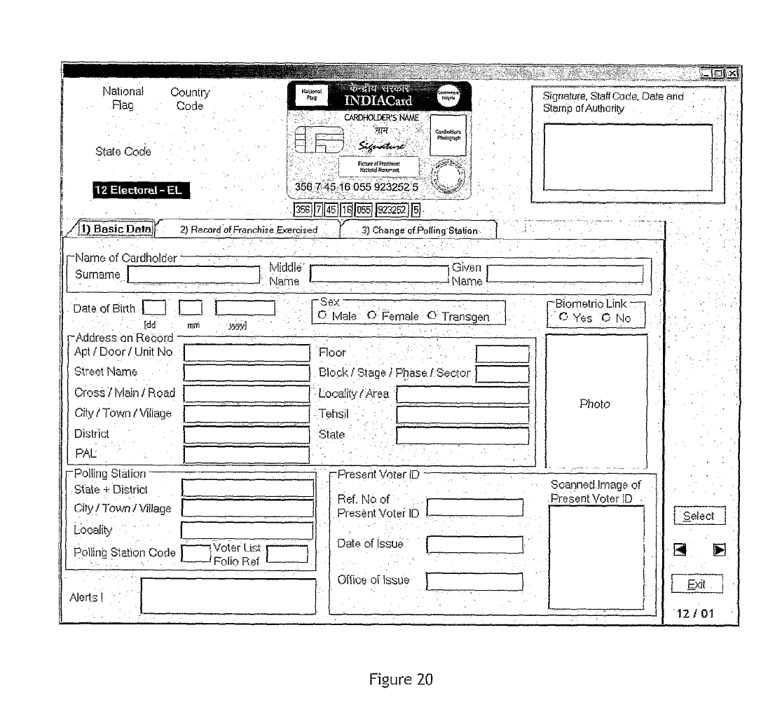

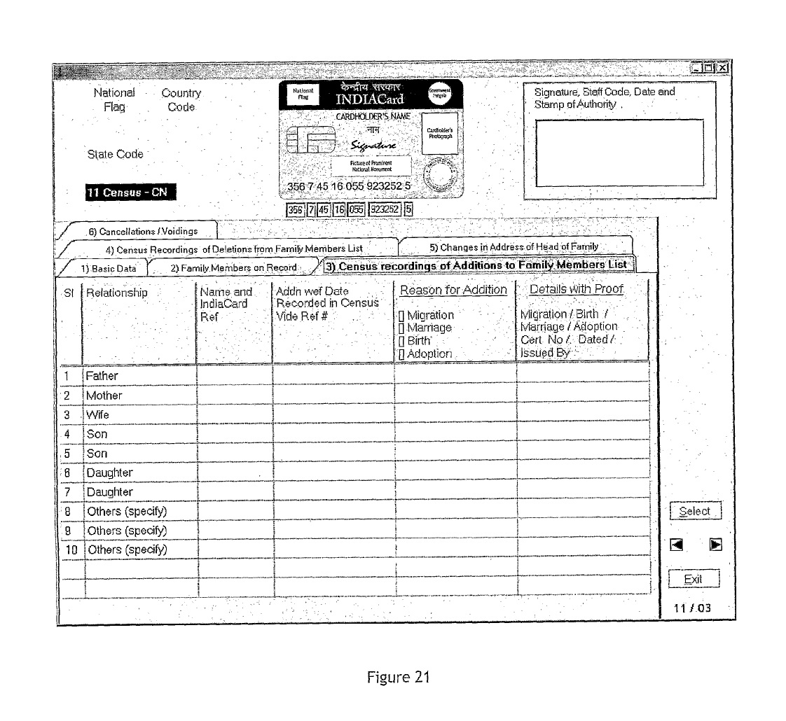

FIG. 21 illustrates the design, content, inter-linkage, functionality and configuration of specially designed and developed Tabs to store Census Data of Citizens which is displayed when the data embedded in the chip on the card is called up for review, according to the present invention. The sub-Tabs thereof contain further elaboration of the configurations and arrangements designed for systematically classifying, storing and accessing data of each Citizen appurtenant to said main Tab.

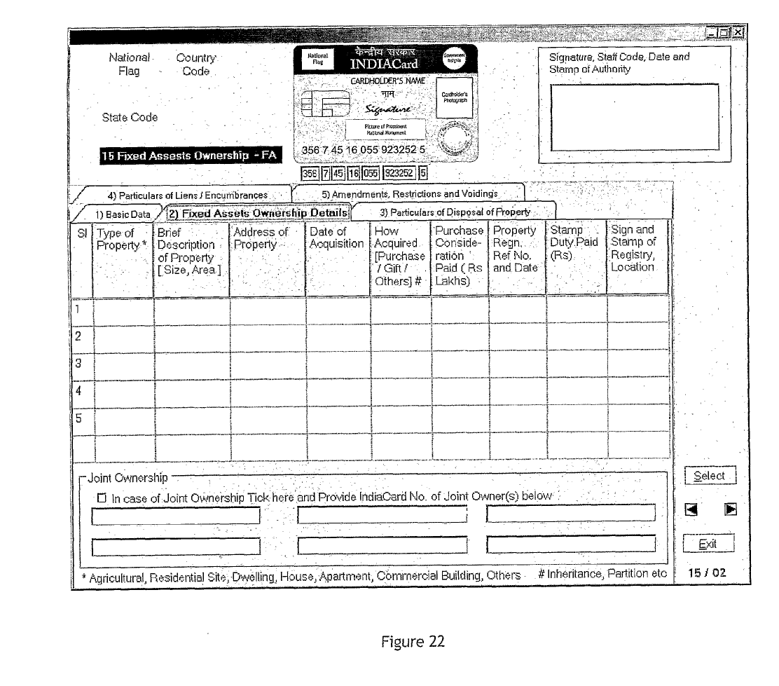

FIG. 22 illustrates the design, content, inter-linkage, functionality and configuration of specially designed and developed Tabs to store Fixed Assets Ownership Data of Citizens which is displayed when the data embedded in the chip on the card is called up for review, according to the present invention. The sub-Tabs thereof contain further elaboration of the configurations and arrangements designed for systematically classifying, storing and accessing data of each Citizen appurtenant to said main Tab.

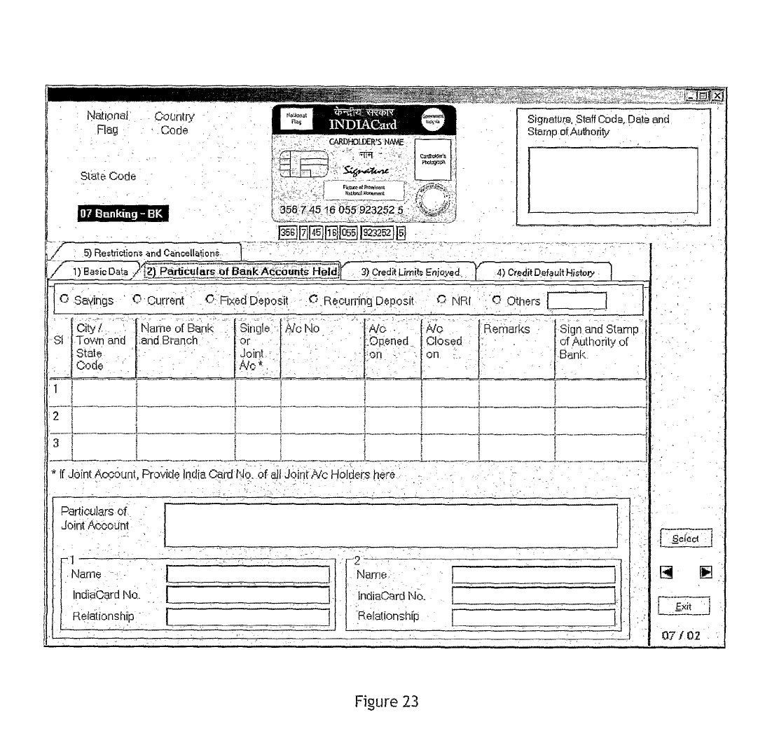

FIG. 23 illustrates the design, content, inter-linkage, functionality and configuration of specially designed and developed Tabs to store Banking Data of Citizens which is displayed when the data embedded in the chip on the card is called up for review, according to the present invention. The sub-Tabs thereof contain further elaboration of the configurations and arrangements designed for systematically classifying, storing and accessing data of each Citizen appurtenant to said main Tab.

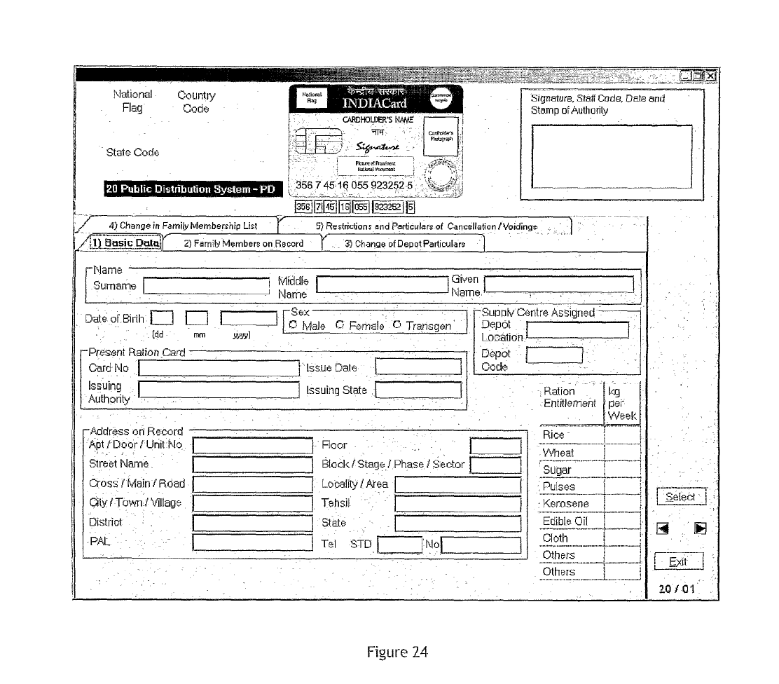

FIG. 24 illustrates the design, content, inter-linkage, functionality and configuration of specially designed and developed Tabs to store Public Distribution System Data of Citizens which is displayed when the data embedded in the chip on the card is called up for review, according to the present invention. The sub-Tabs thereof contain further elaboration of the configurations and arrangements designed for systematically classifying, storing and accessing data of each Citizen appurtenant to said main Tab.

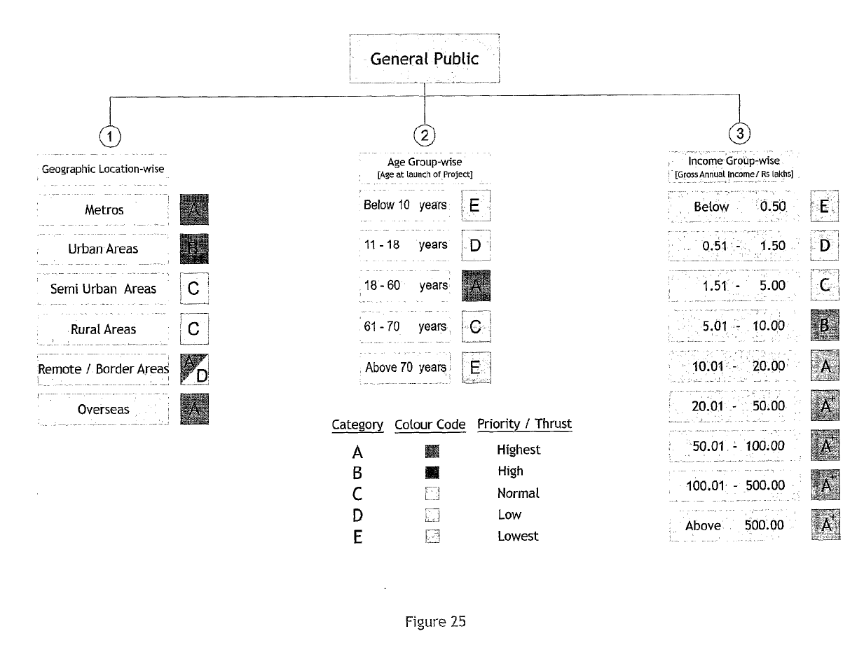

FIG. 25 illustrates the Population Coverage Priority Classification for National Citizen ID Card Project implementation on a countrywide basis, showing the focus and thrust for optimum coverage of population based on three criteria viz., geographic location-wise, age group-wise and income group-wise.

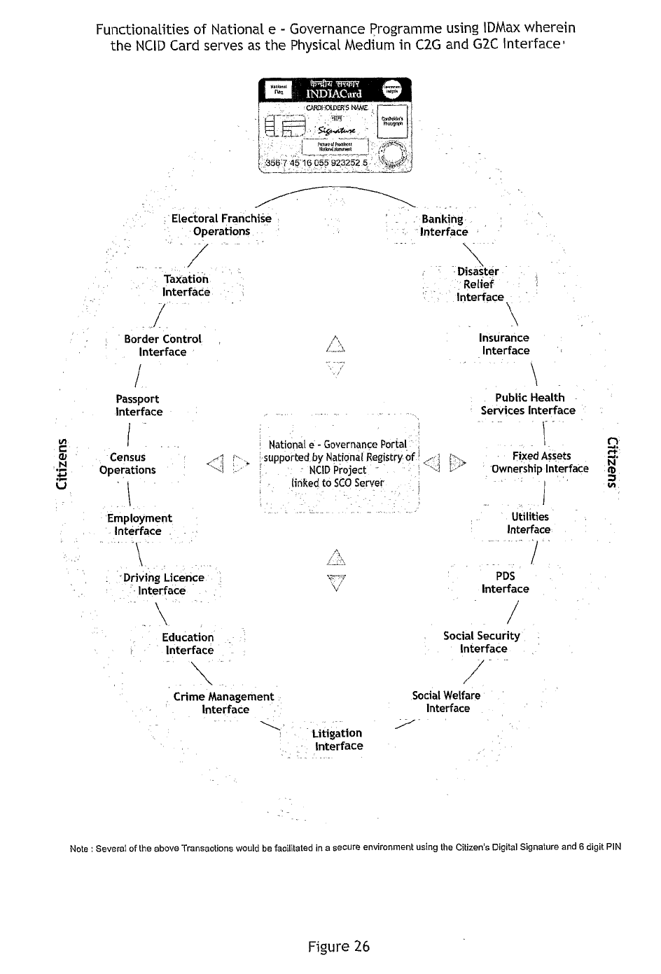

FIG. 26 illustrates the schematic of national-e-Governance Programme using the IDMax® wherein the NCID Card is a tool to achieve the programme objectives on a countrywide basis, showing the distinct areas of citizen-to-government and government-to-citizen interfaces operating under e-Governance with optimum coverage of population.

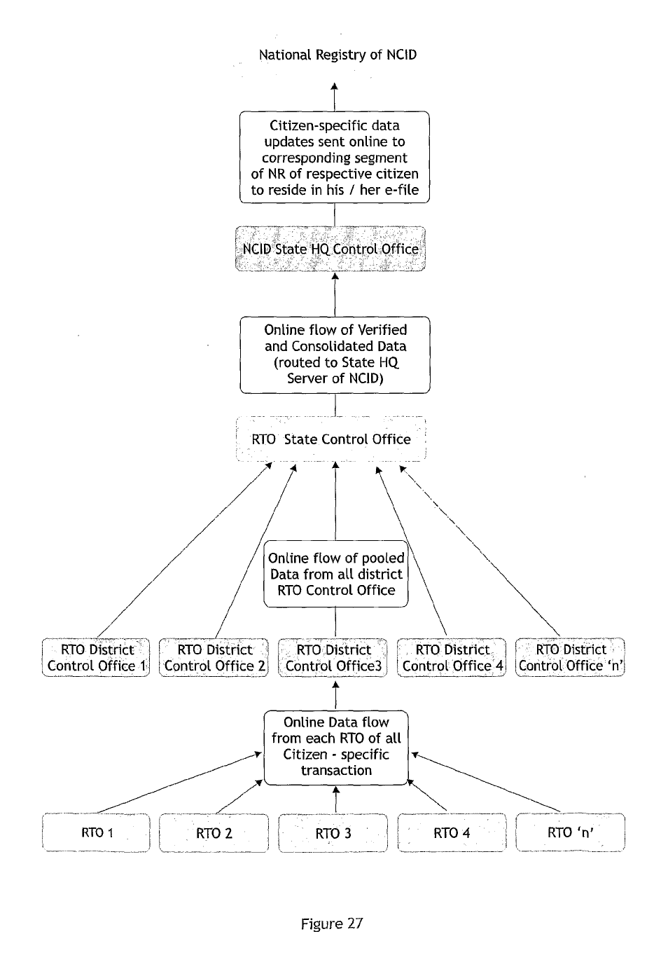

FIG. 27 illustrates the Context Diagram showing Schematic of Dataflow from RTO's to Citizens' e-File in National Registry, which is representative of the flow of key citizen-centric data from various government departments and other NCID Project-related agencies to the concerned segment of the Citizens e-File in the National Registry, through official channels as defined by government authorities.

The scanned images of existing ID and other cards/registration certificates held by each citizen are ported to the respective segments of the national registry as well as the smart card, and available for call-up and verification by concerned authorities at any time—whether at defined office locations or in mobile applications—since the instant invention is also designed for offline application of the ID card, and consequently, for instant verification of the contents thereof from any location.

By the above procedure, the instant invention creates a circumstance whereby unfailing compliance for enrolment is facilitated through the above method which follows an approach of suasive compulsion, since regulatory mechanism prescribes mandatory provision of new ID Card (or in some cases the new ID Number) as described in FIGS. 10A to 10D, as and with effect from the cut-off date fixed by law. Apart from this, the non production of the new ID Card/Number when demanded by authorities would itself constitute a cognizable offence attracting serious punishment.

The said approach followed by the instant invention reflects a high level of efficiency, safety, economy and convenience to Government in the process of creating a national identity system which preponderates all existing and known methods of citizen enrolment and retro cross-referencing their relevant information as contained in existing data basis held by various central, state and local government agencies/departments.

By this method, no effort or investment of resource is required on the part of various government departments and agencies to direct citizens to enrol themselves under the new citizen ID programme or to transmit data from their existing data bases to the designated national citizen ID authority for purposes of providing the latter with a database from which they would proceed to issue the new unique ID numbers to respective citizens. By obviating such major steps, the instant invention enables governments both at central and state level to save very significant amounts of money and deployment of state machinery which would otherwise be spent through alternative approach(es) that would be ridden with high costs, not to mention the redundancy of multiple efforts by different agencies to achieve the same single objective of granting a new, unique ID reference to all citizens.

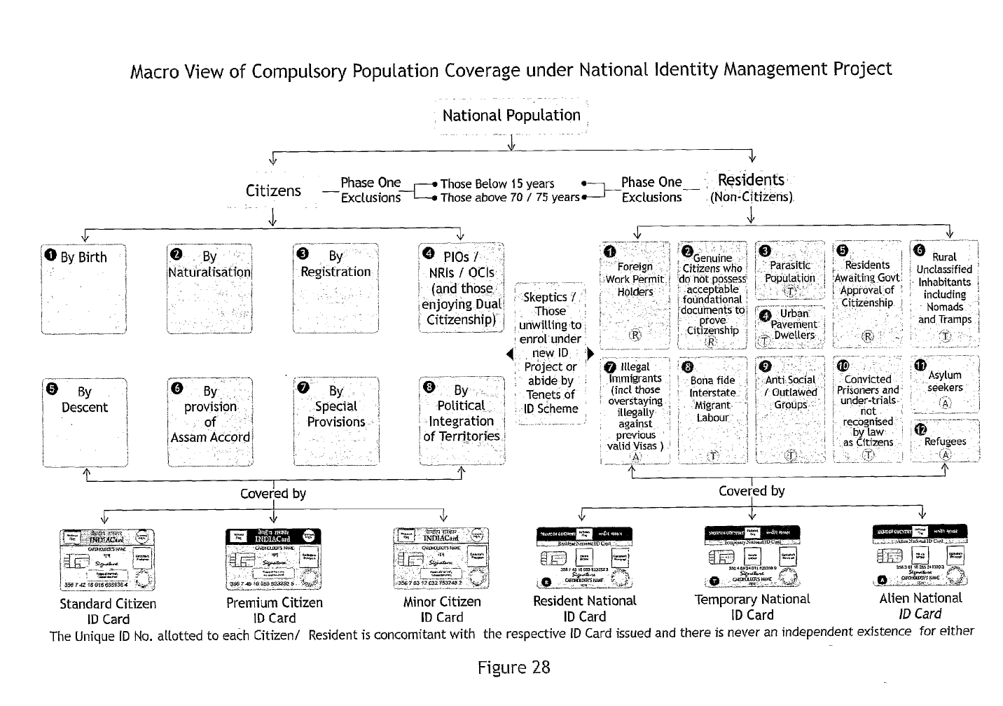

Since all people residing in the country cannot be issued a national citizen ID card on account of their not being eligible to receive the same, the instant invention offers a novel, viable and pioneering solution for identity management of such populace, whereby according to the instant invention three new types of identity cards are issued respectively to the following categories of people residing in the country and collectively categorized as non-citizens, and its application as illustrated in FIG. 28:
1. Foreign Work/Residence Permit Holders
2. Genuine Citizens who do not possess acceptable foundational documents to prove Citizenship
3. Parasitic Population
4. Urban Pavement Dwellers and Unclassified Inhabitants
5. Residents Awaiting Govt Approval of Citizenship
6. Rural Unclassified Inhabitants including Nomads and Tramps
7. Illegal immigrants (including those overstaying illegally against previously valid visas or work/residence permits)
8. Bona fide inter-State Migrant Labour
9. Anti Social/Outlawed Groups
10. Convicted Prisoners and under-trials not recognized by law as Citizens
11. Asylum seekers
12. Refugees

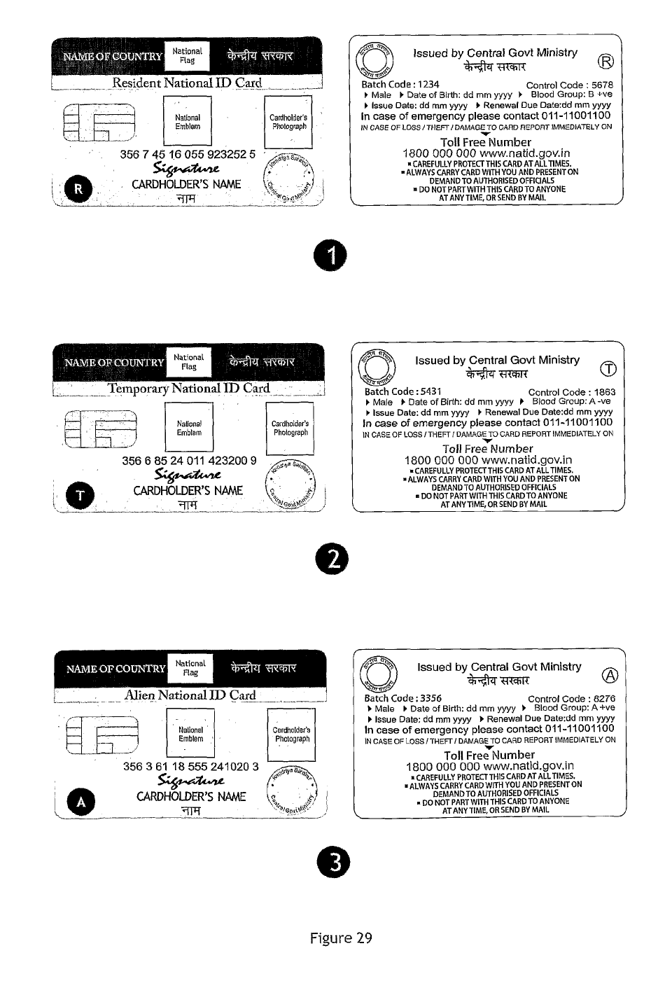

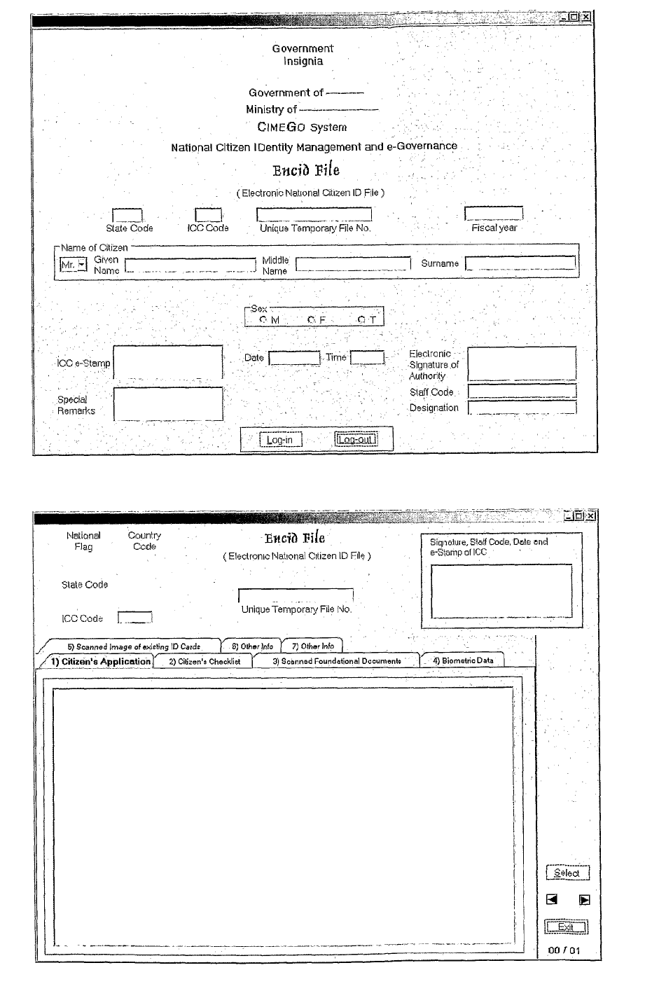

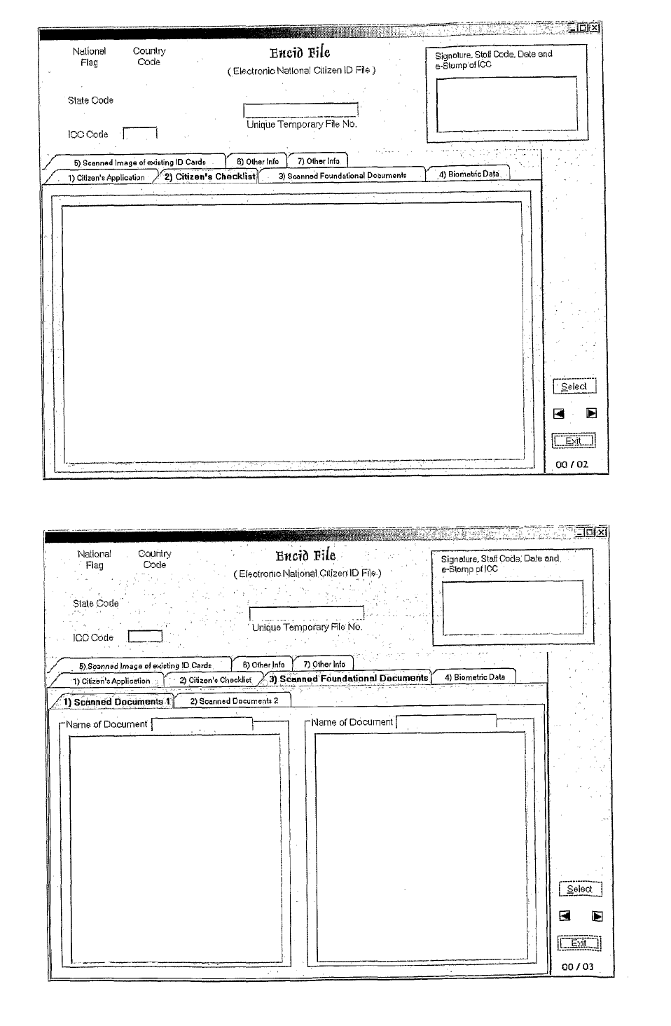

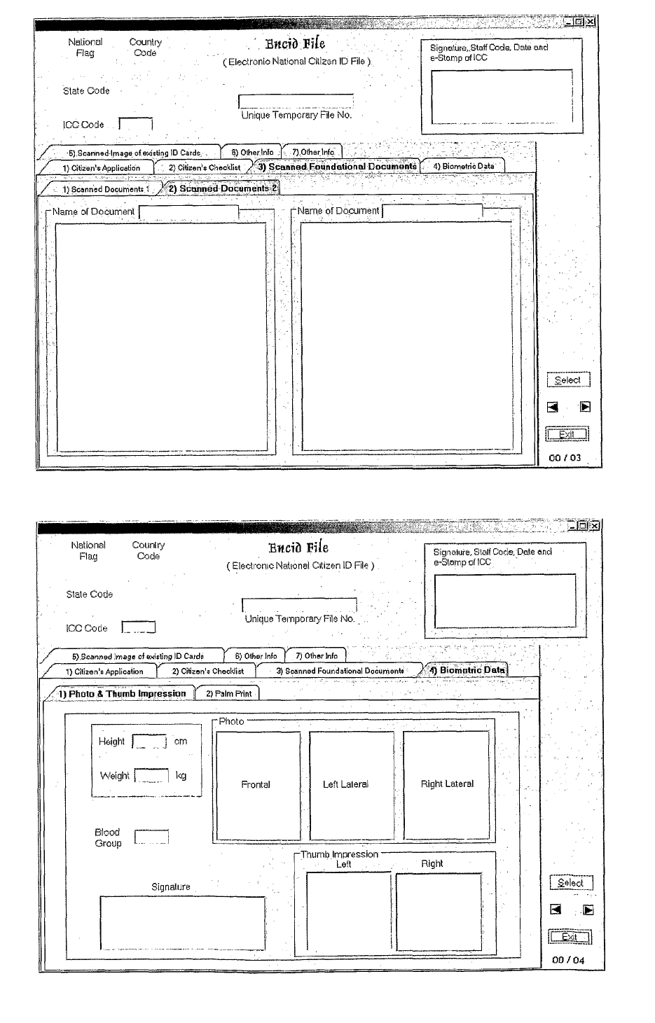

According to the instant invention, all the above categories of people would receive one of the following three types of identity cards forming part of the instant invention, as illustrated in FIG. 29. The application thereof is as illustrated in FIG. 28.
1. Resident National ID Card which is shown as item 1 in FIG. 29 and symbolised by the letter R, which is issued to residents in Categories 1, 2, 5 above vide para 22.
2. Temporary National ID Card which is shown as item 2 in FIG. 29 and symbolised by the letter T, which is issued to residents in Categories 3, 4, 6, 8, 9, 10 above vide para 22.
3. Alien National ID Card which is shown as item 3 in FIG. 29 and symbolised by the letter A, which is issued to residents in Categories 7, 11, 12 above vide para 22.

By virtue of the novelty of design and in-built application and functionalities of the said invention, the national citizen ID card is capable of being used as a tool to achieve the objectives and goals of Vision 2020 set for the country which visualizes the nation achieving and occupying a pre-eminent position in the global economy with clearly defined, measurable levels of economic and social attainment as well as quality of governance and compliance by citizens of laid down national and state laws.

In terms of the instant invention, the activities of citizens are channelized to achieve said national goals and objectives by utilizing the specially designed functionality of the new ID card to sub-serve said goals and direct all micro and macro actions of citizens and therefore of government to attain fulfilment of said goals and objectives. In other words, the new ID card represented by the instant invention facilitates much more than mere identity management—it paves the way for national development and attaining economic prosperity and social harmony through a well-regulated and balanced governance enabled by the said pioneering invention which acts as a constant regulatory tool in this behalf.

In order to provide a reliable means of identifying residents in India who are not Indian citizens, an alternative type of ID card known as Resident ID Card offered in three variants, is herein described. This novel product provides reliable proof of identity of the person to whom it is issued, by virtue of being resident in India. However, it does not bestow the rights of citizenship on such persons as such, and therefore, he/she will not qualify to receive the National Citizen ID Card, since his/her citizenship cannot be established* for the time being owing to their inability to provide acceptable foundation documents such as proof of address, proof of age, proof of domicile, etc. (*This does not apply to foreign nationals working in India on valid work permits/visas.)

The 18-digit harmonized resident numbers (HRNs) for each resident is specially designed to comprise various distinct identifier groups. This unique ID number for residents is composed of distinct identifier groups which, when juxtaposed, ensures that only one unique resident ID number is located to each person, which serves as the key primary identifier number for such person throughout the period of validity of the said ID card.

### Example

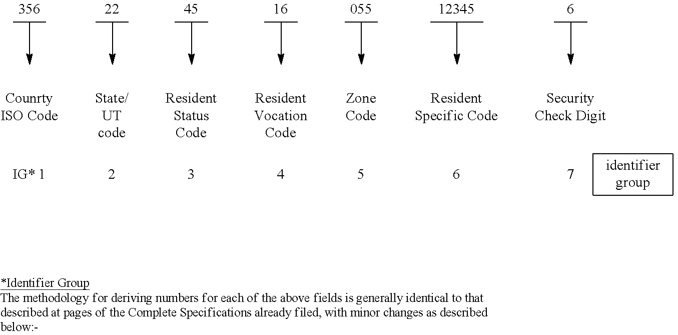

Identifier Group 1 consists of 3-digit ISO Country code, Identifier Group 2 consists of 2-digit State/UT Code, Identifier Group 3 consists of 2-digit Resident Status Code (derived as per details shown in para 32 above), Identifier Group 4 consists of 2-digit Resident Vocation Code (as per description contained at pages 47 to 50 of Complete Specifications, with exclusion of sl nos. 1 to 20, 29, 30, 31 thereof), Identifier Group 5 consists of 3-digit issuing Zone Code, Identifier Group 6 consists of 5-digit Resident Specific Code and Identifier Group 7 consists of 1-digit Security Check digit at the end.

This number system, in addition to creating a unique identification number for each resident, additionally facilitates efficient administrative control as well as rapid analysis and review of a wide range of matters relating to various facets of such residents including observing and recording their migratory and socio economic conduct.

According to the instant invention, the resident ID card is issued with a limited period of validity, which is variable at the discretion of respective issuing authorities. The objective thereof is to regulate the resident population in accordance with the requirements of Central and respective State/UT Governments in respect of each category/group of residents in specific geographical location.

In addition to the above, the issuance of such residents' cards provides an opportunity for residents to establish their claim as well as the priority date to qualify for citizenship upon fulfilment of various norms and guidelines established by the Central Government in this behalf.

Further, the said invention when implemented in conjunction with stringent border security and control measures, will prevent/assist in identifying illegal immigrants who would not possess a Resident ID card after the cut-off date decided by Government authorities. Accordingly, non-possession of such resident ID card would provide an immediate legal basis to deport all such illegal residents. In effect, the deployment of the resident's ID card as herein described will create serious barriers for entry of illegal immigrants in future.

The data segments in respect of the resident ID card would hold and include core personal and family data, biometric data, cardholder status data, vocation data, education data, scanned images or existing ID/registration documents held, electoral data, asset ownership data, crime data, card history data, BPL data, PDS data and system files.

The usage and application for which the three variants of the National ID Card would be valid includes one or more of the following:
1. Foundational basis for staking claim to Indian citizenship under Government of India norms and prescribed guidelines.
2. To confirm type of holder's residence permit in India as and when effect from a date entered on the card based on verification made by authorities.
3. To stake claim for BPL card if not owned so far.
4. To stake claim for Voter ID card if not owned so far.
5. To stake claim for allotment of low cost housing under new projects of Government of India/respective States/UTs.
6. To stake claim for PDS card if not already issued.
7. To establish priority date to receive various benefits from Government agencies and for statutory procedures.

### IDMax®—Technical Description and Principal Functionalities

IDMax® is an integral part of the instant invention and embodies an advanced software package specifically designed and developed to drive the Cimego System®, wherein is enabled live and form-based data capturing meant for creation of database in National Registry, for issuance and administration of NCID Card and implementing and overseeing e-Governance initiatives, having been developed on a Service Oriented Architecture (SOA), designed to serve large installations in nationwide implementation, affording greater flexibility and being more adaptable than the traditional client server software, and easy customisation to suit specific user needs.

### Key Features of IDMax®

IDMax® is a web-based online solution which can also perform all data capture activities offline, wherein is included the software to support various peripheral devices including digital cameras, live finger-print scanner, electronic signature pad, iris scanner, advanced DNA mapping equipment, etc., and wherein the architecture facilitates seamless integration with other legacy systems.

IDMax® is configurable for an unlimited number of services and operates over distributed workstations as well as on a single data capture workstation.

IDMax® performs ‘Live Data Capture’ of citizens' biometrics according to the NCID specifications, facilitated by quality assurance processes to ensure the usage of the biometrics for electronic authentication and verification.

IDMax® stores all the data of applicants in its own repository at enrolment station, from where they can be ported onto National Registry and also transmitted to the issuance authorities for production and personalisation of citizen ID card.

IDMax® is designed and developed for a multi-server and multi-workstation environment and hence can be deployed on various system architecture designs, ranging from one workstation to a country-wide installation of hundreds of networked workstations.

IDMax® architecture provides a solution based on web services/XML messages, easy to extend and integrate with, aligned with the rest of the industry standards on matters like data encrypting and security policies.

### Enrolment Station Configuration

The Enrolment Configuration consists of IDMax® Local Server which holds the application server for the attached Enrolment Stations which perform the live data capture of all images and textual data. There is also a Supervisor Station that deals with all exceptions that occur during enrolment that cannot be handled by the enrolment operators. The Supervisor Station here serves also as the required backup station during need.

### Enrolment Station

Citizen Application Forms are collected and entered into system and subsequent cropping of a photo or signature can be performed. The applicant affixes his/her signature on the Signature Pad which captures and stores his digital signature. The Digital Camera records and stores live colour digital photographs of the applicant simultaneously in three views: front, left lateral and right lateral. The Finger Scanner captures the images of all fingers of the applicant and the Data Capture Workstation supports all the peripheral devices and communicates the data with the application server. Similarly other biometric data are collected here with respective equipment connected to these systems.

### IDMax® Local Server at Enrolment Station

The Server at Enrolment station is the central component of any IDMax® Software installation. Its main task is to service the client applications implementing the business logic through a Service Layer. It acts as the central point for data management and distribution, and it implements logic to take care of versioning and synchronization of the data. It is also the access point to the central database i.e., National Registry, and the application clients always go this route for extra manageability and to be able to audit who, when and from where the data is accessed.

This Server can scale vertically, running multiple application servers on a single machine, or horizontally, where the application is seamlessly distributed between different machines on cluster or over the network. Also, it is possible to design a network of local servers on site working in a collaborative fashion with the central server.

### IDMax® Data Management

The data storage and distribution within the NCID System will be guided by the following principles:
All information of the Enrolment System is stored in the Local repository at the site.
Data, relevant for the daily work of local sites, will be copied and distributed. New Function or system configuration updates shall be distributed in the same way.
Data distribution from the Central repository to the Enrolment Offices is done periodically in a batch mode or online depending on the importance of the data.
Data, captured at Enrolment Stations, will be directly sent or periodically sent to the next level i.e., to Zonal Offices
With respect to performance, each local site will be able to work autonomously, only using their local databases.
All data stored together are considered as a distributed database in the sense of a database system. There will be global multi-database transactions, supported by the database management system.

Data is distributed in such a way that all data necessary to a level that each Enrolment Station works offline as well. Data will be held centrally as much as possible but will cater for offline storage in case of a network breakdown.

### IDMax®Capture

IDMax®Capture is the main operational application. Its task is to capture and assure the quality of all data of an applicant that requests a certain service. IDMax®Capture is service oriented which means that based on a definable service the necessary modules are being loaded and executed. Modules within IDMax®Capture are software agents that perform a dedicated task within the overall transaction of capturing data of an applicant.

Those main tasks of data capture are performed by modules which are arranged in a certain default workflow. IDMax®Capture communicates with the application server who in turn can perform compressions, extractions and other manipulations of the captured data and saves the formatted data either in a local database or sends the data to a connected register or legacy database.

### Start-Up & Shutdown

The IDMax®Capture Application runs a start-up sequence in which the client connects to the application server and authenticates itself to the server. Data items are loaded, peripherals initialized and the check-in module is started. Now applicants can be served until IDMax®Capture is shut down. Upon shutdown IDMax®Capture executes a shutdown sequence in which it can perform certain tasks or a module, disconnects itself from the application server and finally closes.

Updations to the National Registry will occur online periodically via data transmitted by various project operating agencies using the IDMax® standard formats via secure data transmission mode.

### Interoperability Framework Aided by IDMax®

Interoperability is the facile interaction of electronic data relating to diverse systems with minimal additional effort by organisations involved in such transfer. It is the ability of a given macrosystem to efficiently exchange data and seamlessly interface information from databases of citizens, service providers and public administration bodies.

Here, the network acts as a single computer, facilitated by IDMax®, built on service oriented architecture (SOA) which is at the core of all operations. IDMax® plays a key role in adoption of common standard framework across all platforms, with utmost facility and flexibility.

The Interoperability Framework minimises technology incompatibility, by effective handling of data interchange, instead of dealing with islands of heterogeneous information. Diverse and distributed working groups are bound to adopt diverse standards of data that result in larger issues for interoperability than the technology alone. These obstacles are overcome with the proper understanding and implementation of interoperability framework.

The interoperability framework ensures the overall compatibility of processes in relation to technical policies, standards and guidelines, and management processes for achieving interoperability and coherence of information systems across multitude of platforms. It contains descriptions and recommendations of selected processes, standards, technologies and protocols, which serve as the underlying basis for designing and implementing e-governance applications.

The primary objective of e-Governance is to provide citizen-centric, comprehensive government and allied services. However, within this objective the goals should be to attain improved quality of services, enhanced operational efficiency and greater cost effectiveness. IDMax® provides a single interface for comprehensive services, enabling seamless exchange of information across diverse and distributed platforms in a secure manner, facilitating interoperability on a pan-project basis, with a high degree of reliability and effectiveness.

### Advantages of IDMax® in Interoperability Framework:

Easy and comprehensive access to all public services.
Single access to avail services and, thus, reduce effort in dealing with different government bodies/agencies.
Enables better and more efficient management of e-governance services by reducing redundancies and overlaps.
Helps government and private agencies to work closely in a digital world.
Makes systems, knowledge and experience reusable from one agency to another, to enhance effectiveness, efficiency, flexibility, and transparency.

### IDMax®Secure

Data Security, also known as information security, plays a critical role in the NCID project. Citizens' data captured and stored in the local database and transmitted over the Internet must be protected against theft, pilferage, loss etc, apart from unauthorized access, disclosure, disruption, modification, or destruction. The confidentiality, integrity and reliable availability of data have to be maintained, regardless of the form of the data, in order to ensure foolproof functioning of e-governance system. IDMax® ensures utmost confidentiality, integrity and availability of data, with state-of-the-art proprietary built-in security features. IDMax® has been developed taking into consideration, three critical components, hardware, software and communications with the purpose of identifying and applying information security industry standards, as mechanisms of protection and prevention, at three levels: physical, personal and organizational. Procedures, policies are implemented to train administrators, users etc, on how to use products to ensure data security within, and across the implementing agencies.

Data Security with IDMax®.

By deploying IDMax®, stringent data security measures are inbuilt right from the stage of initializing the enrolment process at ICCs to the stage of eventual long term data storage in the NR, with various levels of physical and computer security measures, including firewalls, data encryption and usage of specialised software programmes which altogether preclude unauthorised copying, data transfer, data diversion and data manipulation. IDMax® allows transmission of data only through PKI which includes Digital Signature, Digital Certificate, Secure Socket Layers, etc.

IDMax® has several control features/information security policies that are built in to its architecture to ensure data security:
1. Secure network protocols that authorise only identified users to access data
2. Deployment of software that allows only known secure applications within the system
3. Automatic updations of Vulnerability Management Programmes, within the system and related key thrust areas, since public networks are also part of transmission of data
4. Tracks and monitors all access to data in ICCs and NR including network resources
5. Regular testing of all systems and processes

IDMax® employs highest levels of Data Security during storage, transmission, and retrieval with many access control layers specifically deployed that allow access to only bona fide users with specific authorisation.

### ADVANTAGES OF THE PRESENT INVENTION

The instant invention embodies the following benefits, novelties, utilities, value-in-use and very significant, sustained and tangible benefits as a result of its many original, unique and unprecedented proprietary concepts, features, know-how and methodology to provide a singular, comprehensive national level identity management solution inclusive of e-Governance functionalities, capable of performing when implemented on any scale.

The present invention provides a smart card based identity management system for citizens and forms excellent basis to usher e-Governance programmes, as it is directly linked to a National Registry which contains all relevant particulars of each citizen. This card is designed to replace all other ID cards, resulting in enormous savings to governments of administrative and financial resources. It eliminates present instances of forgery/duplication being witnessed in PAN cards, voter ID cards etc. It ensures effective national administration without infringing on citizen's privacy, by virtue of offering true, multi-function capabilities, regardless of internal/external geographic boundaries or language barriers. It serves as a regional passport for travel between neighbouring countries. It curbs tax evasion, insurgency and economic crimes. For example, when hot lists are circulated to law enforcement agencies and emigration points, automatic alerts are activated when specified card is deployed anywhere in the country, resulting in instant detection of wanted persons or serious economic offenders and anti-social elements. It serves as a reliable basis for delivering social benefits and welfare measures by various Government departments and private agencies. It is found useful in border areas and sensitive zones to check illegal immigration, insurgency and underground activity. The card can also be deactivated to deny the economic offenders and delinquent citizens for accessing socio-economic services. The instant invention when deployed as a national level programme fosters economic discipline among citizens, improves distribution of fruits of economic growth to all sections of society, and facilitates efficient governance of the populace by various government and concerned non-government agencies, significantly improves operational efficiency of governments at national and regional levels—in a manner that preponderates all known practices in this behalf.

The references of patent applications filed by the same inventor in the related field of technology are titled as
(1) System and Method of Integrated IDentity Management and e-Governance of Armed Forces Personnel
(2) System and Method of Integrated IDentity Management and e-Governance of Police Personnel
(3) System and Method of Integrated e-Governance and IDentity Management of Government Employees

I claim:

1. A System of Integrated National Citizen Identity Management and e-Governance comprising:
A centralised National Registry containing key data of all citizens including minors enrolled under the National Citizen ID Project functioning as the foundation of national citizen identity manage-ment and e-Governance
A Card
front portion of said card is printed with ID Card name, citizen name, photograph, signature, unique citizen ID number, various security elements including inscribed hologram of issuing authority, distinctive colour panel at the upper portion of the Card to indicate key types of card issuance, and embedded with a memory chip
back portion of said card is printed with issuing authority name and seal, alpha code for type of card, batch code and control code of card issuance; citizen's sex, date of birth, blood group; date of card issue, card renewal due date; emergency contact details of card holder; toll-free helpline reference; basic instructions to card holder
wherein citizen-specific data is securely stored on the National Registry in specially designed formats and layouts, and ported to the memory chip of the citizen ID Card relating to core personal data, biometric data, digital signature, card holder status, education, vocation, banking, credit card, driving license, passport, census, electoral, social security, medical and insurance, fixed assets ownership, moveable assets ownership, business ownership, government interface, key services utilisation, public distribution system, key membership, taxation, major travel, special achievements, principal events, linkage to related Indiacards, IndiaCard® history, litigation data, crime data, other data, additional segments for future use, system files,—all these segments being appurtenant to the Premium Card; and number of segments commensurately abridged for the Standard ID Card and the Minor's ID Card respectively—said card on operation via specially calibrated card reader units will display on terminal the required information as stored in well-defined segments thereon ported from the National Registry—and periodically updated—when accessed by duly authorised personnel.
An e-Governance System with comprehensive nationwide citizen-to-government and government-to-citizen interface using the centralised electronic database comprised in the National Registry referred above, wherein the arrangement and storage of citizens' data serves as the platform which enables governments to seamlessly implement said e-Governance programmes using public key infrastructure and digital signature with full-scale inter-operability, said citizen ID Card functioning as an instrument to achieve the objectives of e-Governance.

2. The National Citizen Identity Management and e-Governance System as claimed in claim 1, wherein said card is produced using polycarbonate or polyvinylchloride acetate base with other specially formulated additives, and laminated with layers of protective film.

3. The National Citizen Identity Management and e-Governance System as claimed in claim 1, wherein said system provides Governments a reliable and efficient mechanism for interface with its citizens for e-governance, ensuring effective administrative capability and the means to oversee compliance with laid-down laws and national policies, to reach welfare measures to the entire populace, and to establish stringent levels of internal security and border control.

4. The National Citizen Identity Management and e-Governance System as claimed in claim 1, wherein the memory chip for the Premium ID Card ranges from 4.0 MB, for the Standard ID Card from 1.0 MB, and for the Minor's ID Card from 1.0 MB respectively, or higher/lower as required.

5. The National Citizen Identity Management and e-Governance System as claimed in claim 1, wherein citizens' biometric data includes signature/LTI (RTI for females), photograph, rolled finger prints, full palm prints, iris scan, DNA mapping and full body profile is enabled.

6. The National Citizen Identity Management and e-Governance System as claimed in claim 1, wherein secure storage of data is facilitated in the National Registry in specially formulated, designed and sequenced formats and layouts for each citizen, relating to
core personal data, biometric data, digital signature, card holder status, education, vocation, banking, driving license, census, electoral, social security, medical and insurance, fixed assets ownership, moveable assets ownership, business ownership, government interface, key services utilisation, public distribution system, principal events, linkage to related IndiaCards, IndiaCard® history, litigation data, crime data, other data, additional segments for future use, system files,
and ported to the Standard ID Card, wherein the memory chip is at least of 1.0 MB or higher/lower as required.

7. The National Citizen Identity Management and e-Governance System as claimed in claim 1, wherein secure storage of data is facilitated in the National Registry in specially formulated, designed and sequenced formats and layouts for each minor citizen, relating to
core personal data, biometric data, digital signature, card holder status, education, banking, driving license, passport, principal events, linkage to related IndiaCards, IndiaCard® history, crime data, other data, additional segments for future use, system files,
and ported to the Minor's ID Card, wherein the memory chip is at least of 1.0 MB or higher/lower as required.

8. The National Citizen Identity Management and e-Governance System as claimed in claim 1, wherein secure storage of data is facilitated in the National Registry in specially formulated, designed and sequenced formats and layouts for each citizen, relating to
core personal data, biometric data, digital signature, card holder status, education, vocation, banking, credit card, driving license, passport, census, electoral, social security, medical and insurance, fixed assets ownership, moveable assets ownership, business ownership, government interface, key services utilisation, public distribution system, key membership, taxation, major travel, special achievements, principal events, linkage to related IndiaCards, IndiaCard® history, litigation data, crime data, other data, additional segments for future use, system files,
and ported to the Premium ID Card, wherein the memory chip is at least of 4.0 MB or higher/lower as required.

9. The National Citizen Identity Management and e-Governance method comprising the steps of:
filing prescribed application form by citizen, containing personal data, supported with foundational documents,
capturing biometric data,
scanning citizen's application form and foundational documents,
creating an e-File for each citizen at the ICC, containing digitized data of all the above viz., personal data, supporting documents and biometric data
uploading the said e-File to the NCID Project Database at the Zonal Control Office (ZCO) from the ICC,
ZCO sending data contained in e-File to various government departments for verification/validation,
ZCO uploading e-File to State Control Office (SCO) of NCID Project for final approval and recommendation to Central Control Office (CCO) for issuance of ID Card to citizen, where the result is positive (where the result on verification is negative, the citizen is given an opportunity to remedy and re-submit his/her application)
SCO accepting the approved e-File for inclusion of citizen's data in National Registry (NR) to create a national database of all citizens,
CCO granting issuance of ID Card to citizen and allocating a unique 18-digit harmonized citizen number (HCN),
novel system of generating HCN comprising scientifically derived key identifier number-groups,
producing the ID Card
effecting card personalization,
fixing a memory chip on the personalized ID card,
porting citizen's data from NR to the memory chip of ID Card
despatching of personalized ID card to citizen by secure post under authorization of SCO on behalf of CCO,
receipt of said card by the citizen with proof of delivery produced to ICC, which transmits confirmation to CCO
activating the card by CCO, remotely and
sending 6-digit PIN to the citizen

10. The National Citizen Identity Management and e-Governance System as claimed in claim 1, wherein total identity management of citizens of a country is enabled regardless of expansive size of population or diversity of geo-location by providing an irrefutable means of proving one's citizenship, nationality and true identity with unfailing reliability.

11. The National Citizen Identity Management and e-Governance System as claimed in claim 1, wherein the unique ID number allotted to each citizen is concomitant with the respective ID Card issued under the relevant laws, and there is never an independent existence for either i.e., the unique ID number itself cannot exist on standalone basis, nor can an ID Card exist without the said unique ID number being imprinted thereon—they can only mutually co-exist.

12. The National Citizen Identity Management and e-Governance System as claimed in claim 1, wherein the unique ID Card allotted to each citizen is designed to be variously deployed in one of four methods, thus: (1) for transactions of citizens which are directly interfaced from originating department's e-governmental server to NCID server; (2) for activities requiring mandatory deployment of the citizen ID card for pre-defined transactions; (3) for citizens' activities requiring compulsory furnishing of their national ID number for certain defined transactions for which the actual deployment of the ID card is not essential; and (4) for activities which require compulsory voluntary event-based disclosure by citizens in respect of each of various defined events.

13. The National Citizen Identity Management and e-Governance System as claimed in claim 1, wherein the entire population of the country coverable under the Nation Citizen Identity Management Scheme is systematically and compulsorily covered following a master plan which comprises distinct identity solutions for the two principal and distinct Groups viz., (a) Citizens and (b) Non-Citizens, showing classification of persons under each Group as well as the three types of visually distinguishable Identity Cards for each Group, viz., (1) Standard National Citizen ID Card, (2) Premium National Citizen ID Card; and (3) Minor National Citizen ID Card, respectively for the three principal groups of Citizens; and in the case of non-Citizens thus:
(1) Resident National ID Card; (2) Temporary National ID Card; and (3) Alien National ID Card.

14. The National Citizen Identity Management and e-Governance System as claimed in claim 1, wherein the unique ID Card allotted to each citizen originates in the collection of primary input data of each citizen in an ENCID File, which is generated and assigned a unique ICC-centric number individually for each citizen at the time of enrolment to the national ID Project at the IndiaCard Centre, and to which is uploaded basic particulars of the citizen, various biometric data of the citizen, scanned images of the citizen's application form and checklist, foundational documents furnished by the citizen in supporting his (her) application, as well as all presently held ID and other cards/registration certificates, which are respectively stored on each of the relative Tabs provided therein.

15. The National Citizen Identity Management and e-Governance System as claimed in claim 1, wherein enrolment of citizens to the National Citizen ID Card Scheme is facilitated at specially designed Centres countrywide. The layout of the National Citizen ID Enrolment and Services Facility—herein referred to as “India Card Centre” (ICC) further elaborated by the design of four layout options respectively for (1) Metro Facility (including Category “A” Cities); (2) Advanced Biometric Capture Facility; (3) Standard Facility for Urban Areas including Category “B”, “C” and “D” Cities/Towns; and (4) Rural Facility, and the functioning of each of said ICCs reflects optimum efficiency in servicing the needs of citizens—both during enrolment and post project implementation, maintaining high degree of operational control and process automation.

16. The National Citizen Identity Management and e-Governance System as claimed in claim 1, wherein the method for implementation of the national citizens' card project is unique and unprecedented owing to the novel approach for citizen enrolment, wherein a single high-security identity card replaces (is not in addition to) all other existing ID and other types of cards and registration certificates issued by various central, state and local authorities, and wherein the said high-security ID card contains distinct segments which hold images/descriptive details of all facets of the citizen such other cards via porting key summary data from existing databases and sourcing scanned images of such cards from citizens themselves during the enrolment process, thereby obviating multiple identity and other cards presently held by certain citizens; and consequently, overcoming variance in citizen's name and other key particulars that may appear differently from one card to another, whether caused accidentally or intentionally—as all cards and registration certificates owned by a citizen and tendered at the time of enrolment to the citizen ID Card programme are scanned and uploaded to the ENCID File as described above, to converge therein. As a result, citizens are automatically barred from providing false/multiple cards they may have acquired clandestinely and hold presently, to the enrolment authorities, as enrolment is completed following a stringent process incorporating biometrics, signature and 3-view photographs of each citizen captured live at the IndiaCard Centre, which are also uploaded to the ENCID File, along with basic particulars of the citizen. Eventually, all such data come to rest in the citizen's e-file at the National Registry as well as reflected on the smart card chip embedded on the Citizen ID Card, according to the present invention.

17. The National Citizen Identity Management and e-Governance System as claimed in claim 1, wherein the unique ID Number allotted to each citizen is valid for the life of the citizen to whom it is allotted, and becomes the permanent reference point for all interaction between the citizen and the government—central, state and local. Thereafter, this unique ID number is transmitted online by the authority issuing the same to all central and state Government departments/agencies, particularly those which have issued the ID and other cards/registration certificates to respective citizen as mentioned above, to create a retro cross-reference record at each such government agency/department of the new unique ID number appurtenant to the respective card originally issued by them, example: voter ID card, driving license, BPL card, PDS card. By this method, all future interaction between the citizen and the said agencies/departments will compulsorily reflect the new citizen unique ID number, as a result of which, all fake/multiple cards in the possession of unscrupulous citizens would be automatically barred from usage for any application, and espective government departments/agencies would thus be able to automatically weed out and rapidly eliminate all spurious cards hitherto clandestinely obtained by unscrupulous citizens.

18. The National Citizen Identity Management and e-Governance System as claimed in claim 1, wherein the most significant and unprecedented benefit of this methodology is that upon completion of retro cross-referencing as described above, the Government authorities would, as and with effect from a designated cut-off date, acquire by means of appropriate national level legislation, the statutory right to confiscate and appropriate all fixed assets as well as bank deposits and current/savings/other accounts (having credit balances) of citizens which remain devoid of cross-referencing with the new ID Number. The inherent and significant resultant benefit to respective government agencies/departments who can no longer be deceived by deployment by fake cards is saving of very large amounts of money.

19. The National Citizen Identity Management and e-Governance System as claimed in claim 1, wherein e-Governance is facilitated covering the entire population of a country with seamless interoperability, upgradeability and scalability.

20. The National Citizen Identity Management and e-Governance System as claimed in claims 1 and 9, wherein the citizen ID number is an 18-digit harmonized citizen number (HCN) unique for each citizen including minors, said single ID number valid for the lifetime of the citizen and serving as the key primary identifier, comprising 7 distinct Identifier Groups of Numbers, thus: Identifier Group 1 consists of 3-digit ISO country code, Identifier Group 2 consists of 1-digit citizen's status code, Identifier Group 3 consists of 2-digit citizen's vocation code, Identifier Group 4 consists of 2-digit issuing State code, Identifier Group 5 consists of 3-digit Issuing Zone code, Identifier Group 6 consists of 6-digit unique citizen-specific code, and Identifier Group 7 consists of 1-digit security check digit at the end.

21. The National Citizen Identity Management and e-Governance System as claimed in claim 1, wherein the generation and allocation of unique, functionally valuable HCN for each citizen including minors is enabled, with the Composition (make-up of seven distinct identifier groups) of Unique Numbering System as shown below, the utility of which surpasses any known system of national citizen identity numbering.

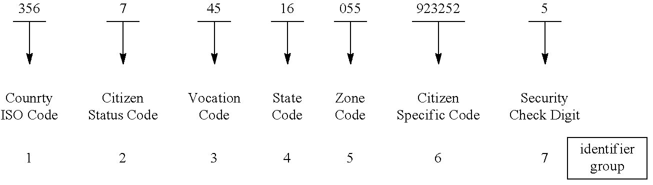

22. The National Citizen Identity Management and e-Governance System as claimed in claims 1 and 13, wherein the unique identity reference for each citizen including minors is valid for all applications, functionalities and references on a countrywide basis replacing the present system in vogue of multiple identity references issued by state and central government authorities thereby virtually precluding identity manipulations and fraud.

23. The National Citizen Identity Management and e-Governance System as claimed in claim 1, wherein the allotment of a one-digit Status Code to all citizens as shown below affords exceptional value in security and macro socio-economic planning and formulation of policies and strategies to achieve national and regional objectives of governments.
Status Code (1 digit)

| Code | Status |
|---|---|
| 1 | VVIP and VIPs |
| 2 | Indian Armed Forces and Para Military Forces |
| 3 | Govt. of India Service [including PSUs and Establishments of |
| | GOI] |
| 4 | National and State/UT Law Enforcement Agencies |
| 5 | State/UT Govt. Service [including PSUs and Establishments of |
| | State Govt] |
| 6 | Ordinary Citizen |
| 7 | NRI/PIO/OCI [including dual citizenship holders, if applicable] |
| 8 | Immigrant Citizen |
| 9 | Reserved for Future Application |
| 0 | Reserved for future Application |

24. The National Citizen Identity Management and e-Governance System as claimed in claim 1, wherein the allotment of a two-digit Vocation Code to all citizens as shown below affords exceptional value in macro socio-economic planning and formulation of policies and strategies and regulatory control to achieve national and regional objectives of governments under e-Governance initiates:
Citizen Vocation Code (2 digits)

| Code | Vocation/Calling |
|---|---|
| 1. | Privileged Posts (President, Governors, CJI) |
| 2. | Union Ministers, MOS and equivalent positions |
| 3. | MPs (RS and LS) |
| 4. | Privileged Central Government Appointments |
| 5. | State Ministers and equivalent positions |
| 6. | Privileged State Government/UT Appointments |
| 7. | MLAs/MLCs |
| 8. | Indian Civil Service |
| 9. | Indian Army |
| 10. | Indian Air Force |
| 11. | Indian Navy |
| 12. | Indian Coast Guard |
| 13. | Para Military Forces |
| 14. | Central/National Police Forces |
| 15. | State Civil Services |
| 16. | State Police Forces |
| 17. | Central Government |
| 18. | State Government/UT |
| 19. | Defence Establishment |
| 20. | R&D/Science Establishment |
| 21. | Telecom Sector |
| 22. | Power and Energy Sector |
| 23. | Industrialist |
| 24. | Engineering Professional |
| 25. | Insurance/Actuaries Sector |
| 26. | Banking/Financial Services Sector |
| 27. | Central PSU |
| 28. | State PSU |
| 29. | Judicial Service |
| 30. | Legal Profession |
| 31. | Political Party Worker/Affiliate |
| 32. | Accounting and Finance |
| 33. | Medical/Nursing/Paramedic/Health Services |
| 34. | Pharmaceutical and Healthcare |
| 35. | Academic and Research/Training |
| 36. | Corporate Director/Professional Director |
| 37. | Corporate Sector |
| 38. | Business and Trading Sector |
| 39. | Aviation Industry |
| 40. | Rail Transportation |
| 41. | Auto & Road Transportation Sector |
| 42. | SME Sector |
| 43. | Technical & Maintenance Services and Trades |
| 44. | Tourism and Travel Related Industry |
| 45. | Logistics, Distribution, Supply Chain, Warehousing Sector |
| 46. | Real Estate and Construction Industry Sector |
| 47. | Metals and Mining Sector |
| 48. | Information Technology Sector |
| 49. | Infrastructure Sector |
| 50. | Oil and Refinery Industry |
| 51. | Industrial and Manufacturing Sector |
| 52. | Hotel and Hospitality Sector |
| 53. | Precious Metals & Stones/Jewellery |
| 54. | Religious Sector |
| 55. | Veterinary Services |
| 56. | Security and Safety |
| 57. | Co-operative Sector |
| 58. | Homemaker |
| 59. | Social Worker/Social Services Sector/NGOs |
| 60. | Consultancy and Advisory Services |
| 61. | Leisure & Entertainment, Fashion |
| 62. | Textile, Clothing & Dress Accessories Sector |
| 63. | Furniture and Interior Designing |
| 64. | Livestock and Poultry |
| 65. | Offshore Services |
| 66. | Landlord |
| 67. | Journalism & Press/Electronic Media |
| 68. | Advertising and Publicity, Event Management |
| 69. | Stock-broking |
| 70. | Sports Sector |
| 71. | EOU/SEZ/FTZ Sector |
| 72. | Factory/Office |
| 73. | Farming/Agro Processing Sector |
| 74. | Self-employed |
| 75. | Self Help Group/Cottage Industry |
| 76. | Personal Care Services |
| 77. | International/National/State Award Winner |
| 78. | Student/Scholar |
| 79. | Apprentice/Tradesman/Intern |
| 80. | Waste Management Sector |
| 81. | Social Services Sector/NGOs |
| 82. | Forestry/Wildlife/Aqua-based |
| 83. | Retail Vendor |
| 84. | Petty Trader |
| 85. | Daily Wage Earner |
| 86. | Miscellaneous |
| 87. | Retired Private Sector Employee |
| 88. | Retired Industrialist/Businessman |
| 89. | Retired Government Employee and Pensioner |
| 90. | Pensioner's Spouse |
| 91. | Social Security Beneficiary |
| 92. | Unemployed |
| 93. | Physically Challenged |
| 94. to 99. | Reserved for assignment in future |

25. The National Citizen Identity Management and e-Governance System as claimed in claim 1, wherein the allotment of a three-digit Zone Code to each zone created as convenient, postal address locator linked administrative zones in each State/UT is based on the geo-location of villages, tehsils, towns, the municipal wards/localities in each city/metro; the geographic territories designated by the defence ministry in respect of forward areas, border regions and special zones under their purview, which affords enhanced administrative control and provides exceptional value in macro socio-economic planning and formulation of policies and strategies to achieve national and regional objectives of governments.

26. The National Citizen Identity Management and e-Governance System as claimed in claim 1, wherein the software design included in the Project deliverables for the ID Project enables management information systems (MIS) to be generated rapidly in respect of all transactions—of a particular citizen/group of citizens across all segments; or of a group of citizens covering any particular segment—originating in relation to citizens registered under a given Zone Code, or given Vocation Code, or given age group, and any other parameter or set of parameters desired, which facilitate ready analysis and quick decision-making by law enforcement agencies/home ministry authorities or other Government Agencies, which in turn provide significant and timely assistance in combating anti-social activities committed/attempted by unscrupulous citizens; also enable generation of “Monitoring Lists” and “Watch Lists” using any set or sets of identifier number groups, by means of the Security Check Digit assigned to the citizen; the citizen Status Code: 0, for instance, which represents immigrant/migrant citizens; or citizens in pre-defined Zone Codes e.g., border areas.

27. The National Citizen Identity Management and e-Governance System as claimed in claims 1 and 17, wherein the three-digit Zone Codes within each State and UT facilitates governments to classify and highlight using colour coding in order of graded intensity, zones which are considered sensitive from inhabitation/security point of view, example, anti-social/naxal/prone/infested areas, high-infiltration zones, porous border areas, terrorist inhabited areas, politically sensitive areas etc, whereby government is rapidly informed to keep watch over select citizens originating from such “Marked Zones”, scrutinise their migratory movements, linkages, vocation patterns and financial (i.e., banking) conduct by examining all transactions relating to the unique ID Card Number of such persons, under proper authorization from concerned authorities.

28. The National Citizen Identity Management and e-Governance System as claimed in claims 1 and 13, wherein suffixing single-digit security check digit which provides unique security validation of the HCN.

29. The National Citizen Identity Management and e-Governance System as claimed in claim 1, wherein a unique and unprecedented range of applications and functionalities with all-encompassing Card Deployment as per schematic furnished at FIG. 10 are agglomerated, where the multipurpose, multifunction ID Card deployed is linked to a secure and stringently safeguarded national level central data repository which serves as the anchor for all administrative procedures and e-Governance initiatives under the Citizens' Identity Management and e-Governance Programme, also known as CimeGo System®.

30. The National Citizen Identity Management and e-Governance System as claimed in claim 1, wherein the agglomeration and composition of citizens' data is enabled, comprising their collection, classification and storage in novel, uniquely designed segment terminating in a National Registry and reflected on individual Card's storage device for each Citizen's Card as depicted in FIG. 14 and as exemplified by FIGS. 15 to 23 (both inclusive) which represent one of the chosen methods of embodying the data shown at FIG. 14, all of the said data being similarly displayed.

31. The National Citizen Identity Management and e-Governance System as claimed in claim 1, wherein a tamper proof card storage device (chip) is provided which includes “kill command” that is automatically invoked instantly when an attempt is made to tamper with it electronically making it self-destructing when tampered with.

32. The National Citizen Identity Management and e-Governance System as claimed in claim 1, wherein data once entered cannot be erased and wherein erroneous entries can be rectified only by means of fresh correction entry below the original entry, thereby precluding record manipulation and assuring the safety of contents of stored data.

33. The National Citizen Identity Management and e-Governance System as claimed in claim 1, wherein a special facility to port data from existing national/provincial databases to the new, comprehensive National Registry under respective segments and interfaced with reciprocal referencing is enabled.

34. The National Citizen Identity Management and e-Governance System as claimed in claim 1, wherein receiving and processing applications together with accompanying foundational documents from citizens seeking enrolment to the National Citizen Identity Management and e-Governance Programme is enabled, with rapid and accurate capturing and storing of citizen's biometrics, and their aggregation in a distinct e-File for each citizen housing said data and accessed by means of an e-Tag bearing a temporary control number, until the unique citizen ID number is allotted to citizen, whereafter the temporary control number cedes way to the Electronic File Number (EFN) for the e-File which resides permanently in the NR bearing the same 18-digit HCN allotted to the citizen, with the old TCN being stored within the e-File for correlating reference.

35. The National Citizen Identity Management and e-Governance System as claimed in claim 1, wherein India Card Centres (ICCs) are created and established on pan-India basis to implement the Project, said ICCs functioning as citizen-friendly interface between the populace and federal/provincial governments and their agencies and other institutions and the enunciated procedures to manage and control their operations.

36. The National Citizen Identity Management and e-Governance System as claimed in claim 1, wherein multifarious high-utility statistical analyses are generated to provide the ready means for improved planning and qualitative and regulatory enhancements in e-Governance.

37. The National Citizen Identity Management and e-Governance System as claimed in claim 1, wherein readily accessible graded/layered biometrics for distinctive, need-based application in varied fields is enabled.

38. The National Citizen Identity Management and e-Governance System as claimed in claim 1, wherein use of digital signature safeguarded by usage of 6-digit PIN is enabled for wide range of modern e-Governance and e-commerce applications in a fully secure environment.

39. The National Citizen Identity Management and e-Governance System as claimed in claim 1, wherein effective, simplified and smoothly regulated border control and detection/prevention of infiltration/insurgency are enabled with special reference to sensitive areas and entry points appurtenant to porous external borders.

40. The National Citizen Identity Management and e-Governance System as claimed in claim 1, wherein the mandatory deployment and application of said NCID Card as an Inland/Regional Passport is enabled, with facility to effectively monitor the movement of people at all airports, seaports, and to regulate their movement at all immigration and emigration points and at all internal borders and check points, via programmable control instructions, enabled by the incorporation of MRZ: Machine Readable Zone, widely used in international travel documents such as passports, visas, etc is provided optionally at the bottom panel on the reverse of the ID Card, for all or select categories of ID Cards, as illustrated in FIG. 1C, thereby rendering the said ID Card capable of being used as a reliable and fool-proof cross-border regional Citizen ID Card. For such Cards, the Important Instructions panel will appear on the pouch provided with each ID Card.

41. The National Citizen Identity Management and e-Governance System as claimed in claim 1, wherein citizens are enabled to reliably exercise their franchise electronically, regardless of their geographical location, and the consolidation of electoral results in a completely tamper-proof, fool-proof environment is facilitated, obviating sizeable expenses to government in conducting elections at all levels—whether local, state or central—the security arrangements thereof, and the concomitant malpractices by vested interests in the free and fair conduct of electoral process.

42. The National Citizen Identity Management and e-Governance System as claimed in claim 1, wherein the conduct of national/regional/local census operations by governments is enabled electronically, completely eliminating the arduous, expensive and imprecise current practice of physical, door-to-door head count, and huge costs and timescale thereof and replacing the same with compulsive voluntary compliance by citizens, and inbuilt features of NCID Card system herein proposed.

43. The National Citizen Identity Management and e-Governance System as claimed in claim 1, wherein a unique and unprecedented Identity correlation system and methodology is enabled on countrywide basis for spontaneous online support in detection of various types of crime.

44. The National Citizen Identity Management and e-Governance System as claimed in claim 1, wherein language translation of stored information is facilitated to any one or more of the officials languages of the country.

45. The National Citizen Identity Management and e-Governance System as claimed in claim 1, wherein the content, flow, sequence, methodology, procedure of data sourcing and incorporation, layout, scheme and formatting of Tabs under each principal segment of data as described FIG. 7 and as shown in FIGS. 15 to 23 are unique, and is one of the chosen methods of embodying the said data securely.

46. The National Citizen Identity Management and e-Governance System as claimed in claim 1, wherein the unique ability to use any Indian language in addition to English to operate Card System and hold citizen's data on the National Registry and on the chip of the NCID Card is enabled, thereby greatly enhancing the value of the project to masses who do not use English, and consequently, promotes the success of the CimeGo System®.

47. The National Citizen Identity Management and e-Governance System as claimed in claim 1, wherein the multiple unique security features incorporated in the NCID Card include blacklight, guilloche print, embedded hologram, indelible and tamper-proof laser printing of personalized data and unique identity reference number of citizen wherein the ink used to print permeates into the card substrate rendering it completely invulnerable to forgery or counterfeit attempts, variable surface-level of citizen's signature inscribed at a level up to 40 microns below the remaining surface area of the printed NCID Card (where the citizen in unable to affix his/her signature, this panel will be inscribed with the citizen's name in his/her mother tongue), resulting in providing governments an extremely secure and reliable national citizen identity management system.

48. The National Citizen Identity Management and e-Governance System as claimed in claim 1, wherein the activation and deactivation of citizens ID Card is remotely controlled, thereby providing authorities reliable and spontaneous control to prevent identity thefts, use of fraudulent identities, deployment of fake ID Cards, impersonation and all forms of misuse of nation's economic system/social infrastructure.

49. The National Citizen Identity Management and e-Governance System as claimed in claim 1, wherein rapid, accurate, secure and error-free NCID Card personalization is facilitated by deploying advanced card personalisation techniques which facilitate efficient coverage of large populations under the new identity management cum e-Governance programme in a relatively short timeframe, thereby hastening the resultant benefits to both citizens and governments.

50. The National Citizen Identity Management and e-Governance System as claimed in claim 1, wherein a single NCID Card is deployed across of the country permanently replacing all other forms/types of citizen identities, whether federal or provincial, and Citizen to Government (C2G) interfaces and thereby serves as Single Identity with only One Reference Number for all applications, throughout the life of each Citizen, altogether precluding citizens from securing a second (additional)/false identity card in any circumstance.

51. The National Citizen Identity Management and e-Governance System as claimed in claim 1, wherein the classification, codification and representation of citizens vocation/calling is extremely useful for macro-economic planning and policy formulation by governments at all levels.

52. The National Citizen Identity Management and e-Governance System as claimed in claim 1, wherein the categorisation of citizens under broad groups assigning any chosen parameter(s) for spontaneous macro analysis of trends and patterns is enabled, thereby facilitating rapid administrative and policy decisions, resulting in achieving more effective and meaningful governance of populace in the entire country or in a part or region thereof.

53. The National Citizen Identity Management and e-Governance System as claimed in claim 1, wherein sustainable, gainful employment is enabled to very large numbers of people in varying age groups, educational levels and career background, in connection with operating the ICCs and in providing various forms of support services including facilitation services to citizens via operation of call centres etc throughout the life-cycle of the CimeGo System® enabling successfully implementation of the said Programme and its efficient and reliable operation on long term basis.

54. The National Citizen Identity Management and e-Governance System as claimed in claim 1, wherein the rapid, systematic and scientific coverage of populace under the CimeGo System® is enabled by means of focused, compulsive compliance serves to promote attainment of various national development and socio economic targets set by government under annual, five year and national vision plans in a systematic, measurable manner.

55. The National Citizen Identity Management and e-Governance System as claimed in claim 1, wherein dedicated call centres are established and operationalised nationwide under the CimeGo System® to render efficient, systematic and timely service 24/7 to citizens on all aspects of ID Card usage as well as of e-Governance.

56. The National Citizen Identity Management and e-Governance System as claimed in claim 1, wherein public key infrastructure facilities are extended to citizens who hold and operate the corresponding private key under e-Governance programmes.

57. The National Citizen Identity Management and e-Governance System as claimed in claim 1, wherein the nation's hitherto neglected androgynous populace is effectively covered under the CimeGo System® by means of creating a new classification referred to as transgen for persons having an ambiguous sexual identity and this forms the basis for extension of special socio-economic reliefs to them by government.

58. The National Citizen Identity Management and e-Governance System as claimed in claim 1, wherein the timely and accurate recording of changes in key data is enabled covering all important facets appurtenant to each citizen covered under the CimeGo System® by means of specially designed formats and software to record and track said changes.

59. The National Citizen Identity Management and e-Governance System as claimed in claim 1, wherein authenticated, certified true copies of key documents digitally stored in the National Registry are spontaneously provided with convenience to citizens upon their requisitioning, by means of specially designed printout facility at ICCs or via web-enabled certification services via call centres 24/7, resulting in additional revenue streams for governments.

60. The National Citizen Identity Management and e-Governance System as claimed in claim 1, wherein citizen's name in inscribed in his/her mother tongue on the obverse of the ID Card in the panel provided for signature, in cases where the citizen is illiterate and/or unable to affix his/her signature, provides ready visual confirmation thereof.

61. The National Citizen Identity Management and e-Governance System as claimed in claim 1, wherein custom-designed software known as IDMax® is deployed, incorporating on-card and off-card systems which together provide a complete smart card solution offering rapid application development and dynamic upgrade in the field, with said IDMax® residing in three domains: the smart card, the terminal and the back office, appurtenant to card management, security management and control application management respectively.

62. The National Citizen Identity Management and e-Governance System as claimed in claim 1, wherein changes occurring in certain identifier number-groups in the original, unique 18-digit citizen NCID number by means of using IDMax® are dynamically recorded and spontaneously displayed—on the National Registry database and subsequently on the ID Card chip when updated—thereby altogether precluding false claims or misrepresentations by citizens in respect of status, vocation, state and zone location from time to time.
